(19) United States
(12) Patent Application Publication
(10) Pub. No.: US 2026/0309897 A1
(43) Pub. Date: Oct. 8, 2026

(54) Imaging Lighting Lenses

(71) Applicant: SUNEX, INC., CARLSBAD, CA (US)

(72) Inventors: ALEX NING, CARLSBAD, CA (US); JINGBO CAI, CARLSBAD, CA (US)

(21) Appl. No.: 19/658,421

(22) Filed: Apr. 24, 2026

Related U.S. Application Data
(63) Continuation-in-part of application No. 19/091,118, filed on Mar. 26, 2025.
(60) Provisional application No. 63/795,306, filed on Apr. 26, 2025.

(51) Int. Cl. G02B 3/00; G02B 9/12; G02B 9/34; G02B 9/60; G02B 9/62; G02B 13/18

(52) U.S. Cl. CPC G02B 3/0056; G02B 9/12; G02B 9/34; G02B 9/60; G02B 9/62; G02B 13/18

(57) ABSTRACT

A lens system design for an imaging projection lens is described. The system enables selection of performance requirements of a high or low resolution lens system as described through a set of examples meeting a set of parametric equations. A low resolution imaging lenses has a field angle between 15 and 20 degrees and effective focal lengths (EFL) between 18 and 25. The high resolution lens systems have an EFL between 30 and 38 source and field angles between 10 and 12 degrees. The examples all use a 12.8 mm light source (Ah). The lens system is scaled to other size light sources using the parametric equation for EFL/Ah. The lens system comprises two positive powered lens groups. There are 3 lens elements in a first group and 1 to 3 lens element in a second group, the second group is nearest the light source.

### CROSS REFERENCE TO RELATED APPLICATIONS

This application is a continuation-in-part of U.S. application Ser. No. 19/091,118 filed Mar. 26, 2025 which is a continuation-in-part of U.S. application Ser. No. 17/806,765 filed Jun. 14, 2022. This application also claims priority to U.S. Provisional Application 63/795,306, filed Apr. 26, 2025, all titled IMAGING LIGHTING LENSES and including common inventors.

### STATEMENT REGARDING FEDERALLY SPONSORED RESEARCH OR DEVELOPMENT

Not Applicable.

### BACKGROUND OF THE INVENTION

### Technical Field

The invention relates to projection lens systems used primarily for automotive headlights.

### Related Background Art

Optical elements or lenses for traditional lighting applications such as vehicle headlights, room lighting, street and traffic lamps are designed as efficient light collectors. Imaging performance of such lenses has been less important than efficiency. New LED array lighting applications require lenses having not only efficient light collection but also excellent imaging performance.

New lighting systems are used, for example, in automotive headlights, known as adaptive driving beam (ADB) headlights, where they can provide brighter illumination of a section of the roadway and at the same time reduced glare for oncoming drivers. New light sources include upwards of a million individually controllable pixels. Headlights can now automatically adjust for curvature and contours of the road and can also provide messaging, directional instructions and more. Efficient light collection and projection implies that the lens must have very high numerical aperture or low F/#. A low F/# requirement present significant challenges from image quality point of view because most of the image aberrations are highly dependent on the F #. For example, spherical and coma aberrations are difficult to correct with a low F/# lens. In addition, the lens has to be designed to meet other requirements such as minimum stray light, good temperature stability and acceptable color fringes due to restriction of both visual and government regulations. Furthermore, the full horizontal field of view FOV for these applications is also considerable with a range from 20 degrees on the narrow side to 40 degrees on the wide side, the aberration change over the full field could also present itself as a challenge.

An object of this invention is to provide lens designs capable of providing good imaging performance while meeting these constraints and at the same time collecting light efficiently from array light sources such as LED matrix and micro-LED array chips and having a F/# in the range of 0.55-0.8. There is a need for the lens set to be compact. There is a need for a lens design that prioritizes light collection efficiency and cost, and, there is a need for a lens design that enables high resolution imaging. High resolution meaning in this case the ability to accurately display an image from an LED matrix chip that includes multiple pixels onto a surface that may be 1 to 10 meters away. The designs must also be cost-effective to manufacture. Both European and United States have published regulations for the performance of ADB headlights. The regulations include testing in road conditions such as at speeds and on straight and curved roads and with front approaching vehicles and vehicles approached from the rear, with requirements for light intensity and limits on glare to other drivers. The regulations cover what should be lit and what should not be lit and the definition of “lit” in terms of lux. An intent of the regulation is to maximize visibility to a driver and minimize glare to other drivers. ADB headlights have been commercialized for more than 20 years. However, lens designs that meet the heretofore little used new imaging capabilities of the LED arrays that are now commonly available, while maintaining efficient operation at a near commodity cost mean that prior art lenses are not sufficient. There is a need for new lens systems that enable imaging capabilities of the ADB headlights and lighting systems that go beyond the current definition of ADB. Development also requires a lens system that is adaptable to new uses, such as higher resolution light source arrays as well as lower resolution light sources, or, new mechanical designs and lighting designs for a vehicles front end. There is a need for a lens design that applies to both low resolution imaging light sources and higher resolution imaging light sources. There is a need for such a lens element to be modified to meet target values for parameters as normally applied to optics design rather than waiting for testing only in a finished vehicle.

### BRIEF SUMMARY OF THE INVENTION

A lens system that includes 3, 4, 5 and 6 lens element designs for imaging lenses is described.

All embodiments of the lens system meet pre-selected operating parameters such as low f-number (F/#) and effective focal length range, and, further can be selected and optimized for particular imaging properties either as lower resolution applications used for low beam, wider field of view (FOV) or illumination, and, high beam, narrower FOV. The lower resolution applications have larger spot size and if an image is formed using selected pixels from the array source the image formed would be lower resolution than that formed using the higher resolution, longer focal length and smaller individual pixel images.

The embodiment lenses of the invention are presented as several illustrative examples. The illustrative examples are not all inclusive. Other similar embodiments are possible within the constraints of the claims. In the following description, distinction between lens element and lens group is not absolute because a lens group could contain just one lens element and one lens element can be split into a number of weaker elements which function equivalently as the replaced single element. Generally, each disclosed example comprises a number of lens elements which are numerically labeled in increasing order from the left to the right with the left most being L1. These lenses logically form into two groups which are labeled numerically in increasing order from the left to the right with the left most being G1 and the group nearest the light source being G2. Each lens group comprises one or several lens elements. Each lens element has two surfaces. The object surface of an element is defined as the surface facing the object space (the side to be illuminated) of the lens assembly. The plane of image is defined as location of the LED light source array. In all drawings the object space is on the left side of the lens assembly. The image surface of an element is defined as the lens surface facing the image space (the LED source) of the lens assembly. In all drawings the image space and light source array is on the right side of the lens assembly. Element surfaces can be flat (plano), spherical or aspheric. For an aspheric surface the following equation is used to describe the surface profile:

$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16} .$$

In this equation z is the surface sag at radial distance r from the optical axis. The k is the conic constant. The c is the curvature or inverse of the radius of curvature. The term ai is the i^{th} polynomial coefficient. Please refer to various lens design publications or Zemax® software manual (www.Zemax.com, Zemax is a registered US trademark of Zemax, LLC) for detailed description of this equation. The effective focal length of the whole lens assembly designated by EFL is the numerical value as calculated by the Zemax software EFFL optimization operand or equivalent method.

The effective focal length of an element designated by appending “EFL_” to the name of the element such as “EFL_L #” is the numerical value as calculated by the Zemax software EFLY optimization operand over the two surfaces bounding the lens element # or equivalent method.

The effective focal length of a lens group designated by appending “EFL_” to the name of the lens group such as “EFL_G #” is the numerical value as calculated by the Zemax software EFLY optimization operand over the starting and ending surfaces of the lens group or equivalent method.

To designate the desirable configuration of current invention, a numerical range of the ratio of the effective focal length of a lens group or a lens element to the effective focal length of the whole lens assembly is given. In addition, the ratio of the radius of the image surface of the last lens element to the effective focal length of the whole lens is also given as a range to identify the desirable configuration.

The source array is rectangular and has a horizontal size (Aₕ) of 9.0 mm, 12.8 mm or 14.0 mm in all illustrative examples. The lens system is scalable to other light source array sizes as reflected in the parametric equations. All the lens systems have a compact design with total track length of the lens systems divided by the horizontal array size (Aₕ) of less than or equal to 6.1. The lens systems are also designed for economical manufacturing with the minimum value of the absolute value of the radius of curvature for all lens elements (|Ri|/Aₕ)>=0.69. The lens systems are compact with the minimum value of the absolute value of the radius of curvature for all lens elements divided by the total track length (|Ri|/TTL)>=0.51. All lens systems have an F/# of 0.8 or less and satisfy the parametric equations discussed below.

The embodiments are divided into lower resolution lenses and higher resolution lenses, both have the same basic structural designs. Resolution is measured by techniques as are known in the art, such as field of view and spot size, line resolution, etc. In this context, low resolution lens examples have an effective focal length (EFL) between 12 and 25 mm and the high resolution lens examples have an EFL between 21 and 37 mm for the current Aₕ. The lens system is scaled to other size source arrays according to equation (1) for low resolution lens systems and according to equation (2) for the high resolution lens systems. Examples 1-12 are lower resolution examples. Examples 13-41 are high resolution examples. Low resolution is selected here by equation (1) and the higher resolution is selected by parametric equation (2):

$$1.3 <= EFL / A h <= 2 \qquad ( 1 )$$

$$2. <= EFL / A h <= 3 \qquad ( 2 )$$

The parametric equations (1) and (2) would give an equivalent sorting as to other common measures of resolution including the field of view (FOV) as discussed above. All examples satisfy parametric equations (1)-(11).

The imaging lighting lenses are comprised, from object to image, of two lens groups: a first positive powered lens group G1, and a second positive powered group G2. Group 1 includes two or three lens elements and an aperture stop, and, group 2 consists of 1, 2 or 3 lens elements.

When comprised of three elements, Group 1 includes, in order object to image where image is the light source side, a first positive lens element, a second negative lens element and a third positive lens element. Each of the lens elements can be replaced by using two or more lens elements. In a four lens element Group 1, the third and fourth elements can be the third lens of the three element example split into two positive lens elements or the first element split into two positive lens elements. Group 2, has positive power and includes 1-3 lens elements. Group 1 includes an aperture stop.

The parametric equations for the designs are:

### Overall Lens System Parameters

$$1.2 <= EFL / A h <= 2 ( for low resolution designs ) \qquad ( 1 )$$

$$2.2 < = EFL / A h <= 3 ( for high resolution designs ) \qquad ( 2 )$$

$$TTL / A h < 6.1 \qquad ( 3 )$$

$$\vert Ri \vert / TTL > 0.51 \qquad ( 4 )$$

$$F / \# < 0.8 \qquad ( 5 )$$

### GROUP PARAMETERS for Low Resolution Designs

$$1. <= EFL\_G1 / EFL <= 2.6 \qquad ( 6 )$$

$$0.9 <= EFL\_G2 / EFL <= 2. \qquad ( 7 )$$

$$1.5 <= \vert R L \vert / EFL \qquad ( 8 )$$

### GROUP PARAMETERS for High Resolution Designs:

$$1. <= EFL\_G1 / EFL <= 2.6 \qquad ( 9 )$$

$$0.9 <= EFL\_G 2 / EFL <= 4.7 \qquad ( 10 )$$

$$0.3 <= \vert RL \vert / EFL \qquad ( 11 )$$

And for designs with 3 or more lens elements in Group 1 the power of each element L1, L2, L3 is +−+ respectively and the following equations apply:

$$1.3 <= EFL\_L1 / EFL <= 4.5 \qquad ( 12 )$$

$$- 12 <= EFL\_L2 / EFL <= - 0.5 \qquad ( 13 )$$

$$1. 0 <= EFL\_L3 / EFL <= 3.5 \qquad ( 14 )$$

Where EFL_G1 means the effective focal length of the first lens group, EFL is the effective focal length of the entire lens system, EFL_L1 is the effective focal length of the first lens element in group 1 and EFL_L2 is the effective focal length of the second lens, and so on. The image surface of the last element facing the light source array has a curvature radius of RL. The compact design of the lens system is reflected in equation (3) where the total track length divided by the horizontal dimension of the light source (TTL/Ah) is less than 6.1. In the examples shown the TTL is less than 64 mm for the low resolution set and less than 78 mm for the higher resolution set. One aspect of ease of manufacturing is reflected in part in equation 8 where the absolute value of the radius of curvature for any single lens element (|Ri|) divided by the total track length (TTL) is greater than 0.23. All of the designs are optically efficient with a low f/#reflected in equation 9. Equations (7) and (20), Effective focal length for the whole lens system divided by the horizontal size of the light source array (EFL/Ah) are a parametric definition for low resolution and high resolution lens systems respectively.

The higher resolution embodiments all have higher resolution capabilities relative to those designs described above as low resolution. Resolution is measured by techniques as are known in the art, such as spot size, line resolution, etc. The higher resolution lens systems have a field angle between +/−10 and 12 degrees and an EFL between 30 mm and 38 mm for a 12.8 mm sized array (Ah). The higher resolution set are comprised, from object to image, of two lens groups: a first positive powered lens group G1, having three lens elements of positive, negative and positive powers in that order from object to image, and a second positive powered lens group G2 having 1, 2 or 3 lens elements. The EFL for other size arrays scales according to Equations (1) and (2). For example, a lens system design with an EFL of 30 mm, a 12.8 mm array(Ah), and, EFL/Ah=30/12.8=2.3 would have an EFL of 31 mm for use with a 9 mm wide source array.

The embodiments are sorted into low resolution and high resolution examples in the order of EFL/Ah. Example 1 is a low resolution example having the lowest EFL/Ah and the highest field angle. The last example, numbered 41 has the highest value for EFL/Ah at 2.9 and the smallest field angle at +/−10 degrees.

### BRIEF DESCRIPTION OF THE DRAWINGS

FIG. 1 shows a schematic view of an example LED array light source.

FIG. 2 shows plots of Field angle and EFL/Ah as a function of example number.

FIG. 3-12 shows cross-section schematic views of lower resolution examples in order of lowest to highest EFL/Ah from 1.4 to 2 and a field angle of 40 degrees down to 14 degrees.

FIG. 3 shows a cross-section schematic view of a low resolution three lens example having a value for EFL/Ah of 1.4.

FIG. 4 shows a cross-section schematic view of a low resolution three lens example.

FIG. 5 shows a cross-section schematic view of a low resolution four lens example.

FIG. 6 shows a cross-section schematic view of a low resolution five lens example. FIG. 7 shows a cross-section schematic view of a low resolution five lens example.

FIG. 8 shows a cross-section schematic view of a low resolution five lens example.

FIG. 9 shows a cross-section schematic view of a low resolution five lens example.

FIG. 10 shows a cross-section schematic view of a low resolution five lens example.

FIG. 11 shows a cross-section schematic view of a low resolution five lens example.

FIG. 12 shows a cross-section schematic view of a low resolution five lens example.

FIGS. 13-43 show three, four, five and six lens element examples of higher resolution examples in order of lowest to highest EFL/Ah from 2.3 to 2.9 and field angle of 12 down to 10 degrees.

FIG. 13 shows a cross-section schematic view of a higher resolution five lens example having a value for EFL/Ah of 2.3 and a field angle of 12 degrees.

FIG. 14 shows a cross-section schematic view of a higher resolution three lens example.

FIG. 15 shows a cross-section schematic view of a higher resolution four lens example.

FIG. 16 shows a cross-section schematic view of a higher resolution three lens example.

FIG. 17 shows a cross-section schematic view of a higher resolution four lens example.

FIG. 18 shows a cross-section schematic view of a higher resolution four lens example.

FIG. 19 shows a cross-section schematic view of a higher resolution four lens example.

FIG. 20 shows a cross-section schematic view of a higher resolution four lens example.

FIG. 21 shows a cross-section schematic view of a higher resolution five lens example.

FIG. 22 shows a cross-section schematic view of a higher resolution five lens example.

FIG. 23 shows a cross-section schematic view of a higher resolution five lens example.

FIG. 24 shows a cross-section schematic view of a higher resolution six lens example.

FIG. 25 shows a cross-section schematic view of a higher resolution five lens example.

FIG. 26 shows a cross-section schematic view of a higher resolution four lens example.

FIG. 27 shows a cross-section schematic view of a higher resolution four lens example.

FIG. 28 shows a cross-section schematic view of a higher resolution six lens example.

FIG. 29 shows a cross-section schematic view of a higher resolution six lens example.

FIG. 30 shows a cross-section schematic view of a higher resolution six lens example.

FIG. 31 shows a cross-section schematic view of a higher resolution six lens example.

FIG. 32 shows a cross-section schematic view of a higher resolution six lens example.

FIG. 33 shows a cross-section schematic view of a higher resolution six lens example.

FIG. 34 shows a cross-section schematic view of a higher resolution six lens example.

FIG. 35 shows a cross-section schematic view of a higher resolution six lens example.

FIG. 36 shows a cross-section schematic view of a higher resolution six lens example.

FIG. 37 shows a cross-section schematic view of a higher resolution four lens example.

FIG. 38 shows a cross-section schematic view of a higher resolution four lens example.

FIG. 39 shows a cross-section schematic view of a higher resolution five lens example.

FIG. 40 shows a cross-section schematic view of a higher resolution six lens example.

FIG. 41 shows a cross-section schematic view of a higher resolution five lens example.

FIG. 42 shows a cross-section schematic view of a higher resolution four lens example.

FIG. 43 shows a cross-section schematic view of a higher resolution four lens example having an EFL/Ah of 2.9 and field angle down to 10 degrees.

### DETAILED DESCRIPTION OF THE INVENTION

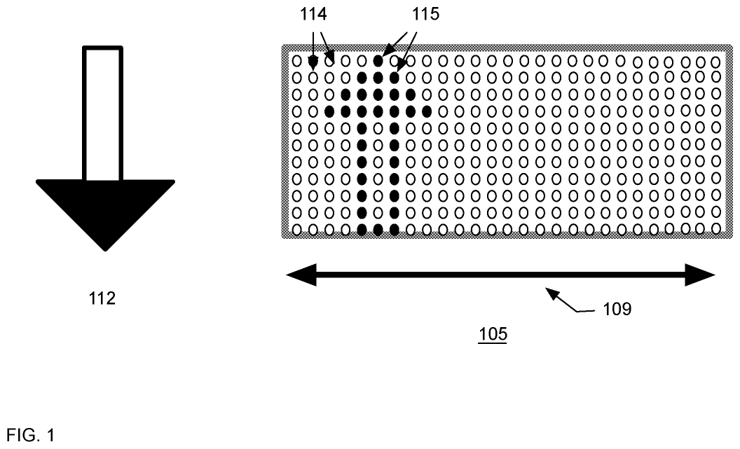

FIG. 1 shows a light source 105 having a horizontal dimension 109 (Ah). The lens system is used to project a light pattern 112 originating from an image or light pattern formed on the light source by turning individual pixels either “on” 115 or “off” 114 forming the pattern 112. In the following examples the dimension, Ah, 109 is either 9, 12.8 or 14 mm. The dimensions of the lens system can be scaled using the parametric equation Ah/EFL to change the effective focal length (EFL) of the system providing the same projected image 112 using light sources having different dimensions 109.

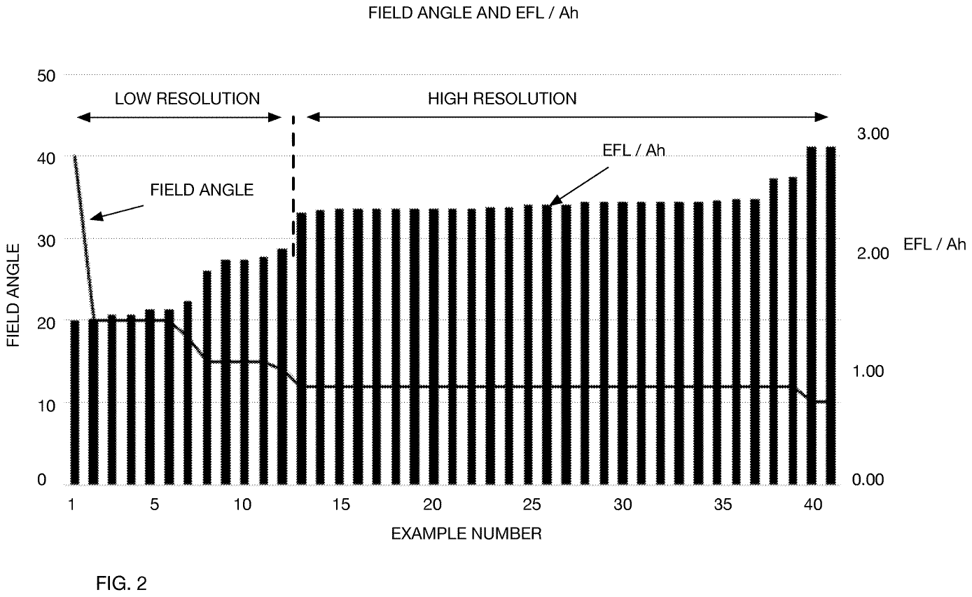

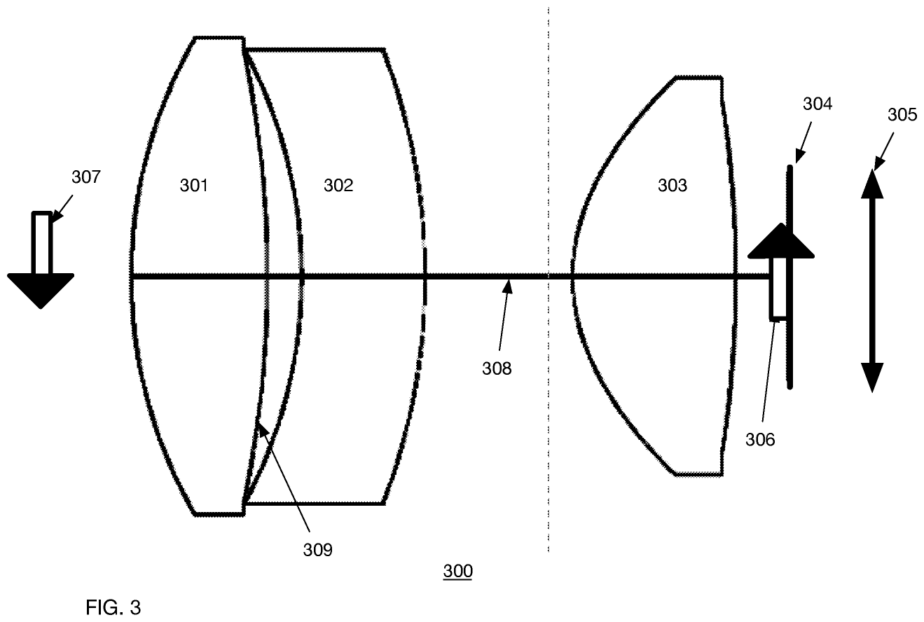

FIG. 2 shows a graph depicting key variables of effective focal length for the lens system (EFL) divided by the width of the light source (Ah), depicted as a bar for each example number shown along the X-axis, the height of each bar being the ratio EFL/Ah. The scale for the bar heights is the right hand Y-axis. The examples are sorted here and in the following FIGS. 3-41 in order of the ration EFL/Ah. Low resolution examples have a range of EFL/Ah between 1 and 2, and, correspond to examples 1-12. The lower resolution samples would produce the higher field angle (equal to the half horizontal field of view in traditional imaging lens terminology, the “+/−” is ignored due to the field angle symmetry) as shown by the line and corresponding to values on the left hand vertical axis. The examples for the high resolution show a large number of examples with little variation in the values for EFL/Ah and the field angle.

This is more an artifact of the target values for performance and regulations for automotive lighting rather than inherent limits on the invention.

The remaining FIGS. 3-43 show side cross sectional views for each of the examples 1-41.

All embodiments are comprised of two lens groups. In order from object to image, the first group has positive power and is comprised of two, three or four lens elements. In the case of three elements in group 1 they have, in order of object to light source, positive, negative, positive optical powers. In some embodiments, the third positive lens element of Group 1 is split into two positive lens elements making a low resolution five lens element embodiment. The second lens group has positive power and comprises one, two or three lens elements. The lens elements in the case of two lens elements in group two have positive and negative powers and the case of three lens elements in group 2 have positive, positive, negative optical powers.

In a preferred embodiment the lens system consists only of the three lens elements in Group 1 and consists only of one, two, or, three lens elements in group 2 each with the optical powers as described in the order as described above.

FIG. 3 shows the layout of Example 1, a first lens system 300. This design has a horizontal field angle of +/−40° with a relative aperture (F/#) of F/0.6 and an effective focal length EFL of 12.5 mm with a 9 mm source Ah.

It comprises three lens elements 301-303. The first lens 301 (L1) from the left is a positive powered element with optical property of a larger abbe number and therefore relatively lower color dispersion. There is an aperture stop on the image side of L1. The second lens 302 (L2) from the left is a weak powered shell-like element with a smaller Abbe number and therefore relatively higher color dispersion. L1 and L2 form the first lens group G1. The third element 303 (L3) from left forms the second group G2 and is a positive powered element with a larger Abbe number and therefore relatively lower color dispersion. Such choice of dispersion properties of elements facilitates the good color correction as required by automobile lighting lens application.

The all glass element design provide good protection from heat and UV radiation generated by light source even with the close proximity of lens elements to the light source and performance stability of the lens assembly. The additional design degrees of freedom available from using aspheric profile for object/image surfaces of L3 can further improve the aberration correction of the system without incurring additional manufacturing cost due to the material chosen for L3 can be molded.

The image surface (RL) of the last element is convex facing the light source array and has a curvature radius divided by the total track length (TTL) satisfying above specified Equation (4) to improve light collection efficiency, to keep the lens barrel rear end diameter small, to improve optical performance uniformity over the projected field and to keep the stray light low.

The lens system is used to project an image or light pattern originating from an image or light pattern formed on the light source. A non-limiting example light source is an LED array having a horizontal size (Aₕ) 109 of 9 mm. Details of an example LED array light source are shown in FIG. 1B. The physical length (TTL) of the example 1 lens system is 30.6 mm. However, dimensions of the lens system 100 can be scaled to accommodate light sources having different dimensions.

Table 1 shows the optical prescription of Example 1.

| | | Radius | Thickness | | | Clear | |
|---|---|---|---|---|---|---|---|
| Surface | Type | (mm) | (mm) | Nd | Vd | Diameter | lens |
| OBJ | SPHERICAL | Infinity | Infinity | | | 0 | |
| 1 | SPHERICAL | 22.1978 | 6.354 | 1.658 | 50.9 | 22.2 | L1 |
| STO | SPHERICAL | −50.5754 | 1.596 | | | 21.2 | |
| 3 | SPHERICAL | −22.2147 | 5.762 | 1.728 | 28.3 | 21.2 | L2 |
| 4 | SPHERICAL | −29.3279 | 6.869 | | | 20.9 | |
| 5 | ASPHERICAL | 8.6003 | 7.625 | 1.694 | 53.2 | 18.5 | L3 |
| 6 | SPHERICAL | −52.2282 | 2.4 | | | 16.8 | |
| IMA | SPHERICAL | Infinity | | | | 9.6 | |

L3 object surface is aspherical described by the following equation:

$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16} .$$

The parameters for this equation are as follows:

Object Surface of L3

| | |
|---|---|
| k | −1.001896 |
| Coefficient on r\hat{ } 2 | 0.00E+00 |
| Coefficient on r\hat{ } 4 | −5.1482815e−05 |
| Coefficient on r\hat{ } 6 | 3.5668711e−07 |
| Coefficient on r\hat{ } 8 | 0.00E+00 |
| Coefficient on r\hat{ }10 | 0.00E+00 |
| Coefficient on r\hat{ }12 | 0.00E+00 |
| Coefficient on r\hat{ }14 | 0.00E+00 |
| Coefficient on r\hat{ }16 | 0.00E+00 |

The data for the parametric constraints of Equations 1-14 are shown here and summarized for all Examples in Table 42 of the Summary.

| EXAMPLE | EFL/Ah | TTL/Ah | Ri/TTL | F/# | EFL_G1/EFL | EFL_G2/EFL | RL/EFL |
|---|---|---|---|---|---|---|---|
| 1 | 1.39 | 3.40 | 0.28 | 0.6 | 2.38 | 0.89 | 4.18 |
| | | | | | EFL_L1/EFL 1.9 | EFL_L3/EFL 0.89 | |
| | | | | | EFL_L2/EFL −15.2 | | |

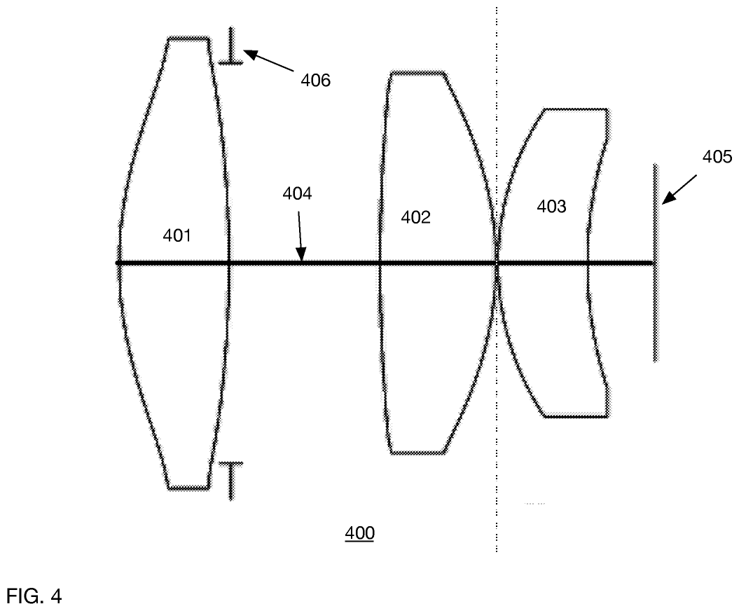

FIG. 4 shows the layout of Example 2, a three element, lower resolution lens system 100. This design has a horizontal field angle of +/−20° with a relative aperture (F/#) of F/0.7 and an effective focal length EFL of 18 mm with a 12.8 mm source Ah.

It comprises three lens elements 401, 402, 403 with an aperture stop 406 on the image side of the first lens element 401. The first lens 401 L1 from the left is a positive powered element with optical property of a higher abbe number and therefore relatively small color dispersion. The second lens 402 L2 from the left is a positive powered glass element with a larger Abbe number and therefore relatively lower color dispersion. The third element 403 L3 from left is a slightly powered element with a lower Abbe number and therefore relatively higher color dispersion.

Such choice of dispersion properties of elements facilitates the good color correction as required by automobile lighting lens application. The L1 and L2 are made of moldable glass material and L3 is made of glass material. This arrangement provide good protection from heat and UV radiation generated by light source even with the close proximity of lens elements to the light source 405. Each element can be made either from optical plastic or glass materials. In preferred embodiments, all three elements are made of glass materials. The all glass design also is helpful to the thermal performance stability of the lens assembly. The additional design degrees of freedom available from using aspheric profile for object and image surfaces of L1 and L2, respectively, can further improve the aberration correction of the system without incurring additional manufacturing cost due to the material chosen for L1 and L2 can be molded.

The image surface (RL) of the last element 403 is concave facing the light source array and has a curvature radius divided by the total track length (TTL) satisfying above specified Equation (4) to improve light collection efficiency, to keep the lens barrel rear end diameter small, to improve optical performance uniformity over the projected field and to keep the stray light low.

The lens system is used to project an image or light pattern originating from an image or light pattern formed on the light source 405. A non-limiting example light source is an LED array having a horizontal size (Aₕ) 109 of 12.8 mm. Details of an example LED array light source are shown in FIG. 4. The physical length (TTL) of the example 1 lens system is 35 mm. However, dimensions of the lens system 400 can be scaled to accommodate light sources having different dimensions.

Table 2 shows the optical prescription of Example 2.

TABLE 2

| | | Radius | Thickness | | | Clear | |
|---|---|---|---|---|---|---|---|
| Surface | Type | (mm) | (mm) | Nd | Vd | Diameter | lens |
| OBJ | SPHERICAL | Infinity | Infinity | | | 0 | |
| 1 | ASPHERICAL | 24.2636 | 7.2681 | 1.5163 | 64.05 | 29.74 | L1 |
| 2 | ASPHERICAL | −71.5471 | 0.128 | | | 28.23 | |
| STO | SPHERICAL | Infinity | 9.8403 | | | 26.51 | |
| 4 | ASPHERICAL | 88.6704 | 7.68 | 1.5163 | 64.05 | 25.08 | L2 |
| 5 | ASPHERICAL | −21.3149 | 0.128 | | | 24.64 | |
| 6 | SPHERICAL | 18.2398 | 5.9129 | 1.8348 | 42.73 | 20.29 | L3 |
| 7 | SPHERICAL | 26.5982 | 4.48 | | | 16.55 | |
| IMA | SPHERICAL | Infinity | | | | 13.02 | |

L1 and L2 object/Image surface are aspherical described by the following equation:

$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16} .$$

The parameters for this equation are as follows:

Object Surface of L1

| | |
|---|---|
| k | −2.334854 |
| Coefficient on r\hat{ } 2 | 0.00E+00 |
| Coefficient on r\hat{ } 4 | 0 |
| Coefficient on r\hat{ } 6 | −5.9604483e−08 |
| Coefficient on r\hat{ } 8 | −8.5514798e−11 |
| Coefficient on r\hat{ }10 | 0 |
| Coefficient on r\hat{ }12 | 0.00E+00 |
| Coefficient on r\hat{ }14 | 0.00E+00 |
| Coefficient on r\hat{ }16 | 0.00E+00 |

Image Surface of L1

| | |
|---|---|
| k | −19.01188 |
| Coefficient on r\hat{ } 2 | 0.00E+00 |
| Coefficient on r\hat{ } 4 | 6.87605e−06 |
| Coefficient on r\hat{ } 6 | −1.2183258e−07 |
| Coefficient on r\hat{ } 8 | 3.6144691e−10 |
| Coefficient on r\hat{ }10 | 0 |
| Coefficient on r\hat{ }12 | 0.00E+00 |
| Coefficient on r\hat{ }14 | 0.00E+00 |
| Coefficient on r\hat{ }16 | 0.00E+00 |

Object Surface of L2

| | |
|---|---|
| k | 41.5806 |
| Coefficient on r\hat{ } 2 | 0.00E+00 |
| Coefficient on r\hat{ } 4 | −3.2338577e−05 |
| Coefficient on r\hat{ } 6 | 6.9423666e−08 |
| Coefficient on r\hat{ } 8 | 0 |
| Coefficient on r\hat{ }10 | 0 |
| Coefficient on r\hat{ }12 | 0.00E+00 |
| Coefficient on r\hat{ }14 | 0.00E+00 |
| Coefficient on r\hat{ }16 | 0.00E+00 |

Image Surface of L2

| | |
|---|---|
| k | −2.438937 |
| Coefficient on r\hat{ } 2 | 0.00E+00 |
| Coefficient on r\hat{ } 4 | 0 |
| Coefficient on r\hat{ } 6 | −1.9283601e−07 |
| Coefficient on r\hat{ } 8 | 9.7074633e−10 |
| Coefficient on r\hat{ }10 | 0 |
| Coefficient on r\hat{ }12 | 0.00E+00 |
| Coefficient on r\hat{ }14 | 0.00E+00 |
| Coefficient on r\hat{ }16 | 0.00E+00 |

The parametric equations (1)-(14) are satisfied:

| EXAMPLE | EFL/Ah | TTL/Ah | Ri/TTL | F/# | EFL_G1/EFL | EFL_G2/EFL | RL/EFL |
|---|---|---|---|---|---|---|---|
| 2 | 1.41 | 2.77 | 0.51 | 0.7 | 2.56 | 0.97 | 1.48 |
| | | | | | EFL_L1/EFL 2 | EFL_L3/EFL 2.9 | |
| | | | | | EFL_L2/EFL 1.9 | | |

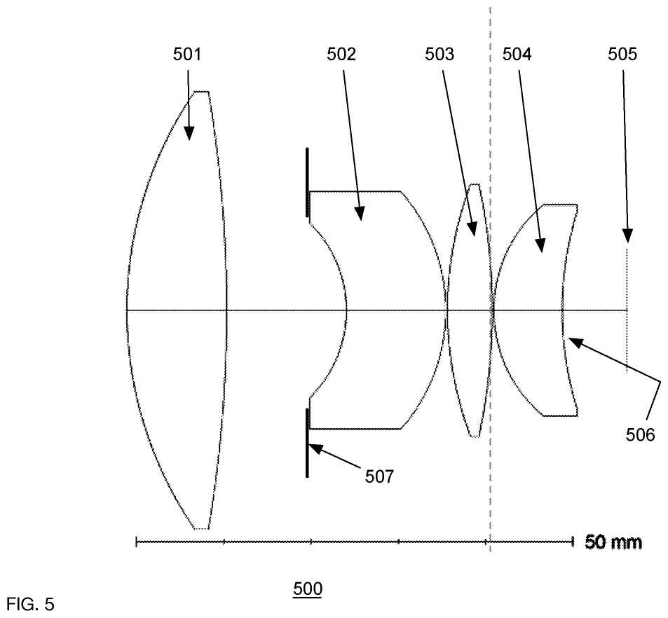

FIG. 5 shows the layout of Example 3, a lower resolution four lens element imaging projection lens system 500. The example satisfies parametric equations (1)-(7). This design has a field angle of +/−20° with a relative aperture of F/0.70 and an effective focal length of 18.4 mm. The example of present invention shows an imaging lighting lens of a low F/# which has good optical efficiency and less requirement in resolution.

This example, as for all other examples, comprises two lens groups. Group 1 has positive power and comprises three lens elements. L1, 501, L2, 502, and, L3 503. The powers of the lens elements in group 1 are positive, negative, positive, respectively. An aperture stop 507 is located in group 1 near the object surface of L2, 502. Group 2, in this example, includes a single, positive power lens element 504. The image side surface 506 is concave and has a curvature satisfying parametric equation (4). All of the lens surfaces are spherical and all lens elements are made of glass. The optical prescription for example 3 is shown in Table 3.

TABLE 3

| | | | | | Clear | |
|---|---|---|---|---|---|---|
| Sur- | | | Thick- | ND, | Diam | |
| face | Type | Radius | ness | ABBE NO. | Comment | LENS |
| OBJ | SPHERICAL | Infinity | 10000.00 | | | |
| 1 | SPHERICAL | 43.92 | 11.43 | 1.568, 56.059 | 50.00 | L1 |
| 2 | SPHERICAL | −150.32 | 13.72 | | 50.00 | |
| STO | SPHERICAL | −13.92 | 11.39 | 1.620, 60.373 | 19.96 | L2 |
| 4 | SPHERICAL | −20.43 | 0.20 | | 27.05 | |
| 5 | SPHERICAL | 40.36 | 5.13 | 1.620, 60.373 | 28.85 | L3 |
| 6 | SPHERICAL | −68.50 | 0.18 | | 28.79 | |
| 7 | SPHERICAL | 15.67 | 7.83 | 1.772, 49.613 | 24.10 | L4 |
| 8 | SPHERICAL | 38.17 | 7.49 | | 22.71 | |
| IMA | SPHERICAL | Infinity | | | 14.17 | |

The parametric equations (1)-(14) are satisfied:

| EXAMPLE | EFL/Ah | TTL/Ah | Ri/TTL | F/# | EFL_G1/EFL | EFL_G2/EFL | RL/EFL |
|---|---|---|---|---|---|---|---|
| 3 | 1.44 | 4.48 | 0.27 | 0.7 | 1.93 | 1.61 | 2.07 |
| | | | | | EFL_L1/EFL 3.3 | EFL_L4/EFL 1.61 | |
| | | | | | EFL_L2/EFL −11.6 | | |
| | | | | | EFL_L3/EFL 2.25 | | |

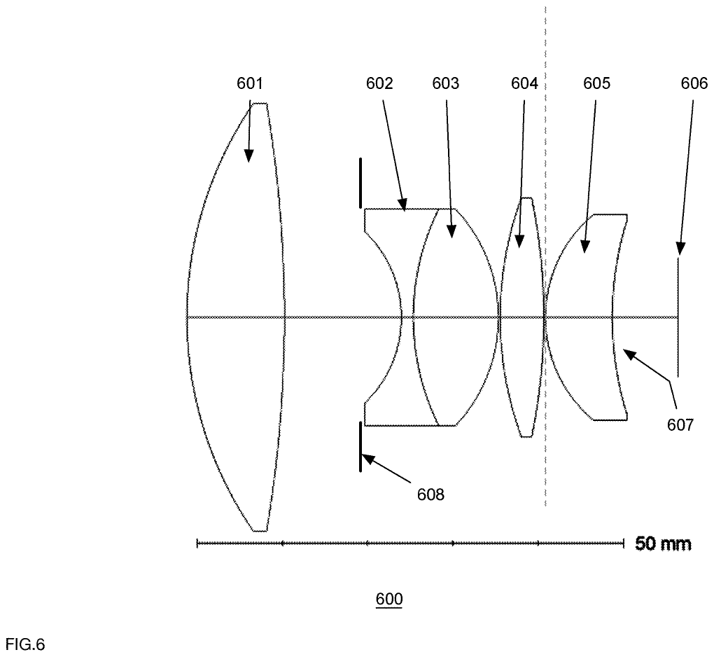

FIG. 6 shows the layout of Example 4, a low resolution embodiment or an imaging projection lens system 600 where the third lens element in Group 1 is split into two lens elements L3 and L4. This design has a field angle of +/−20° with a relative aperture of F/0.70 and an effective focal length of 18.4 mm. This example of present invention shows an imaging lighting lens of a low F/# which has good optical efficiency and less requirement in resolution.

It comprises two lens groups. Group 1 comprises L1 601, L2 602 and L3 603 and L4 604, and has an effective focal length of EFL_G1. L2 and L3 form a cemented doublet or air gap doublet. An aperture stop 608 is located in group 1 at the object surface of L2. The optical powers of the lens elements in the first group are positive, negative, positive respectively. Group 2 comprises the single positive power lens element lens elements L4 605 and has an effective focal length of EFL_G2. The image surface 607 of the last element nearest the light source 606 has a radius of RL. In a preferred embodiment all lens elements are made of glass material in order to achieve maximum thermal stability. Further the bending of individual lens shape is chosen to lower fabrication cost, stray light generation and aberration contribution.

Table 4 shows the optical prescription of Example 4.

TABLE 4

| | | | Thick- | ND, | Clear | |
|---|---|---|---|---|---|---|
| Surface | Type | Radius | ness | ABBE NO. | Diam | LENS |
| OBJ | SPHERICAL | Infinity | 10000 | | | |
| 1 | SPHERICAL | 43.91 | 11.43 | 1.568, 56.059 | 50.00 | L1 |
| 2 | SPHERICAL | −150.32 | 13.72 | | 50.00 | |
| STO | SPHERICAL | −13.85 | 1.40 | 1.620, 36.347 | 19.98 | L2 |
| 4 | SPHERICAL | 28.31 | 9.99 | 1.568, 56.059 | 25.33 | L3 |
| 5 | SPHERICAL | −18.47 | 0.20 | | 25.33 | |
| 6 | SPHERICAL | 40.36 | 5.13 | 1.622, 58.154 | 27.97 | L4 |
| 7 | SPHERICAL | −68.50 | 0.18 | | 27.80 | |
| 8 | SPHERICAL | 15.67 | 7.83 | 1.772, 49.613 | 24.10 | L5 |
| 9 | SPHERICAL | 38.17 | 7.68 | | 22.71 | |
| IMA | SPHERICAL | Infinity | | | 13.95 | |

The parametric equations (1)-(14) are satisfied.

| | | | | | | | |
|---|---|---|---|---|---|---|---|
| EXAMPLE | EFL/Ah | TTL/Ah | Ri/TTL | F/# | EFL_G1/EFL | EFL_G2/EFL | RL/EFL |
| 4 | 1.44 | 4.50 | 0.24 | 0.7 | 1.96 | 1.62 | 2.07 |
| | | | | | EFL_L1/EFL 3.30 | EFL_L5/EFL 1.62 | |
| | | | | | EFL_L2/EFL −0.80 | | |
| | | | | | EFL_L3/EFL 1.15 | | |
| | | | | | EFL_L4/EFL 2.25 | | |

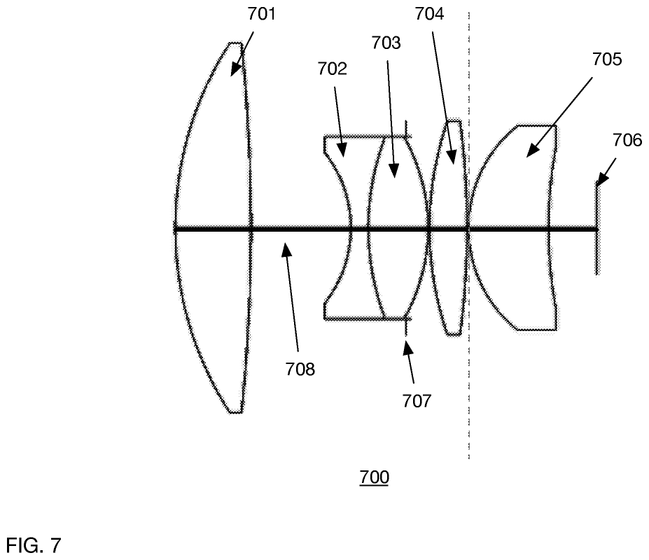

FIG. 7 shows the layout of Example 5, a five element lens system 700. This design has a horizontal field angle of +/−20° with a relative aperture (F/#) of F/0.7 and an effective focal length EFL of 19 mm with a 12.8 mm source Ah.

It comprises five lens elements. The lens element 701 L1 from the left is a positive powered glass element with optical property of a higher abbe number and therefore relatively small color dispersion. The second lens 702 L2 from the left is a negative powered glass element with optical property of a lower abbe number and therefore relatively higher color dispersion. The third lens 703 L3 from the left is a positive powered glass element with a higher Abbe number and therefore relatively lower color dispersion. An aperture 707 is on the image side of this lens element 703. The fourth elements 704 L4 from left is positively powered glass element with a high Abbe number and therefore relatively lower color dispersion. Lens elements L1-L4 form the first lens group G1. The fifth element 705 L5 from left forms G2 and is positively powered glass element with a high Abbe number and therefore relatively lower color dispersion. Such choice of dispersion properties of elements facilitates the good color correction as required by automobile lighting lens application. All elements are made of glass material. This arrangement provide good protection from heat and UV radiation generated by light source even with the close proximity of lens elements to the light source. The all glass design also is helpful to the thermal performance stability of the lens assembly.

The image surface (RL) of the last element is concave facing the light source array 706 and has a curvature radius divided by the total track length (TTL) satisfying above specified Equation (4) to improve light collection efficiency, to keep the lens barrel rear end diameter small, to improve optical performance uniformity over the projected field and to keep the stray light low.

The lens system is used to project an image or light pattern originating from an image or light pattern formed on the light source 706. A non-limiting example light source is an LED array having a horizontal size (Aₕ) 109 of 12.8 mm. Details of an example LED array light source are shown in FIG. 1. The physical length (TTL) of the example 1 lens system is 31 mm. However, dimensions of the lens system 100 can be scaled to accommodate light sources having different dimensions.

Table 5 shows the optical prescription of Added Example 5.

TABLE 5

| | | | | | | Clear | |
|---|---|---|---|---|---|---|---|
| Surface | Type | Radius | Thickness | Nd | Vd | Diam | lens |
| OBJ | SPHERICAL | Infinity | 10000 | | | 7305.4 | |
| 1 | SPHERICAL | 46.1136 | 10.6417 | 1.5688 | 56.06 | 51 | L1 |
| 2 | SPHERICAL | −246.5068 | 14.0228 | | | 51 | |
| 3 | SPHERICAL | −16.6963 | 2.467 | 1.6727 | 32.18 | 20.79 | L2 |
| 4 | SPHERICAL | 34.0702 | 8.3849 | 1.6385 | 55.47 | 24.05 | L3 |
| 5 | SPHERICAL | −25.1577 | 0.31 | | | 25.22 | |
| STO | SPHERICAL | Infinity | 3.2625 | | | 25.22 | |
| 7 | SPHERICAL | 44.0977 | 5.3013 | 1.804 | 46.57 | 29.5 | L4 |
| 8 | SPHERICAL | −107.2882 | 0.1938 | | | 29.56 | |
| 9 | SPHERICAL | 17.8535 | 11.2492 | 1.755 | 52.33 | 28.2 | L5 |
| 10 | SPHERICAL | 60.0909 | 6.7903 | | | 22.53 | |
| IMA | SPHERICAL | Infinity | | | | 12.86 | |

The parametric equations (1)-(14) are satisfied:

| EXAMPLE | EFL/Ah | TTL/Ah | Ri/TTL | F/# | EFL_G1/EFL | EFL_G2/EFL | RL/EFL |
|---|---|---|---|---|---|---|---|
| 5 | 1.48 | 4.89 | 0.27 | 0.7 | 2.06 | 1.61 | 3.16 |
| | | | | | EFL_L1/EFL 3.7 | EFL_L5/EFL 1.6 | |
| | | | | | EFL_L2/EFL −1.3 | | |
| | | | | | EFL_L3/EFL 2.2 | | |
| | | | | | EFL_L4/EFL 2.1 | | |

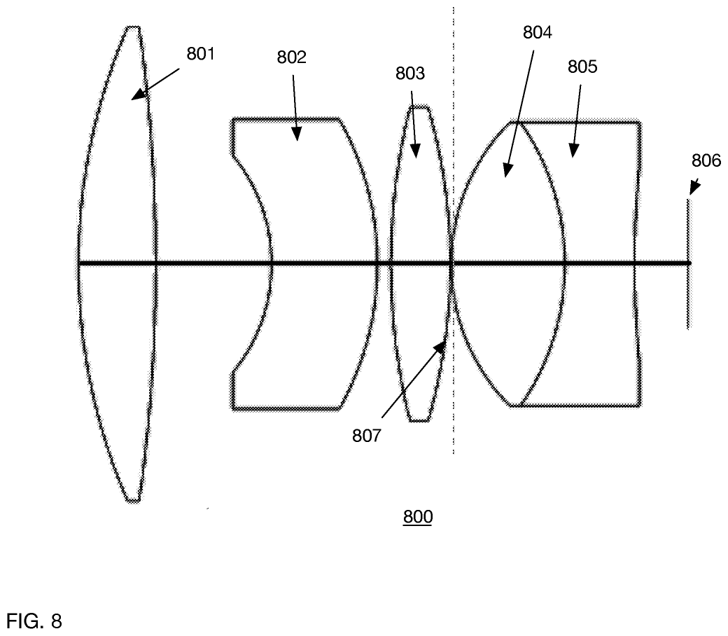

FIG. 8 shows the layout of Example 6, a five lens system 800. This design has a horizontal field angle of +/−20° with a relative aperture (F/#) of F/0.7 and an effective focal length EFL of 19 mm with a 12.8 mm source Ah.

It comprises five lens elements. The first lens element 801 L1 from the left is a positive powered glass element with optical property of a higher abbe number and therefore relatively small color dispersion. The second lens 802 L2 from the left is a negative powered glass element with optical property of a lower abbe number and therefore relatively higher color dispersion. The third lens 803 L3 from the left is a positive powered glass element with a higher Abbe number and therefore relatively lower color dispersion. There is an aperture stop 807 on the image side of the third lens element 803. The first three elements and the aperture stop form group 1. The fourth elements 804 L4 from left is positively powered glass element with a high Abbe number and therefore relatively lower color dispersion. The fifth element 805 L5 from left is negatively powered glass element with a low Abbe number and therefore relatively high color dispersion. Such choice of dispersion properties of elements facilitates the good color correction as required by automobile lighting lens application. Each element can be made either from optical plastic or glass materials. In preferred embodiments, all elements are made of glass materials. All elements are made of glass material. L4 and L5 form group 2. This arrangement provides good protection from heat and UV radiation generated by light source 806 even with the close proximity of lens elements to the light source. The all glass design also is helpful to the thermal performance stability of the lens assembly.

The image surface (RL) of the last element 805 is concave facing the light source array and has a curvature radius divided by the total track length (TTL) satisfying above specified Equation (4) to improve light collection efficiency, to keep the lens barrel rear end diameter small, to improve optical performance uniformity over the projected field and to keep the stray light low.

The lens system is used to project an image or light pattern originating from an image or light pattern formed on the light source 806. A non-limiting example light source is an LED array having a horizontal size (Aₕ) 109 of 12.8 mm. Details of an example LED array light source are shown in FIG. 1. The physical length (TTL) of the example 1 lens system is 31 mm. However, dimensions of the lens system 800 can be scaled to accommodate light sources having different dimensions.

Table 6 shows the optical prescription of Added Example 6.

TABLE 6

| | | | | | | Clear | |
|---|---|---|---|---|---|---|---|
| Surface | Type | Radius | Thickness | Nd | Vd | Diam | lens |
| OBJ | SPHERICAL | Infinity | 10000 | | | 7295.02 | |
| 1 | SPHERICAL | 62.5687 | 8.1689 | 1.5688 | 56.06 | 50 | L1 |
| 2 | SPHERICAL | −178.7001 | 12.2411 | | | 50 | |
| STO | SPHERICAL | −17.9803 | 11.1804 | 1.8467 | 23.79 | 22.96 | L2 |
| 4 | SPHERICAL | −30.7419 | 1.4131 | | | 30.44 | |
| 5 | SPHERICAL | 68.5712 | 6.2821 | 1.7725 | 49.61 | 33.07 | L3 |
| 6 | SPHERICAL | −58.9608 | 0.0998 | | | 33.06 | |
| 7 | SPHERICAL | 21.135 | 12.0001 | 1.7725 | 49.61 | 29.91 | L4 |
| 8 | SPHERICAL | −26.1152 | 7.3653 | 1.8467 | 23.79 | 28.62 | L5 |
| 9 | SPHERICAL | 107.5034 | 5.6685 | | | 20.07 | |
| IMA | SPHERICAL | Infinity | | | | 13.64 | |

The parametric equations (1)-(14) are satisfied:

| EXAMPLE | EFL/Ah | TTL/Ah | Ri/TTL | F/# | EFL_G1/EFL | EFL_G2/EFL | RL/EFL |
|---|---|---|---|---|---|---|---|
| 6 | 1.48 | 5.03 | 0.26 | 0.7 | 2.28 | 1.82 | 5.66 |
| | | | | | EFL_L1/EFL 4.4 | EFL_L4/EFL 1.6 | |
| | | | | | EFL_L2/EFL -4.6 | EFL_L5/EFL -4.9 | |
| | | | | | EFL_L3/EFL 2.2 | | |

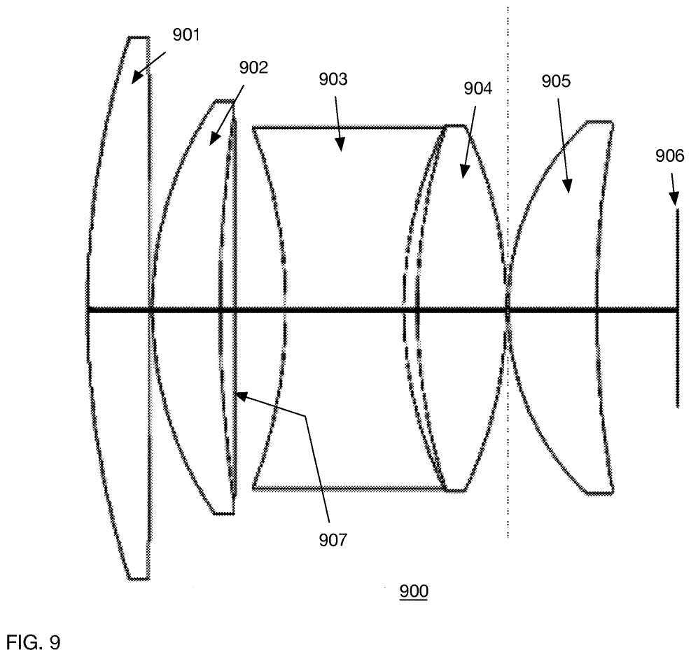

FIG. 9 shows the layout of Example 7, a five lens system 900. This design has a horizontal field angle of +/−18° with a relative aperture (F/#) of F/0.65 and an effective focal length EFL of 14 mm with a 9 mm source Ah.

It comprises five lens elements. The first two lenses 901 L1 and 902 L2 from the left are positive powered glass element with optical property of a higher abbe number and therefore relatively small color dispersion. An aperture stop is located on the image side of L2 907. The third lens 903 L3 from the left is a negative powered glass element with a smaller Abbe number and therefore relatively higher color dispersion. The fourth elements 904 L4 from left is positively powered glass element with a high Abbe number and therefore relatively lower color dispersion. The fifth element 905 L5 from left is positively powered glass element with a low Abbe number and therefore relatively higher color dispersion. Such choice of dispersion properties of elements facilitates the good color correction as required by automobile lighting lens application. All elements are made of glass material. This arrangement provide good protection from heat and UV radiation generated by light source even with the close proximity of lens elements to the light source. Each element can be made either from optical plastic or glass materials. When the first element is made of plastic material, the aperture shape can be made more complex by plastic molding, and the overall manufacturing cost can also be reduced. In preferred embodiments, all elements are made of glass materials. The all glass design also is helpful to the thermal performance stability of the lens assembly.

The image surface (RL) of the last element is concave facing the light source array and has a curvature radius divided by the total track length (TTL) satisfying above specified Equation (4) to improve light collection efficiency, to keep the lens barrel rear end diameter small, to improve optical performance uniformity over the projected field and to keep the stray light low.

The lens system is used to project an image or light pattern originating from an image or light pattern formed on the light source 906. A non-limiting example light source is an LED array having a horizontal size (Aₕ) 109 of 9 mm. Details of an example LED array light source are shown in FIG. 1. The physical length (TTL) of the example 1 lens system is 31 mm. However, dimensions of the lens system 900 can be scaled to accommodate light sources having different dimensions.

Table 7 shows the optical prescription of Added Example 7.

TABLE 7

| | | Radius | Thickness | | | Clear | |
|---|---|---|---|---|---|---|---|
| Surface | Type | (mm) | (mm) | Nd | Vd | Diameter | lens |
| OBJ | SPHERICAL | Infinity | Infinity | | | 0 | |
| 1 | SPHERICAL | 41.5983 | 3.3245 | 1.7725 | 49.6 | 28 | L1 |
| 2 | SPHERICAL | −736.6161 | 0.0925 | | | 26.54 | |
| 3 | SPHERICAL | 17.2954 | 3.585 | 1.7725 | 49.6 | 20.43 | L2 |
| 4 | SPHERICAL | 63.1702 | 0.7463 | | | 18.95 | |
| STO | SPHERICAL | Infinity | 2.7087 | | | 18.61 | |
| 6 | SPHERICAL | −23.4852 | 6.2198 | 1.8467 | 23.78 | 18.51 | L3 |
| 7 | SPHERICAL | 19.6782 | 0.7148 | | | 18.57 | |
| 8 | SPHERICAL | 27.5192 | 4.6779 | 1.7725 | 49.6 | 18.57 | L4 |
| 9 | SPHERICAL | −19.7704 | 0.1 | | | 18.1 | |
| 10 | SPHERICAL | 12.1541 | 4.6749 | 1.9037 | 31.31 | 18.32 | L5 |
| 11 | SPHERICAL | 48.3391 | 4.279 | | | 17.7 | |
| IMA | SPHERICAL | Infinity | | | | | |

The parametric equations (1)-(14) are satisfied:

| EXAMPLE | EFL/Ah | TTL/Ah | Ri/TTL | F/# | EFL_G1/EFL | EFL_G2/EFL | RL/EFL |
|---|---|---|---|---|---|---|---|
| 7 | 1.56 | 3.46 | 0.39 | 0.7 | 1.79 | 1.20 | 3.45 |
| | | | | | EFL_L1/EFL 3.6 | EFL_L5/EFL 1.2 | |
| | | | | | EFL_L2/EFL 2.1 | | |
| | | | | | — | | |
| | | | | | EFL_L3/EFL 0.84 | | |
| | | | | | EFL_L4/EFL 1.1 | | |

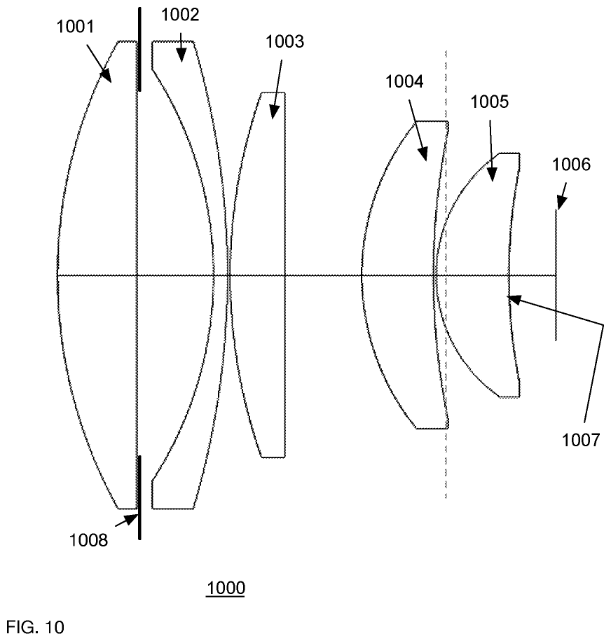

FIG. 10 shows the layout of Example 8, a lower resolution embodiment 1000 in which the third lens element of group 1 is split into two lens elements and Group 2 has a single lens element, or, five lens elements total. This design has a field angle of +/−15° with a relative aperture of F/0.6 and an effective focal length of 23.3 mm. The example shows an imaging lighting lens 1000 of a very low F/# which has very good optical efficiency but less requirement in resolution.

It comprises 2 lens groups. Group 1 comprises L1 1001, L2 1002 and L3_1 1003 and L3_2 1004. There is an aperture stop located on the image surface of L1. Group 1 has an effective focal length of EFL_G1. L1, L2 and L3, comprising L3_1 and L3_2, have positive, negative positive optical powers respectively. Group 2 comprises L4 1005. Group 2 has an effective focal length of EFL_G2 comprising the single lens element, L4 of positive power with an effective focal length of EFL_L4. The image surface of the Group 2 last element has a radius of R_{L}. Each element can be made either from optical plastic or glass materials. When the first/second elements are made of plastic materials, the aperture shape can be made more complex by plastic molding, and the overall manufacturing cost can also be reduced. In preferred embodiments, all elements are made of glass materials. In a preferred embodiment all lens elements are made of glass material in order to achieve maximum thermal stability. Further the bending of individual lens shape is chosen to lower fabrication cost, stray light generation and aberration contribution.

Table 8 shows the optical prescription of Example 8.

TABLE 8

| | | | | | Clear | |
|---|---|---|---|---|---|---|
| Surface | Type | Radius | Thickness | ND, ABBE NO. | Diam Comment | LENS |
| OBJ | SPHERICAL | Infinity | Infinity | | 0.00 | |
| 1 | SPHERICAL | 51.44 | 8.48 | 1.772, 49.613 | 50.00 | L1 |
| STO | SPHERICAL | Infinity | 8.29 | | 38.60 | |
| 3 | SPHERICAL | −40.16 | 1.49 | 1.846, 23.787 | 44.00 | L2 |
| 4 | SPHERICAL | −87.19 | 0.29 | | 50.00 | |
| 5 | SPHERICAL | 58.17 | 5.88 | 1.772, 49.613 | 39.00 | L3 |
| 6 | SPHERICAL | Infinity | 8.27 | | 39.00 | |
| 7 | SPHERICAL | 25.92 | 7.70 | 1.622, 58.154 | 32.90 | L4 |
| 8 | SPHERICAL | 76.45 | 0.30 | | 30.65 | |
| 9 | SPHERICAL | 15.88 | 7.81 | 1.622, 58.154 | 26.09 | L5 |
| 10 | SPHERICAL | 58.84 | 5.01 | | 23.06 | |
| IMA | SPHERICAL | Infinity | | | 14.12 | |

The parametric equations (1)-(14) are satisfied:

| EXAMPLE | EFL/Ah | TTL/Ah | Ri/TTL | F/# | EFL_G1/EFL | EFL_G2/EFL | RL/EFL |
|---|---|---|---|---|---|---|---|
| 8 | 1.82 | 4.18 | 0.30 | 0.6 | 1.56 | 1.4 | 2.53 |
| | | | | | EFL_L1/EFL 2.847 | EFL_L5/EFL 1.396 | |
| | | | | | EFL_L2/EFL −3.8 | | |
| | | | | | EFL_L3/EFL 3.219 | | |
| | | | | | EFL_L4/EFL 2.543 | | |

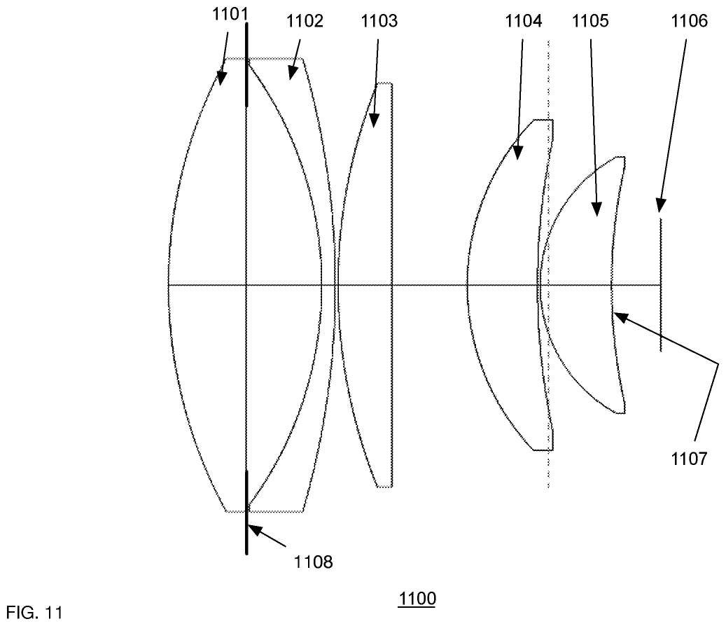

FIG. 11 shows the layout of Example 9, a low resolution embodiment lens system 1100 that has four lens elements in the first group where the third lens element L3, is split into two lens elements L3 and L4. The second group has a single positive lens element or five lens elements total. This design has a field angle of +/−15° with a relative aperture of F/0.6 and an effective focal length of 24.4 mm. The example of present invention shows an imaging lighting lens of a very low F/# which has very good optical efficiency but less requirement in resolution. It comprises 2 lens groups. Group 1 comprises L1-L4. Group 1 has an effective focal length of EFL_G1. L1, L2, and, the combination L3, L4 have positive, negative and positive optical powers respectively. There is an aperture stop 1108 on the image side of lens L1. Group 2 comprises L4 1105. Group 2 has an effective focal length of EFL_G2. L4 has positive power with an effective focal length of EFL_L4. The image surface 1107 of the Group 2 last element, nearest the light source 1106 has a radius of R_{L}. Each element can be made either from optical plastic or glass materials. When the first element is made of plastic material, the aperture shape can be made more complex by plastic molding, and the overall manufacturing cost can also be reduced. In preferred embodiments, all elements are made of glass materials. In a preferred embodiment all lens elements are made of glass material in order to achieve maximum thermal stability. Further the bending of individual lens shape is chosen to lower fabrication cost, stray light generation and aberration contribution. Table 9 shows the optical prescription of Example 9.

TABLE 9

| | | | | | Clear | |
|---|---|---|---|---|---|---|
| Surf | Type | Radius | Thickness | ND, ABBE NO. | Diam | LENS |
| OBJ | SPHERICAL | Infinity | Infinity | | | |
| 1 | SPHERICAL | 52.11 | 8.59 | 1.772, 49.613 | 50.00 | L1 |
| STO | SPHERICAL | Infinity | 8.39 | | 40.52 | |
| 3 | SPHERICAL | −40.68 | 1.51 | 1.846, 23.787 | 48.52 | L2 |
| 4 | SPHERICAL | −88.33 | 0.29 | | 50.00 | |
| 5 | SPHERICAL | 58.92 | 5.96 | 1.772, 49.613 | 44.57 | L3 |
| 6 | SPHERICAL | Infinity | 8.38 | | 44.57 | |
| 7 | SPHERICAL | 26.25 | 7.80 | 1.589, 61.267 | 36.47 | L4 |
| 8 | SPHERICAL | 77.44 | 0.30 | | 32.42 | |
| 9 | SPHERICAL | 16.09 | 7.91 | 1.589, 61.267 | 28.36 | L5 |
| 10 | SPHERICAL | 59.60 | 5.47 | | 26.34 | |
| IMA | SPHERICAL | Infinity | | | 14.66 | |

The parametric equations (1)-(14) are satisfied:

| EXAMPLE | EFL/Ah | TTL/Ah | Ri/TTL | F/# | EFL_G1/EFL | EFL_G2/EFL | RL/EFL |
|---|---|---|---|---|---|---|---|
| 9 | 1.91 | 4.27 | 0.29 | 0.6 | 1.54 | 1.43 | 2.44 |
| | | | | | EFL_L1/EFL 2.751 | EFL_L5/EFL 1.43 | |
| | | | | | EFL_L2/EFL −3.672 | | |
| | | | | | EFL_L3_1/EFL 3.11 | | |
| | | | | | EFL_L4/EFL 2.604 | | |

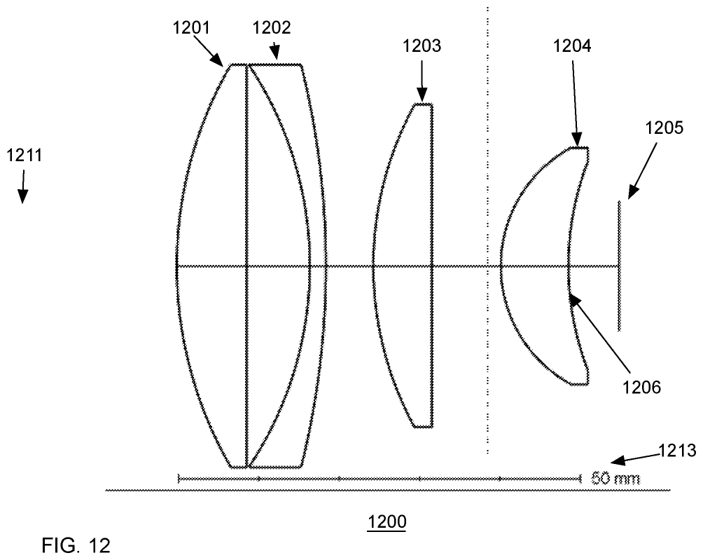

FIG. 12 shows the layout of Example 10, lens system 1200. This design has a field angle of +/−15° with a relative aperture (F/#) of F/0.58 and an effective focal length EFL of 24.5 mm with a 12.8 mm source. The same lens design scales to other size sources through equation (7). This 10^{TH} example of present invention shows an imaging lighting lens of a very low F/# which has very good optical efficiency and is a lower resolution example.

It comprises two lens groups, in order from object end 1207 to the light source end 1208. A first positive power group (counting from the object side) comprises three elements L1 1201, L2 1202, and L3, 1203 with positive, negative and positive powers respectively. The effective focal length of the 12^{st} group is EFL_G1 and the effective focal length of L1 1201 is EFL_L1, L2 1202 is EFL_L2, and the effective focal length of the third lens element in group 1 is EFL_L3. A second positive power group comprises one to three lens elements with positive optical power in the case of a single lens element, positive then negative power with two lens elements and positive, positive, negative optical powers in the case of three lens elements. In this case a single lens element 1204. The effective focal length of the 2^{nd} group and single lens 1204 in the second group is EFL_L4 and also EFL_G2.

The image surface (RL) 1206 of the last element is concave facing the light source array 1205 and has a curvature radius divided by the total track length (TTL) satisfying Equation (4).

Each element can be made either from optical plastic or glass materials. When the first element is made of plastic material, the aperture shape can be made more complex by plastic molding, and the overall manufacturing cost can also be reduced. In preferred embodiments, all elements are made of glass materials. In a preferred embodiment all lens elements are made of glass material in order to achieve maximum thermal stability. Further the curvature of individual lens shape is chosen to lower fabrication cost, stray light minimization and aberration contribution.

All of the lens elements in this first example are spherical. The radius of curvature for all surfaces of all lens elements divided by the total track length: |Rᵢ|/TTL>=0.23 as in equation (4).

The lens has a compact design. The clear diameter 1210 of the lens system is 50 mm. The physical length (TTL) 1213 of the lens system is 65 mm. The lens system is used to project an image or light pattern 1211 originating from an image or light pattern 1212 formed on the light source 1205. A non-limiting example light source is an LED array 1205 having a horizontal size (Aₕ) 1209 of 12.8 mm. Details of an example LED array light source are as shown in FIG. 1 and already discussed The dimensions of the lens system 1200 are scaled to accommodate light sources having different dimensions.

Table 10 shows the optical prescription of Example 10.

TABLE 10

| | | Radius | Thickness | | Clear | |
|---|---|---|---|---|---|---|
| Surface | Type | (mm) | (mm) | nd, abbe number | Diameter (mm) | lens |
| OBJ | SPHERICAL | Infinity | Infinity | | 0.00 | |
| 1 | SPHERICAL | 49.69 | 8.70 | 1.772, 49.613 | 50.00 | L1 |
| STO | SPHERICAL | Infinity | 7.87 | | 50.00 | |
| 3 | SPHERICAL | −44.82 | 2.00 | 1.846, 23.787 | 50.00 | L2 |
| 4 | SPHERICAL | −102.40 | 5.90 | | 50.00 | |
| 5 | SPHERICAL | 41.61 | 7.30 | 1.773, 49614 | 40.00 | L3 |
| 6 | SPHERICAL | Infinity | 8.56 | | 39.00 | |
| 7 | SPHERICAL | 16.71 | 8.41 | 1.903, 31.318 | 29.00 | L4 |
| 8 | SPHERICAL | 35.84 | 6.30 | | 26.00 | |
| IMA | SPHERICAL | Infinity | | | 15.50 | |

The parametric equations (1)-(14) are satisfied:

| EXAMPLE | EFL/Ah | TTL/Ah | Ri/TTL | F/# | EFL_G1/EFL | EFL_G2/EFL | RL/EFL |
|---|---|---|---|---|---|---|---|
| 10 | 1.91 | 4.30 | 0.30 | 0.6 | 1.925 | 1.161 | 1.46 |
| | | | | | EFL_L1/EFL 2.611 | EFL_L4 1.161 | |
| | | | | | EFL_L2/EFL −3.869 | | |
| | | | | | EFL_L3/EFL 2.187 | | |

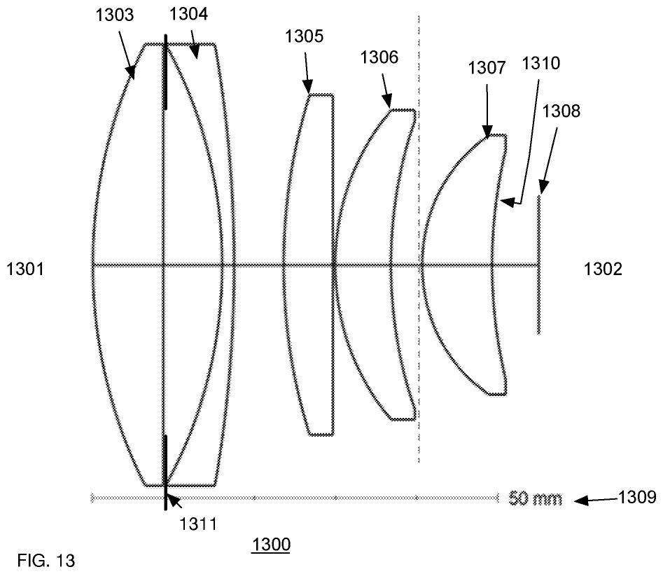

FIG. 13 shows the layout of Example 11, a low resolution five lens element embodiment lens system 1300. This design has a field angle of +/−15° with a relative aperture of F/0.64 and an effective focal length EFL of 24.8 mm. This example of the present invention shows an imaging lighting lens of a very low F/# which has very good optical efficiency but less requirement in resolution.

It comprises 2 lens groups. Group 1 comprises from object 1301 to image light source end 1302, L1 1303, L2 1304 and L3_1 1305 and L3_2. In this example the positive lens element L3 is split into two positive lens elements L3_1 and L3_2. Group 1 has an effective focal length of EFL_G1. L1, L2 and L3 (L31 and L3_2) have positive, negative and positive optical powers respectfully. An aperture stop 1311 is located on the image surface of L1 1303. Group 2 comprises two positive power lens elements, L4 1306 and L5 1307. Group 2 has an effective focal length of EFL_G2 and positive power. The image surface 1310 of the Group 2 last element has a radius of R_{L}. Each element can be made either from optical plastic or glass materials. When the first element is made of plastic material, the aperture shape can be made more complex by plastic molding, and the overall manufacturing cost can also be reduced. In a preferred embodiment all lens elements are made of glass material in order to achieve maximum thermal stability. Further the bending of individual lens shape is chosen to lower fabrication cost, stray light generation and aberration contribution. The radius of curvature for all surfaces of all lens elements divided by the total track length |Rᵢ|/TTL>=0.23.

Table 11 shows the optical prescription of Example 11.

TABLE 11

| | | | | | Clear | |
|---|---|---|---|---|---|---|
| Surface | Type | Radius | Thickness | ND, ABBE NO. | Diam | LENS |
| OBJ | SPHERICAL | Infinity | Infinity | | 0.00 | |
| 1 | SPHERICAL | 47.91 | 5.68 | 1.772, 49.613 | 50.00 | L1 |
| STO | SPHERICAL | Infinity | 7.25 | | 38.12 | |
| 3 | SPHERICAL | −48.19 | 1.49 | 1.846, 23.787 | 50.00 | L2 |
| 4 | SPHERICAL | −131.33 | 6.10 | | 50.00 | |
| 5 | SPHERICAL | 59.44 | 6.06 | 1.772, 49.613 | 38.50 | L3 |
| 6 | SPHERICAL | Infinity | 0.30 | | 37.81 | |
| 7 | SPHERICAL | 25.65 | 6.86 | 1.622, 58.154 | 35.04 | L4 |
| 8 | SPHERICAL | 46.52 | 3.87 | | 32.63 | |
| 9 | SPHERICAL | 17.15 | 8.65 | 1.622, 58.154 | 29.39 | L5 |
| 10 | SPHERICAL | 52.05 | 5.76 | | 25.98 | |
| IMA | SPHERICAL | Infinity | | | 15.73 | |

The parametric equations (1)-(14) are satisfied:

| EXAMPLE | EFL/Ah | TTL/Ah | Ri/TTL | F/# | EFL_G1/EFL | EFL_G2/EFL | RL/EFL |
|---|---|---|---|---|---|---|---|
| 11 | 1.94 | 4.30 | 0.31 | 0.6 | 1.56 | 1.5 | 2.10 |
| | | | | | EFL_L1/EFL 2.68 | EFL_L51.51 | |
| | | | | | EFL_L2/EFL −3.63 | | |
| | | | | | EFL_L3/EFL 3.09 | | |
| | | | | | EFL_L4/EFL 3.28 | | |

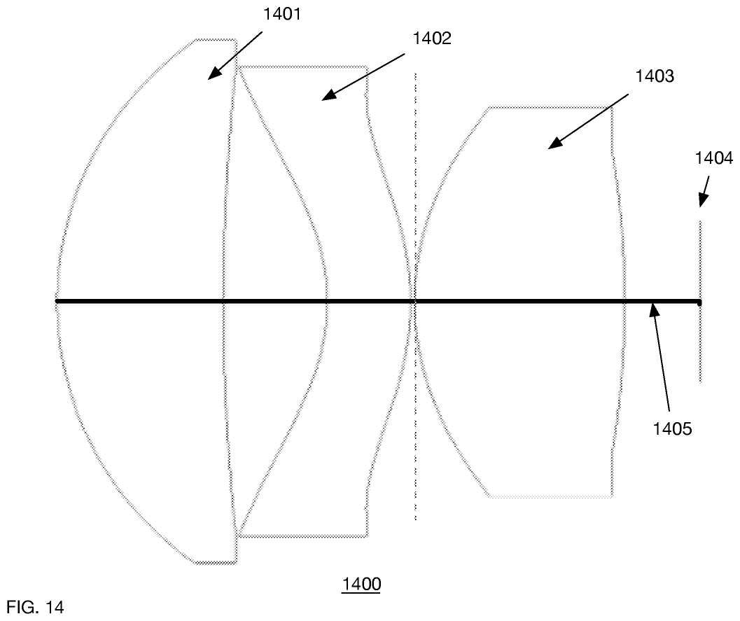

FIG. 14 shows the layout of Example 12, a three lens system 1400. This design has a horizontal field angle of +/−14° with a relative aperture (F/#) of F/0.6 and an effective focal length EFL of 18 mm with a 9 mm source Ah.

It comprises three lens elements. The first lens 1401 L1 from the left is a positive powered glass element with optical property of a larger abbe number and therefore relatively lower color dispersion. There is an aperture stop on the image side of the first element 1401. The second lens 1402 L2 from the left is a weak powered shell-like element with a smaller Abbe number and therefore relatively higher color dispersion. The third element 1403 L3 from left is a positive powered element with a larger Abbe number and therefore relatively lower color dispersion. Such choice of dispersion properties of elements facilitates the good color correction as required by automobile lighting lens application. The second lens 1402 L2 from the left is of plastic material with a higher working temperature property and is shielded from the light source by a relatively thick third lens on the right 1403 L3. This arrangement provide good protection from heat and UV radiation generated by light source even with the close proximity of lens elements to the light source. The strongly powered glass elements L1 and L3 and the weakly powered L2 are helpful to the performance stability of the lens assembly. The additional design degrees of freedom available from using aspheric profile for object/image surfaces of L2 1402 and L3 1403 can further improve the aberration correction of the system without incurring additional manufacturing cost due to the material chosen for L2 and L3 can be molded.

The image surface (RL) of the last element 1403 is convex facing the light source array and has a curvature radius divided by the total track length (TTL) satisfying above specified Equation (4) to improve light collection efficiency, to keep the lens barrel rear end diameter small, to improve optical performance uniformity over the projected field and to keep the stray light low.

The lens system is used to project an image or light pattern originating from an image or light pattern formed on the light source. A non-limiting example light source is an LED array having a horizontal size (Aₕ) 109 of 9 mm. Details of an example LED array light source are shown in FIG. 1. The physical length (TTL) of the example lens system is 37.4 mm. However, dimensions of the lens system 100 can be scaled to accommodate light sources having different dimensions.

Table 2 shows the optical prescription of Added Example 12.

TABLE 12

| | | Radius | Thickness | | | Clear | |
|---|---|---|---|---|---|---|---|
| Surface | Type | (mm) | (mm) | Nd | Vd | Diameter | lens |
| OBJ | SPHERICAL | Infinity | Infinity | | | 0 | |
| 1 | SPHERICAL | 18.437 | 9.6921 | 1.6204 | 60.37 | 30.43 | L1 |
| STO | SPHERICAL | 133.1761 | 6.0627 | | | 27.5 | |
| 3 | ASPHERICAL | −10.745 | 4.8474 | 1.5844 | 27.52 | 27.28 | L2 |
| 4 | ASPHERICAL | −14.5343 | 0.1896 | | | 25.09 | |
| 5 | ASPHERICAL | 14.1122 | 12.2454 | 1.6938 | 53.15 | 22.69 | L3 |
| 6 | SPHERICAL | −55.5404 | 4.3851 | | | 18.13 | |
| IMA | SPHERICAL | Infinity | | | | 9.37 | |

L2 and L3 object/Image surface are aspherical described by the following equation:

$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16} .$$

The parameters for this equation are as follows:

Object Surface of L2

| | |
|---|---|
| k | −2.454058 |
| Coefficient on r\hat{ } 2 | 0.00E+00 |
| Coefficient on r\hat{ } 4 | 0 |
| Coefficient on r\hat{ } 6 | 2.8020222e−07 |
| Coefficient on r\hat{ } 8 | −7.1469657e−10 |
| Coefficient on r\hat{ }10 | 0.00E+00 |
| Coefficient on r\hat{ }12 | 0.00E+00 |
| Coefficient on r\hat{ }14 | 0.00E+00 |
| Coefficient on r\hat{ }16 | 0.00E+00 |

Image Surface of L2

| | |
|---|---|
| k | 0 |
| Coefficient on r\hat{ } 2 | 0.00E+00 |
| Coefficient on r\hat{ } 4 | 0.00014641359 |
| Coefficient on r\hat{ } 6 | 5.587806e−08 |
| Coefficient on r\hat{ } 8 | 1.2722784e−09 |
| Coefficient on r\hat{ }10 | 0.00E+00 |
| Coefficient on r\hat{ }12 | 0.00E+00 |
| Coefficient on r\hat{ }14 | 0.00E+00 |
| Coefficient on r\hat{ }16 | 0.00E+00 |

Object Surface of L3

| | |
|---|---|
| k | 0 |
| Coefficient on r\hat{ } 2 | 0.00E+00 |
| Coefficient on r\hat{ } 4 | −0.00011070554 |
| Coefficient on r\hat{ } 6 | 9.099552e−07 |
| Coefficient on r\hat{ } 8 | −5.2025639e−09 |
| Coefficient on r\hat{ }10 | 0.00E+00 |
| Coefficient on r\hat{ }12 | 0.00E+00 |
| Coefficient on r\hat{ }14 | 0.00E+00 |
| Coefficient on r\hat{ }16 | 0.00E+00 |

The parametric equations (1)-(14) are satisfied:

| EXAMPLE | EFL/Ah | TTL/Ah | Ri/TTL | F/# | EFL_G1/EFL | EFL_G2/EFL | RL/EFL |
|---|---|---|---|---|---|---|---|
| 12 | 2.00 | 4.16 | 0.29 | 0.6 | 2.56 | 0.97 | 3.09 |
| | | | | | EFL_L1/EFL 1.8 | EFL_L3/EFL 0.97 | |
| | | | | | EFL_L2/EFL −7.4 | | |

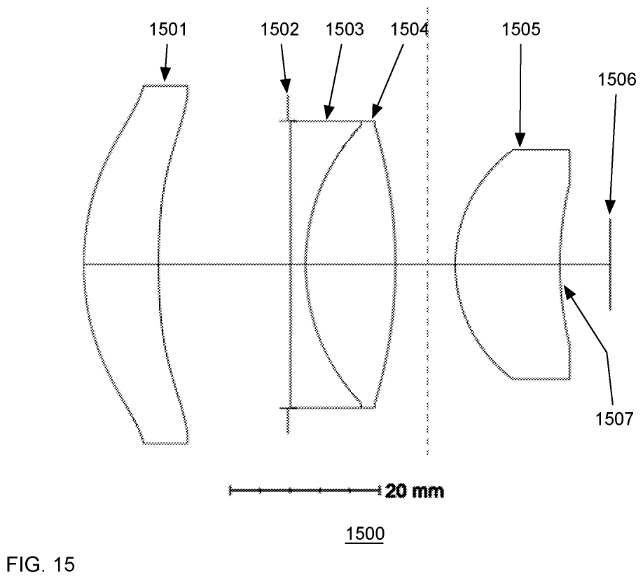

FIG. 15 shows the layout of Example 13, a higher resolution embodiment of an imaging projection lens system 1500. This design has a field angle of +/−12° with a relative aperture of F/0.68 and an effective focal length EFL of 29.5 mm when used with a 12.8 mm (Ah) image source. The design is scaled to other size sources using Equation (2). The 15^{th} example shows an imaging lighting lens which has both good optical efficiency and is high resolution.

It comprises two lens groups. A first group (G1, counting from the object, left, side) comprises an aspheric element L1 1501, where at least one of the two lens surfaces is aspheric, a negative power element L2, 1502 and a positive power element L3, 1504. L2 and L3 form an air spaced doublet or cemented doublet. The first group includes aperture stop 1502 near the object surface of L2. The first group's effective focal length is EFL_G1. A second group G2, with an effective focal length EFL_G2, comprises positive power element L4 1505. The last surface 1507 of the group G4, nearest the light source 1506 is concave and has a radius of curvature R_{L}.

In preferred embodiment, the EFL_G1 should be equal or greater than 2 times the EFL of the whole lens in order to achieve maximum thermal stability. The stop aperture 1502 is optimally located at or close to the doublet in the 2^{nd} group to achieve good chromatic aberration correction which is important for visual and regulation requirements. Further the radius of curvature of all lens shapes is chosen to lower fabrication cost, stray light generation and aberration contribution as indicated by parametric equation (18).

Table 13 shows the optical prescription of Example 13.

TABLE 13

| | | | | | Clear | lens |
|---|---|---|---|---|---|---|
| Surface | Type | Radius | Thickness | ND, ABBE NO. | Diam | element |
| OBJ | SPHERICAL | Infinity | Infinity | | 0.00 | |
| 1 | ASPHERICAL | 36.44 | 10.00 | 1.493, 53.961 | 47.79 | L1 |
| 2 | ASPHERICAL | 99.24 | 17.30 | | 45.34 | |
| STO | SPHERICAL | Infinity | 0.37 | | 38.33 | |
| 4 | SPHERICAL | −3858.00 | 2.00 | 1.672, 32.178 | 38.26 | L2 |
| 5 | SPHERICAL | 26.89 | 12.00 | 1.696, 55.534 | 37.03 | L3 |
| 6 | SPHERICAL | −63.11 | 7.98 | | 37.03 | |
| 7 | SPHERICAL | 19.00 | 14.00 | 1.729, 54.669 | 30.59 | L4 |
| 8 | SPHERICAL | 45.75 | 6.76 | | 21.79 | |
| IMA | SPHERICAL | Infinity | | | 12.23 | |

L1 object and image surfaces are aspherical described by the following equation:

$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16} .$$

The parameters for this equation are as follows:

Object Surface of L1

| | |
|---|---|
| Coefficient on r² | 0 |
| Coefficient on r⁴ | 8.88E−06 |
| Coefficient on r⁶ | −8.29E−09 |
| Coefficient on r⁸ | −2.14E−11 |

Image Surface of L1

| | |
|---|---|
| Coefficient on r² | 0 |
| Coefficient on r⁴ | 2.16E−05 |
| Coefficient on r⁶ | −3.75E−08 |
| Coefficient on r⁸ | 8.93E−12 |

The minimum radius of curvature of all lens surfaces |Rᵢ|, is |R7|. The powers of groups G1, and, G2 are positive and the powers of lens elements L1 to L4 are positive, negative, positive, positive (+−++) respectively.

| EXAMPLE | EFL/Ah | TTL/Ah | Ri/TTL | F/# | EFL_G1/EFL | EFL_G2/EFL | RL/EFL |
|---|---|---|---|---|---|---|---|
| 13 | 230 | 5.50 | 0.27 | 0.7 | 1.997 | 1.23 | 1.55 |
| | | | | | EFL_L1/EFL 3.75 | EFL_L4 1.23 | |
| | | | | | EFL_L2/EFL −1.34 | | |
| | | | | | EFL_L3/EFL 0.97 | | |

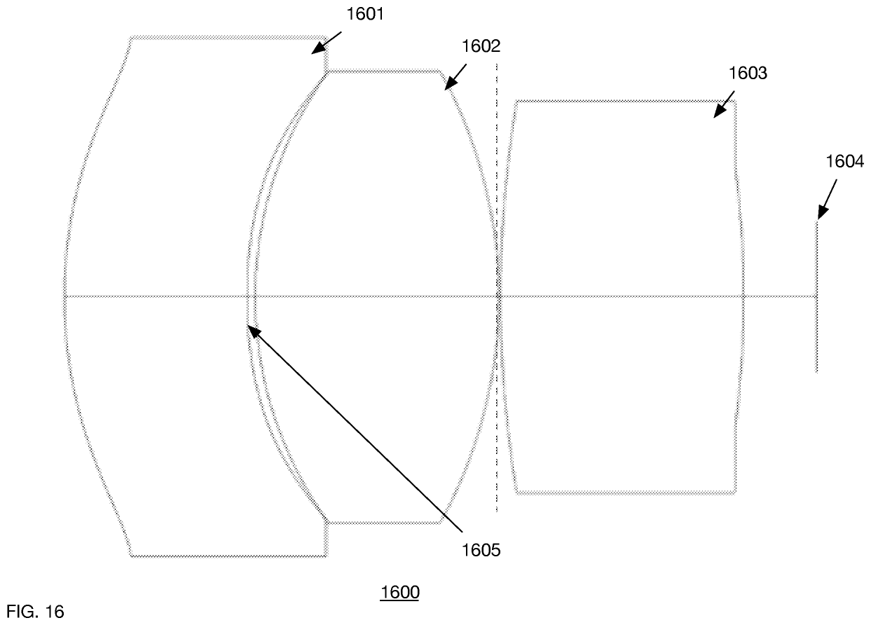

FIG. 16 shows the layout of Example 14, a three lens system 1600. This design has a horizontal field angle of +/−12° with a relative aperture (F/#) of F/0.7 and an effective focal length EFL of 21 mm with a 9 mm source Ah.

It comprises three lens elements. The first lens 1601 L1 from the left is a weakly powered shell-like plastic element with optical property of a smaller abbe number and therefore relatively high color dispersion. There is an aperture stop 1605 on the image side of L1 1601. The second lens 1602 L2 from the left is a strongly powered glass element with a larger Abbe number and therefore relatively lower color dispersion. The third element 1603 L3 from left is a positive powered element with a lower Abbe number and therefore relatively higher color dispersion. Such choice of dispersion properties of elements facilitates the good color correction as required by automobile lighting lens application. The first lens L1 1601 from the left is of plastic material with a higher working temperature property and is shielded from the light source by relatively thick second 1602 L2 and third lens 1603 L3 from right. This arrangement provide good protection from heat and UV radiation generated by light source even with the close proximity of lens elements to the light source. The strongly powered glass elements L2 and L3 and the weakly powered L1 are helpful to the performance stability of the lens assembly. The additional design degrees of freedom available from using aspheric profile for object/image surfaces of L1 1601 and L3 1603 can further improve the aberration correction of the system without incurring additional manufacturing cost due to the material chosen for L1 and L3 can be molded.

The image surface (RL) of the last element 1603 is convex facing the light source array and has a curvature radius divided by the total track length (TTL) to improve light collection efficiency, to keep the lens barrel rear end diameter small, to improve optical performance uniformity over the projected field and to keep the stray light low.

The lens system is used to project an image or light pattern originating from an image or light pattern formed on the light source 1604. A non-limiting example light source is an LED array having a horizontal size (Aₕ) 109 of 9 mm. Details of an example LED array light source are shown in FIG. 1. The physical length (TTL) of the example lens system is 46 mm. However, dimensions of the lens system 100 can be scaled to accommodate light sources having different dimensions.

Table 14 shows the optical prescription of Added Example 14.

TABLE 14

| | | Radius | Thickness | | | Clear | |
|---|---|---|---|---|---|---|---|
| Surface | Type | (mm) | (mm) | Nd | Vd | Diameter | lens |
| OBJ | SPHERICAL | Infinity | Infinity | | | 0 | |
| 1 | ASPHERICAL | 27.7981 | 11.2722 | 1.5844 | 27.52 | 31.97 | L1 |
| STO | ASPHERICAL | 27.7981 | 0.5115 | | | 27.46 | |
| 3 | SPHERICAL | 23.6442 | 15 | 1.6204 | 60.34 | 27.68 | L2 |
| 4 | SPHERICAL | −28.623 | 0.1 | | | 27.83 | |
| 5 | SPHERICAL | 73.5666 | 15 | 1.6889 | 31.08 | 24.1 | L3 |
| 6 | ASPHERICAL | −57.1201 | 4.5004 | | | 16.05 | |
| IMA | SPHERICAL | Infinity | | | | 9.33 | |

L1 and L3 object/Image surface are aspherical described by the following equation:

$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16} .$$

The parameters for this equation are as follows:

Object Surface of L1

| | |
|---|---|
| k | 0 |
| Coefficient on r\hat{ } 2 | 0.00E+00 |
| Coefficient on r\hat{ } 4 | 4.227702e−06 |
| Coefficient on r\hat{ } 6 | −4.3089642e−08 |
| Coefficient on r\hat{ } 8 | 1.0172138e−10 |
| Coefficient on r\hat{ }10 | −8.4233932e−13 |
| Coefficient on r\hat{ }12 | 0.00E+00 |
| Coefficient on r\hat{ }14 | 0.00E+00 |
| Coefficient on r\hat{ }16 | 0.00E+00 |

Image Surface of L1

| | |
|---|---|
| k | 0 |
| Coefficient on r\hat{ } 2 | 0.00E+00 |
| Coefficient on r\hat{ } 4 | 4.7078399e−05 |
| Coefficient on r\hat{ } 6 | 1.6781022e−10 |
| Coefficient on r\hat{ } 8 | −3.305054e−10 |
| Coefficient on r\hat{ }10 | 0 |
| Coefficient on r\hat{ }12 | 0.00E+00 |
| Coefficient on r\hat{ }14 | 0.00E+00 |
| Coefficient on r\hat{ }16 | 0.00E+00 |

Image Surface of L3

| | |
|---|---|
| k | 0 |
| Coefficient on r\hat{ } 2 | 0.00E+00 |
| Coefficient on r\hat{ } 4 | 1.2379278e−05 |
| Coefficient on r\hat{ } 6 | 0 |
| Coefficient on r\hat{ } 8 | 0 |
| Coefficient on r\hat{ }10 | 0 |
| Coefficient on r\hat{ }12 | 0.00E+00 |
| Coefficient on r\hat{ }14 | 0.00E+00 |
| Coefficient on r\hat{ }16 | 0.00E+00 |

The parametric equations (1)-(14) are satisfied:

| EXAMPLE | EFL/Ah | TTL/Ah | Ri/TTL | F/# | EFL_G1/EFL | EFL_G2/EFL | RL/EFL |
|---|---|---|---|---|---|---|---|
| 14 | 2.33 | 5.15 | 0.51 | 0.7 | 1.22 | 2.29 | −2.72 |
| | | | | | EFL_L1/EFL 15 | EFL_L3/EFL 2.3 | |
| | | | | | EFL_L2/EFL 1.1 | | |

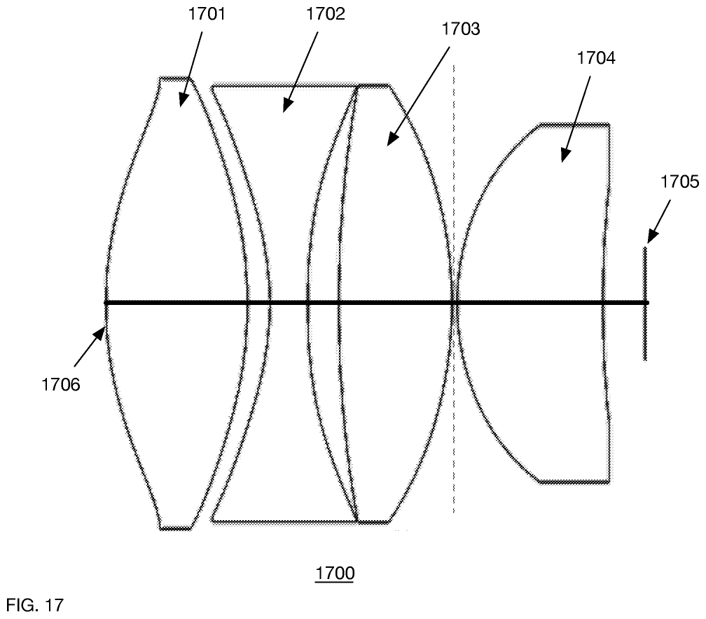

FIG. 17 shows the layout of Example 15, a four lens system 1700. This design has a horizontal field angle of +/−12° with a relative aperture (F/#) of F/0.6 and an effective focal length EFL of 30 mm with a 12.8 mm source Ah.

It comprises four lens elements. The first lens 1701 L1 from the left is a positive powered plastic element with optical property of a larger abbe number and therefore relatively lower color dispersion such as that of acrylic. There is an aperture stop on the object side 1706 of the first lens element 1701. The second lens 1702 L2 from the left is a negative powered plastic element with optical property of a lower abbe number and therefore relatively larger color dispersion such as that of polycarbonate. Lens elements L1, L2 and L3 1703 form group 1 (G1). The third 1703 and fourth 1704 elements L3 and L4 from the left are positive powered and made of optical glass with a larger abbe number and therefore relatively lower color dispersion. Element L4 forms group 2 (G2). Such choice of dispersion properties of elements facilitates the good color correction as required by automobile lighting lens application. The separation of the plastic elements L1 and L2 from the light source 1705 which generates heat and UV radiation by the more thermally stable glass elements L3 and L4 provides good protection for the plastic elements and good thermal stability for the lens assembly. The nearly balanced positive and negative powers of the L1 and L2 also ensure the focal length and optical performance stability over the wide operating temperature range as required by the automobile lighting lens application. The additional design degrees of freedom available from using aspheric profile for object/image surfaces of L1 and L2 can further improve the aberration correction of the system without incurring additional manufacturing cost due to the injection molding process used for the plastic element.

The image surface (RL) of the last element 1704 is concave facing the light source array 1705 and has a curvature radius divided by the total track length (TTL) satisfying above specified Equation (4) to improve light collection efficiency, to keep the lens barrel rear end diameter small, to improve optical performance uniformity over the projected field and to keep the stray light low.

The lens system is used to project an image or light pattern originating from an image or light pattern formed on the light source. A non-limiting example light source is an LED array having a horizontal size (Aₕ) 109 of 12.8 mm. Details of an example LED array light source are shown in FIG. 1. The physical length (TTL) of the example 1 lens system is 74 mm. However, dimensions of the lens system 1700 can be scaled to accommodate light sources having different dimensions.

Table 15 shows the optical prescription of Example 15.

TABLE 15

| | | Radius | Thickness | | | Clear | |
|---|---|---|---|---|---|---|---|
| Surface | Type | (mm) | (mm) | Nd | Vd | Diameter | lens |
| OBJ | SPHERICAL | Infinity | Infinity | | | | |
| STO | ASPHERICAL | 34.06 | 19.44 | 1.494 | 54.0 | 50.7 | L1 |
| 2 | ASPHERICAL | −38.09 | 3.05 | | | 50.6 | |
| 3 | ASPHERICAL | −28.61 | 5.20 | 1.585 | 29.9 | 47.9 | L2 |
| 4 | SPHERICAL | 64.20 | 4.25 | | | 49.0 | |
| 5 | SPHERICAL | 114.72 | 15.56 | 1.639 | 55.5 | 49.1 | L3 |
| 6 | SPHERICAL | −39.03 | 0.70 | | | 49.1 | |
| 7 | SPHERICAL | 23.38 | 20.00 | 1.639 | 55.5 | 40.2 | L4 |
| 8 | SPHERICAL | 107.33 | 5.86 | | | 27.6 | |
| IMA | SPHERICAL | Infinity | 0.00E+00 | | | 12.7 | |

L1 and L2 object and image surfaces are aspherical described by the following equation:

$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16} .$$

The parameters for this equation are as follows:

Object Surface of L1

| | |
|---|---|
| k | 0 |
| Coefficient on r\hat{ } 2 | 0.00E+00 |
| Coefficient on r\hat{ } 4 | −7.01E−07 |
| Coefficient on r\hat{ } 6 | −2.01E−08 |
| Coefficient on r\hat{ } 8 | 3.50E−11 |
| Coefficient on r\hat{ }10 | −3.84E−14 |
| Coefficient on r\hat{ }12 | 0.00E+00 |
| Coefficient on r\hat{ }14 | 0.00E+00 |
| Coefficient on r\hat{ }16 | 0.00E+00 |

Image Surface of L1

| | |
|---|---|
| k | 0 |
| Coefficient on r\hat{ } 2 | 0 |
| Coefficient on r\hat{ } 4 | −2.52E−06 |
| Coefficient on r\hat{ } 6 | 3.33E−08 |
| Coefficient on r\hat{ } 8 | −4.80E−11 |
| Coefficient on r\hat{ }10 | 1.98E−14 |
| Coefficient on r\hat{ }12 | 0 |
| Coefficient on r\hat{ }14 | 0 |
| Coefficient on r\hat{ }16 | 0 |

Object Surface of L2

| | |
|---|---|
| k | 0 |
| Coefficient on r\hat{ } 2 | 0 |
| Coefficient on r\hat{ } 4 | 8.28E−06 |
| Coefficient on r\hat{ } 6 | 3.97E−08 |
| Coefficient on r\hat{ } 8 | −8.33E−11 |
| Coefficient on r\hat{ }10 | 6.27E−14 |
| Coefficient on r\hat{ }12 | 0 |
| Coefficient on r\hat{ }14 | 0 |
| Coefficient on r\hat{ }16 | 0 |

Image Surface of L2

| | |
|---|---|
| k | 0 |
| Coefficient on r\hat{ } 2 | 0 |
| Coefficient on r\hat{ } 4 | 1.46E−05 |
| Coefficient on r\hat{ } 6 | −1.26E−08 |
| Coefficient on r\hat{ } 8 | −1.42E−11 |
| Coefficient on r\hat{ }10 | 1.60E−14 |
| Coefficient on r\hat{ }12 | 0 |
| Coefficient on r\hat{ }14 | 0 |
| Coefficient on r\hat{ }16 | 0 |

The parametric equations (1)-(14) are satisfied:

| EXAMPLE | EFL/Ah | TTL/Ah | Ri/TTL | F/# | EFL_G1/EFL | EFL_G2/EFL | RL/EFL |
|---|---|---|---|---|---|---|---|
| 15 | 2.34 | 5.79 | 0.32 | 0.6 | 1.88 | 1.41 | 3.58 |
| | | | | | EFL_L1/EFL 1.3 | EFL_L4/EFL 1.4 | |
| | | | | | EFL_L2/EFL −1.1 | | |
| | | | | | EFL_L3/EFL 1.6 | | |

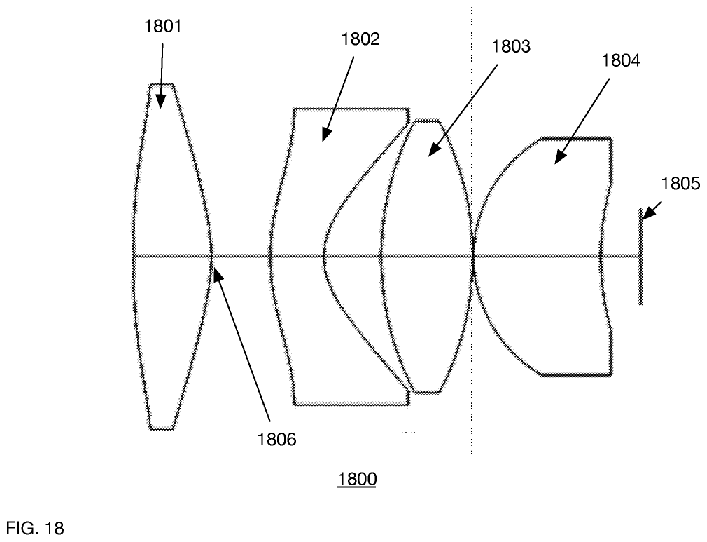

FIG. 18 shows the layout of Example 16, a four lens system 1800. This design has a horizontal field angle of +/−12° with a relative aperture (F/#) of F/0.64 and an effective focal length EFL of 30 mm with a 12.8 mm source Ah.

It comprises four lens elements. The first lens 1801 L1 from the left is a positive powered plastic element with optical property of a larger abbe number and therefore relatively lower color dispersion such as that of acrylic. There is an aperture stop on the image side 1806 of the first element 1801. The second lens 1802 L2 from the left is a negative powered plastic element with optical property of a lower abbe number and therefore relatively larger color dispersion such as that of polycarbonate. The third 1803 and fourth 1804 elements L3 and L4 from the left are positive powered and made of optical glass with a larger abbe number and therefore relatively lower color dispersion. Such choice of dispersion properties of elements facilitates the good color correction as required by automobile lighting lens application. The separation of the plastic elements L1 and L2 from the light source 1805 which generates heat and UV radiation by the more thermally stable glass elements L3 and L4 provides good protection for the plastic elements and good thermal stability for the lens assembly. The nearly balanced positive and negative powers of the L1 and L2 also ensure the focal length and optical performance stability over the wide operating temperature range as required by the automobile lighting lens application. The additional design degrees of freedom available from using aspheric profile for object/image surfaces of L1 and L2 can further improve the aberration correction of the system without incurring additional manufacturing cost due to the injection molding process used for the plastic element.

The image surface (RL) of the last element 1804 is concave facing the light source array 1805 and has a curvature radius divided by the total track length (TTL) satisfying above specified Equation (4) to improve light collection efficiency, to keep the lens barrel rear end diameter small, to improve optical performance uniformity over the projected field and to keep the stray light low.

The lens system is used to project an image or light pattern originating from an image or light pattern formed on the light source 1805. A non-limiting example light source is an LED array having a horizontal size (Aₕ) of 12.8 mm. Details of an example LED array light source are shown in FIG. 1. The physical length (TTL) of the example lens system is 72 mm. However, dimensions of the lens system 1800 can be scaled to accommodate light sources having different dimensions.

Table 16 shows the optical prescription of Example 16.

TABLE 16

| | | Radius | Thickness | | | Clear | |
|---|---|---|---|---|---|---|---|
| Surface | Type | (mm) | (mm) | Nd | Vd | Diameter | lens |
| OBJ | SPHERICAL | Infinity | Infinity | | | | |
| 1 | ASPHERICAL | 149.25 | 11.00 | 1.493 | 57.4 | 48.9 | L1 |
| STO | ASPHERICAL | −26.97 | 8.37 | | | 48.7 | |
| 3 | ASPHERICAL | 27.78 | 7.58 | 1.584 | 27.5 | 42.0 | L2 |
| 4 | ASPHERICAL | 9.16 | 8.14 | | | 37.7 | |
| 5 | SPHERICAL | 41.11 | 12.98 | 1.620 | 60.4 | 38.4 | L3 |
| 6 | SPHERICAL | −41.11 | 0.10 | | | 38.3 | |
| 7 | SPHERICAL | 19.26 | 18.03 | 1.639 | 55.5 | 33.4 | L4 |
| 8 | SPHERICAL | 38.96 | 5.64 | | | 21.2 | |
| 9 | SPHERICAL | Infinity | 0.00 | | | 13.6 | |

L1 and L2 object and image surfaces are aspherical described by the following equation:

$$z = \frac{{cr}^{2}}{1 + \sqrt{1 - ( 1 + k ) {c}^{2} {r}^{2}}} + {a}_{1} {r}^{2} + {a}_{2} {r}^{4} + {a}_{3} {r}^{6} + {a}_{4} {r}^{8} + {a}_{5} {r}^{10} + {a}_{6} {r}^{12} + {a}_{7} {r}^{14} + {a}_{8} {r}^{16} .$$

The parameters for this equation are as follows:

Object Surface of L1

| | |
|---|---|
| k | 0 |
| Coefficient on r\hat{ } 2 | 0 |
| Coefficient on r\hat{ } 4 | 1.99E−05 |
| Coefficient on r\hat{ } 6 | −1.17E−07 |
| Coefficient on r\hat{ } 8 | 3.84E−10 |
| Coefficient on r\hat{ }10 | −7.35E−13 |
| Coefficient on r\hat{ }12 | 7.44E−16 |
| Coefficient on r\hat{ }14 | −3.09E−19 |
| Coefficient on r\hat{ }16 | 0 |

Image Surface of L2

| | |
|---|---|
| k | −11.2 |
| Coefficient on r\hat{ } 2 | 0 |
| Coefficient on r\hat{ } 4 | 0 |
| Coefficient on r\hat{ } 6 | 0 |
| Coefficient on r\hat{ } 8 | 0 |
| Coefficient on r\hat{ }10 | 0 |
| Coefficient on r\hat{ }12 | 0 |
| Coefficient on r\hat{ }14 | 0 |
| Coefficient on r\hat{ }16 | 0 |

Object Surface of L2

| | |
|---|---|
| k | 0 |
| Coefficient on r\hat{ } 2 | 0 |
| Coefficient on r\hat{ } 4 | −3.56E−05 |
| Coefficient on r\hat{ } 6 | 1.30E−08 |
| Coefficient on r\hat{ } 8 | −8.84E−12 |
| Coefficient on r\hat{ }10 | 0 |
| Coefficient on r\hat{ }12 | 0 |
| Coefficient on r\hat{ }14 | 0 |
| Coefficient on r\hat{ }16 | 0 |

Image Surface of L2

| | |
|---|---|
| k | −1.6 |
| Coefficient on r\hat{ } 2 | 0 |
| Coefficient on r\hat{ } 4 | −2.18E−05 |
| Coefficient on r\hat{ } 6 | 2.32E−08 |
| Coefficient on r\hat{ } 8 | 0 |
| Coefficient on r\hat{ }10 | 0 |
| Coefficient on r\hat{ }12 | 0 |
| Coefficient on r\hat{ }14 | 0 |
| Coefficient on r\hat{ }16 | 0 |

| EXAMPLE | EFL/Ah | TTL/Ah | Ri/TTL | F/# | EFL_G1/EFL | EFL_G2/EFL | RL/EFL |
|---|---|---|---|---|---|---|---|
| 16 | 2.34 | 5.61 | 0.13 | 0.6 | 1.96 | 1.42 | 1.30 |
| | | | | | EFL_L1/EFL 1.5 | EFL_L4/EFL 1.4 | |
| | | | | | EFL_L2/EFL −0.9 | | |
| | | | | | EFL_L3/EFL 1.1 | | |

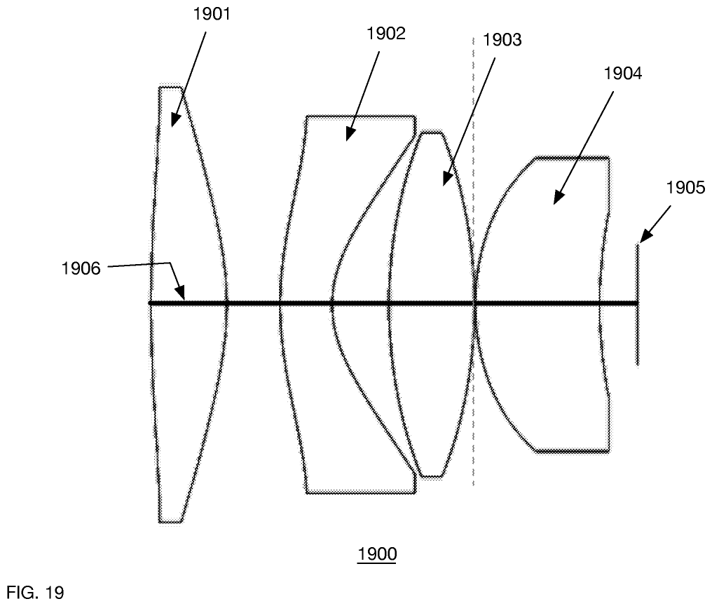

FIG. 19 shows the layout of Example 17, a four lens system 1900. This design has a field angle of +/−12° with a relative aperture (F/#) of F/0.64 and an effective focal length EFL of 30 mm with a 12.8 mm source.

It comprises four lens elements. The first lens 1901 L1 from the left is a positive powered plastic element with optical property of a larger abbe number and therefore relatively lower color dispersion such as that of acrylic. The second lens 1902 L2 from the left is a negative powered plastic element with optical property of a lower abbe number and therefore relatively larger color dispersion such as that of polycarbonate. The third 1903 and fourth 1904 elements L3 and L4 from the left are positive powered and made of optical glass with a larger abbe number and therefore relatively lower color dispersion. Such choice of dispersion properties of elements facilitates the good color correction as required by automobile lighting lens application. The separation of the plastic elements L1 and L2 from the light source which generates heat and UV radiation by the more thermally stable glass elements L3 and L4 provides good protection for the plastic elements and good thermal stability for the lens assembly. The nearly balanced positive and negative powers of the L1 and L2 also ensure the focal length and optical performance stability over the wide operating temperature range as required by the automobile lighting lens application. The additional design degrees of freedom available from using aspheric profile for object/image surfaces of L1 and L2 can further improve the aberration correction of the system without incurring additional manufacturing cost due to the injection molding process used for the plastic element

The image surface (RL) of the last element 1904 is concave facing the light source array and has a curvature radius divided by the total track length (TTL) satisfying above specific Equation (4) to improve light collection efficiency, to keep the lens barrel rear end diameter small, to improve optical performance uniformity over the projected field and to keep the stray light low.

The lens system 1900 is used to project an image or light pattern originating from an image or light pattern formed on the light source. A non-limiting example light source is an LED array having a horizontal size (Aₕ) 109 of 12.8 mm. Details of an example LED array light source are shown in FIG. 1. The physical length (TTL) of the example lens system is 71 mm. However, dimensions of the lens system 1900 can be scaled to accommodate light sources having different dimensions.

The optical prescription for example 17 is shown in Table 17.

TABLE 17

| | | | Thickness | | | Clear | |
|---|---|---|---|---|---|---|---|
| Surface | Type | Radius (mm) | (mm) | Nd | Vd | Diameter | lens |
| OBJ | SPHERICAL | Infinity | Infinity | | | | |
| 1 | ASPHERICAL | 132.29 | 11.00 | 1.493 | 57.4 | 48.9 | L1 |
| 2 | ASPHERICAL | −25.99 | 7.74 | | | 49.0 | |
| 3 | ASPHERICAL | 29.46 | 7.55 | 1.584 | 27.5 | 42.4 | L2 |
| 4 | ASPHERICAL | 9.38 | 8.26 | | | 38.0 | |
| 5 | SPHERICAL | 41.79 | 12.42 | 1.620 | 60.4 | 38.6 | L3 |
| 6 | SPHERICAL | −41.79 | 0.10 | | | 38.5 | |
| 7 | SPHERICAL | 19.80 | 18.11 | 1.639 | 55.5 | 33.1 | L4 |
| 8 | SPHERICAL | 42.66 | 5.47 | | | 20.8 | |
| 9 | SPHERICAL | Infinity | 0.00E+00 | | | 13.6 | |

L1 and L2 object and image surfaces are aspherical described by the following equation:

$$z = \frac{{cr}^{2}}{1 + \sqrt{1 - ( 1 + k ) {c}^{2} {r}^{2}}} + {a}_{1} {r}^{2} + {a}_{2} {r}^{4} + {a}_{3} {r}^{6} + {a}_{4} {r}^{8} + {a}_{5} {r}^{10} + {a}_{6} {r}^{12} + {a}_{7} {r}^{14} + {a}_{8} {r}^{16} .$$

The parameters for this equation are as follows:

Object Surface of L1

| | |
|---|---|
| k | 0 |
| Coefficient on r\hat{ } 2 | 0 |
| Coefficient on r\hat{ } 4 | −1.84E−06 |
| Coefficient on r\hat{ } 6 | −2.03E−09 |
| Coefficient on r\hat{ } 8 | 0 |
| Coefficient on r\hat{ }10 | 0 |
| Coefficient on r\hat{ }12 | 0 |
| Coefficient on r\hat{ }14 | 0 |
| Coefficient on r\hat{ }16 | 0 |

Image Surface of L1

| | |
|---|---|
| k | −6.7 |
| Coefficient on r\hat{ } 2 | 0 |
| Coefficient on r\hat{ } 4 | 0 |
| Coefficient on r\hat{ } 6 | 0 |
| Coefficient on r\hat{ } 8 | 0 |
| Coefficient on r\hat{ }10 | 0 |
| Coefficient on r\hat{ }12 | 0 |
| Coefficient on r\hat{ }14 | 0 |
| Coefficient on r\hat{ }16 | 0 |

Object Surface of L2

| | |
|---|---|
| k | 0 |
| Coefficient on r\hat{ } 2 | 0 |
| Coefficient on r\hat{ } 4 | −2.54E−05 |
| Coefficient on r\hat{ } 6 | 0 |
| Coefficient on r\hat{ } 8 | 0 |
| Coefficient on r\hat{ }10 | 0 |
| Coefficient on r\hat{ }12 | 0 |
| Coefficient on r\hat{ }14 | 0 |
| Coefficient on r\hat{ }16 | 0 |

Image Surface of L2

| | |
|---|---|
| k | −1.5 |
| Coefficient on r\hat{ } 2 | 0 |
| Coefficient on r\hat{ } 4 | −2.39E−05 |
| Coefficient on r\hat{ } 6 | 2.34E−08 |
| Coefficient on r\hat{ } 8 | 0 |
| Coefficient on r\hat{ }10 | 0 |
| Coefficient on r\hat{ }12 | 0 |
| Coefficient on r\hat{ }14 | 0 |
| Coefficient on r\hat{ }16 | 0 |

The parametric equations (1)-(14) are satisfied:

| EXAMPLE | EFL/Ah | TTL/Ah | Ri/TTL | F/# | EFL_G1/EFL | EFL_G2/EFL | RL/EFL |
|---|---|---|---|---|---|---|---|
| 17 | 2.34 | 5.52 | 0.13 | 0.6 | 1.91 | 1.43 | 1.42 |
| | | | | | EFL_L1/EFL 1.5 | EFL_L4/EFL 1.4 | |
| | | | | | EFL_L2/EFL −0.9 | | |
| | | | | | EFL_L3/EFL 1.2 | | |

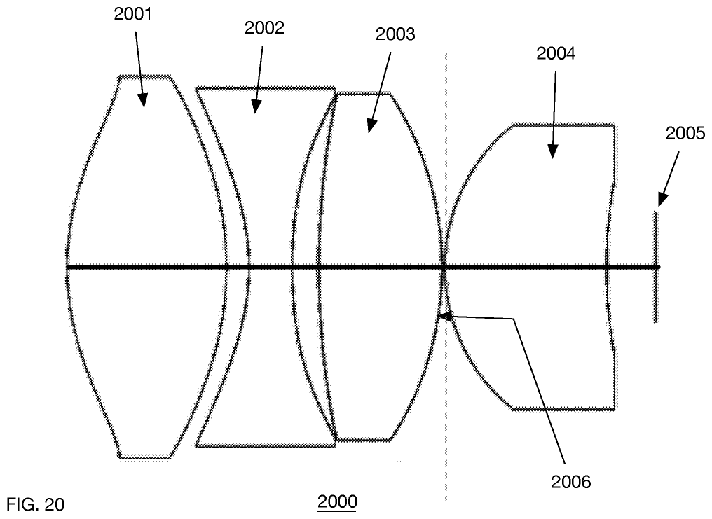

FIG. 20 shows the layout of Example 18, a four element lens system 2000. This design has a field angle of +/−12° with a relative aperture (F/#) of F/0.64 and an effective focal length EFL of 30 mm with a 12.8 mm source.

It comprises four lens elements. The first lens 2001 L1 from the left is a positive powered plastic element with optical property of a larger abbe number and therefore relatively lower color dispersion such as that of acrylic. The second lens 2002 L2 from the left is a negative powered plastic element with optical property of a lower abbe number and therefore relatively larger color dispersion such as that of polycarbonate. The third 2003 and fourth 2004 elements L3 and L4 from the left are positive powered and made of optical glass with a larger abbe number and therefore relatively lower color dispersion. Such choice of dispersion properties of elements facilitates the good color correction as required by automobile lighting lens application. The separation of the plastic elements L1 and L2 from the light source which generates heat and UV radiation by the more thermally stable glass elements L3 and L4 provides good protection for the plastic elements and good thermal stability for the lens assembly. There is an aperture stop 2006 on the image side of L3 2003. The nearly balanced positive and negative powers of the L1 and L2 also ensure the focal length and optical performance stability over the wide operating temperature range as required by the automobile lighting lens application. The additional design degrees of freedom available from using aspheric profile for object/image surfaces of L1 and L2 can further improve the aberration correction of the system without incurring additional manufacturing cost due to the injection molding process used for the plastic element.

The image surface (RL) of the last element 2004 is concave facing the light source array and has a curvature radius divided by the total track length (TTL) satisfying above specific Equation (4) to improve light collection efficiency, to keep the lens barrel rear end diameter small, to improve optical performance uniformity over the projected field and to keep the stray light low.

The lens system 2000 is used to project an image or light pattern originating from an image or light pattern formed on the light source 2005. A non-limiting example light source is an LED array having a horizontal size (Aₕ) 109 of 12.8 mm. Details of an example LED array light source are shown in FIG. 1. The physical length (TTL) of the lens system is 73 mm. However, dimensions of the lens system 2000 can be scaled to accommodate light sources having different dimensions.

Table 18 shows the optical prescription of Example 18.

TABLE 18

| Surface | Type | Radius (mm) | Thickness (mm) | Nd | Vd | Clear Diameter | lens |
|---|---|---|---|---|---|---|---|
| OBJ | SPHERICAL | Infinity | Infinity | | | | |
| 1 | EVENASPH | 33.22 | 19.73 | 1.494 | 54.0 | 47.3 | L1 |
| 2 | EVENASPH | −39.01 | 2.77 | | | 47.1 | gap 1 |
| 3 | EVENASPH | −28.60 | 5.34 | 1.585 | 29.9 | 44.4 | L2 |
| 4 | EVENASPH | 58.98 | 3.30 | | | 42.1 | gap 2 |
| 5 | STANDARD | 106.03 | 15.23 | 1.639 | 55.5 | 42.2 | L3 |
| STO | STANDARD | −39.04 | 0.32 | | | 42.8 | gap 3 |
| 7 | STANDARD | 22.49 | 20.00 | 1.639 | 55.5 | 35.1 | L4 |
| 8 | STANDARD | 58.83 | 6.04 | | | 21.9 | gap 4 |
| 9 | STANDARD | Infinity | 0.00E+00 | | | 13.8 | |

L1 and L2 object and image surfaces are aspherical described by the following equation:

$$z = \frac{{cr}^{2}}{1 + \sqrt{1 - ( 1 + k ) {c}^{2} {r}^{2}}} + {a}_{1} {r}^{2} + {a}_{2} {r}^{4} + {a}_{3} {r}^{6} + {a}_{4} {r}^{8} + {a}_{5} {r}^{10} + {a}_{6} {r}^{12} + {a}_{7} {r}^{14} + {a}_{8} {r}^{16} .$$

The parameters for this equation are as follows:

Object Surface of L1

| | |
|---|---|
| Coefficient on r\hat{ } 2 | 0 |
| Coefficient on r\hat{ } 4 | −1.84E−06 |
| Coefficient on r\hat{ } 6 | −2.02E−08 |
| Coefficient on r\hat{ } 8 | 3.34E−11 |
| Coefficient on r\hat{ }10 | −4.64E−14 |
| Coefficient on r\hat{ }12 | 0 |
| Coefficient on r\hat{ }14 | 0 |
| Coefficient on r\hat{ }16 | 0 |

Image Surface of L1

| | |
|---|---|
| k | |
| Coefficient on r\hat{ } 2 | 0 |
| Coefficient on r\hat{ } 4 | −3.32E−06 |
| Coefficient on r\hat{ } 6 | 3.18E−08 |
| Coefficient on r\hat{ } 8 | −4.95E−11 |
| Coefficient on r\hat{ }10 | 2.20E−14 |
| Coefficient on r\hat{ }12 | 0 |
| Coefficient on r\hat{ }14 | 0 |
| Coefficient on r\hat{ }16 | 0 |

Object Surface of L2

| | |
|---|---|
| k | |
| Coefficient on r\hat{ } 2 | 0 |
| Coefficient on r\hat{ } 4 | 8.62E−06 |
| Coefficient on r\hat{ } 6 | 3.98E−08 |
| Coefficient on r\hat{ } 8 | −8.30E−11 |
| Coefficient on r\hat{ }10 | 6.79E−14 |
| Coefficient on r\hat{ }12 | 0 |
| Coefficient on r\hat{ }14 | 0 |
| Coefficient on r\hat{ }16 | 0 |

Image Surface of L2

| | |
|---|---|
| k | |
| Coefficient on r\hat{ } 2 | 0 |
| Coefficient on r\hat{ } 4 | 1.42E−05 |
| Coefficient on r\hat{ } 6 | −1.34E−08 |
| Coefficient on r\hat{ } 8 | −1.54E−11 |
| Coefficient on r\hat{ }10 | 1.90E−14 |
| Coefficient on r\hat{ }12 | 0 |
| Coefficient on r\hat{ }14 | 0 |
| Coefficient on r\hat{ }16 | 0 |

The parametric equations (1)-(14) are satisfied:

| EXAMPLE | EFL/Ah | TTL/Ah | Ri/TTL | F/# | EFL_G1/EFL | EFL_G2/EFL | RL/EFL |
|---|---|---|---|---|---|---|---|
| 18 | 2.34 | 5.68 | 0.31 | 0.6 | 1.89 | 1.54 | 1.96 |
| | | | | | EFL_L1/EFL 1.3 | EFL_L4/EFL 1.6 | |
| | | | | | EFL_L2/EFL −1 | | |
| | | | | | EFL_L3/EFL 1.5 | | |

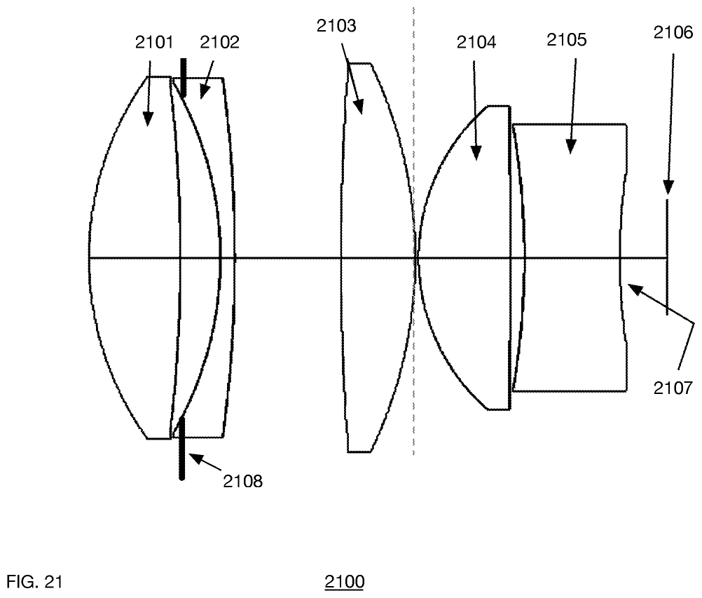

FIG. 21 shows the layout of Example 19, a five lens element embodiment lens system 2100. This design has a field angle of +/−12° with a relative aperture of F/0.75 and an effective focal length of 30 when used with a 12.8 mm (Ah) image source. This example 19th of present invention shows an imaging lighting lens of low F/# which has very good optical efficiency and is also high resolution.

It comprises two positive powered lens groups. Group 1 comprises L1 2101, L2 2102 and L3 2103 and has an effective focal length of EFL_G1. An aperture stop 2108 is located in group 1 at the object surface of L2. The optical powers of the lens elements in the first group are positive, negative, positive respectively. Group 2 in this example has positive power and comprises positive powered lens element L4 2104 and negative powered lens element L5 2105. Group 2 has an effective focal length of EFL_G2. The image surface 2107 of the last element nearest the light source 2106 has a radius of RL. All lens elements are made of glass material in order to achieve maximum thermal stability. All lens elements are spherical. The radius of curvature of individual lens shape is chosen to lower fabrication cost, stray light generation and aberration contribution. The absolute value of the radius of curvature of the lens surface |Rᵢ| with the smallest radius of curvature is |R7|. Table 19 shows the optical prescription of Example 19.

TABLE 19

| Surface | Type | Radius | Thickness | ND, ABBE NO. | Clear Diam | LENS |
|---|---|---|---|---|---|---|
| OBJ | SPHERICAL | Infinity | Infinity | | 0.00 | |
| 1 | SPHERICAL | 34.10 | 10.12 | 1.516, 64.212 | 40.00 | L1 |
| 2 | SPHERICAL | −164.94 | 4.44 | | 38.84 | |
| STO | SPHERICAL | −38.43 | 1.59 | 1.728, 28.310 | 38.43 | L2 |
| 4 | SPHERICAL | −146.39 | 11.76 | | 39.74 | |
| 5 | SPHERICAL | 278.39 | 8.21 | 1.729, 54.669 | 42.80 | L3 |
| 6 | SPHERICAL | −48.97 | 0.36 | | 42.94 | |
| 7 | SPHERICAL | 22.16 | 10.17 | 1.622, 56.726 | 33.52 | L4 |
| 8 | SPHERICAL | −1723.26 | 1.56 | | 30.56 | |
| 9 | SPHERICAL | −85.42 | 10.59 | 1.728, 28.31 | 29.44 | L5 |
| 10 | SPHERICAL | 67.23 | 5.18 | | 18.95 | |
| IMA | SPHERICAL | Infinity | | | 12.93 | |

The parametric equations (1)-(14) are satisfied:

| EXAMPLE | EFL/Ah | TTL/Ah | Ri/TTL | F/# | EFL_G1/EFL | EFL_G2/EFL | RL/EFL |
|---|---|---|---|---|---|---|---|
| 19 | 2.34 | 5.00 | 0.35 | 0.8 | 1.76 | 2.26 | 2.24 |
| | | | | | EFL_L1/EFL 1.85 | EFL_L4/EFL 1.169 | |
| | | | | | EFL_L2/EFL −2.4 | EFL_L5/EFL 1.66 | |
| | | | | | EFL_L3/EFL 1.92 | | |

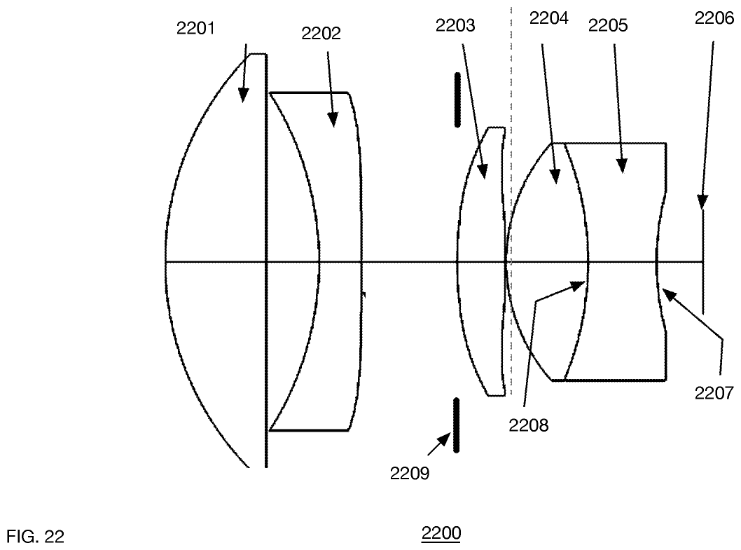

FIG. 22 shows the layout of Example 20, a five lens element embodiment of an imaging lens system 2200. This design has a field angle of +/−12° with a relative aperture of F/0.68 and an effective focal length of 30.0. This example of present invention shows an imaging lighting lens of a low F/# which has good optical efficiency and is high resolution.

It comprises two positive powered lens groups. Group 1 comprises L1 2201, L2 2202 and L3 2203 and has an effective focal length of EFL_G1. An aperture stop 2209 is located in group 1 at the object surface of L3. The optical powers of the lens elements in the first group are positive, negative, positive respectively. L2 and L3 have a considerable spacing between them to maximize the correction effect of these aspheric elements. Further the combined optical power of L2 and L3 is kept large to achieve maximum thermal stability. Group 2 in this example has positive power and comprises positive powered lens element L4 2204 and negative powered lens element L5 2205. L4 and L5 form a cemented or air gap doublet. The cemented surface 2208 in group 2 is helpful in the reduction of blue fringes. Group 2 has an effective focal length of EFL_G2. The image surface 2207 of the last element nearest the light source 2206 has a radius of RL. The radius of curvature of individual lens shape is chosen to lower fabrication cost, stray light generation and aberration contribution. The absolute value of the radius of curvature of the lens surface |Rᵢ| with the smallest radius of curvature is |R7|. Table 20 shows the optical prescription of Example 20.

| | | | | Glass | Clear | | |
|---|---|---|---|---|---|---|---|
| Surface | Type | Radius | Thickness | nd, abbe no. | Diam | Conic | LENS |
| OBJ | SPHERICAL | Infinity | 10000.00 | | 4272.40 | 0.00 | |
| 1 | SPHERICAL | 35.62 | 12.21 | 1.670, 47.197 | 50.00 | 0.00 | L1 901 |
| 2 | SPHERICAL | Infinity | 6.36 | | 50.00 | 0.00 | |
| 3 | SPHERICAL | −37.66 | 5.10 | 1.585, 29.909 | 40.65 | 0.00 | L2 902 |
| 4 | ASPHERICAL | −1106.00 | 11.60 | | 40.50 | 0.00 | |
| STO | ASPHERICAL | 52.97 | 5.80 | 1.491, 57.948 | 32.25 | 0.87 | L3 903 |
| 6 | ASPHERICAL | −72.95 | 0.10 | | 31.39 | 13.78 | |
| 7 | SPHERICAL | 21.48 | 9.89 | 1.772, 49.613 | 28.54 | 0.00 | L4 904 |
| 8 | SPHERICAL | −36.61 | 8.25 | 1.784, 25.71 | 28.54 | 0.00 | L5 905 |
| 9 | SPHERICAL | 31.73 | 5.65 | | 16.70 | 0.00 | |
| IMA | SPHERICAL | Infinity | | | 12.65 | 0.00 | |

### Table 20

The image surface of L2 and both the image and the object surfaces of L3 are aspherical with the following aspheric formula parameters for the equation:

$$z = \frac{{cr}^{2}}{1 + \sqrt{1 - ( 1 + k ) {c}^{2} {r}^{2}}} + {a}_{1} {r}^{2} + {a}_{2} {r}^{4} + {a}_{3} {r}^{6} + {a}_{4} {r}^{8} + {a}_{5} {r}^{10} + {a}_{6} {r}^{12} + {a}_{7} {r}^{14} + {a}_{8} {r}^{16} .$$

Image Surface of L2

| | |
|---|---|
| Coefficient on r² | 0 |
| Coefficient on r⁴ | 6.316e−07 |
| Coefficient on r⁶ | −3.021e−08 |
| Coefficient on r⁸ | 2.324e−11 |

Object Surface of L3

| | |
|---|---|
| Coefficient on r² | 0 |
| Coefficient on r⁴ | 1.761e−05 |
| Coefficient on r⁶ | 3.681e−08 |
| Coefficient on r⁸ | −1.553e−10 |

Image Surface of L3:

| | |
|---|---|
| Coefficient on r² | 0 |
| Coefficient on r⁴ | 3.400e−05 |

The parametric equations (1)-(14) are satisfied:

| EXAMPLE | EFL/Ah | TTL/Ah | Ri/TTL | F/# | EFL_G1/EFL | EFL_G2/EFL | RL/EFL |
|---|---|---|---|---|---|---|---|
| 19 | 2.34 | 5.08 | 0.33 | 0.7 | 1.916 | 1.67 | 1.06 |
| | | | | | EFL_L1/EFL 1.77 | EFL_L4/EFL 0.934 | |
| | | | | | EFL_L2/EFL −2.21 | EFL_L5/EFL −1.317 | |
| | | | | | EFL_L3/EFL 2.11 | | |

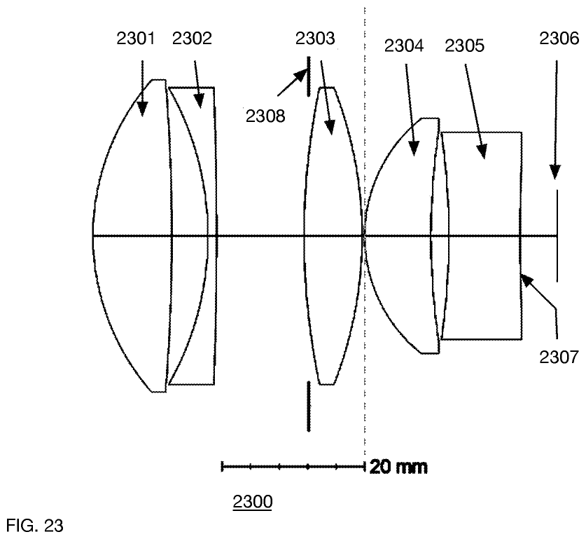

FIG. 23 shows the layout of Example 21 2300. This design has a field angle of +/−12° with a relative aperture of F/0.69 and an effective focal length of 30.0. The example of present invention shows an imaging lighting lens of low F/# which has very good optical efficiency and is high resolution.

It comprises two positive powered lens groups. Group 1 comprises L1 2301, L2 2302 and L3 2303 and has an effective focal length of EFL_G1. In preferred embodiment, the EFL_G1 should be equal or greater than 2 times the EFL of the whole lens in order to achieve maximum thermal stability. An aperture stop 2308 is located in group 1 at the object surface of L3. The stop location is closer to the light source to help with field aberration correction. The optical powers of the lens elements in the first group are positive, negative, positive respectively. Group 2 has positive power and comprises positive powered lens element L4 2304 and negative powered lens element L5 2305. Group 2 has an effective focal length of EFL_G2. The image surface 2307 of the last element nearest the light source 2306 has a radius of RL. All lens elements are spherical and all lens elements are made of glass material in order to achieve maximum thermal stability. The radius of curvature of individual lens shape is chosen to lower fabrication cost, stray light generation and aberration contribution. The absolute value of the radius of curvature of the lens surface |Rᵢ| with the smallest radius of curvature is |R7|. Table 21 shows the optical prescription of Example 21.

TABLE 21

| Surface | Type | Radius | Thickness | ND, ABBE NO. | Clear Diam | LENS |
|---|---|---|---|---|---|---|
| OBJ | SPHERICAL | Infinity | 10000.00 | | | |
| 1 | SPHERICAL | 33.00 | 11.04 | 1.516, 64.212 | 43.62 | L1 |
| 2 | SPHERICAL | −262.21 | 5.04 | | 42.01 | |
| 3 | SPHERICAL | −41.87 | 1.20 | 1.728, 28.310 | 41.55 | L2 |
| 4 | SPHERICAL | −544.85 | 12.25 | | 41.48 | |
| STO | SPHERICAL | 99.64 | 8.12 | 1.729, 54.669 | 41.50 | L3 |
| 6 | SPHERICAL | −56.59 | 0.37 | | 41.45 | |
| 7 | SPHERICAL | 20.98 | 9.30 | 1.622, 56.726 | 32.85 | L4 |
| 8 | SPHERICAL | 103.73 | 2.48 | | 29.76 | |
| 9 | SPHERICAL | −100.85 | 9.97 | 1.728, 28.310 | 28.90 | L5 |
| 10 | SPHERICAL | 218.32 | 5.23 | | 20.17 | |
| IMA | SPHERICAL | Infinity | | | 12.94 | |

| | | | | | | | |
|---|---|---|---|---|---|---|---|
| EXAMPLE | EFL/Ah | TTL/Ah | Ri/TTL | F/# | EFL_G1/EFL | EFL_G2/EFL | RL/EFL |
| 21 | 2.34 | 5.08 | 0.32 | 0.7 | 1.76 | 1.96 | 7.28 |
| | | | | | EFL_L1/EFL 1.91 | EFL_L4/EFL 1.345 | |
| | | | | | EFL_L2/EFL −2.06 | EFL_L5/EFL −3.093 | |
| | | | | | EFL_L3/EFL 1.68 | | |

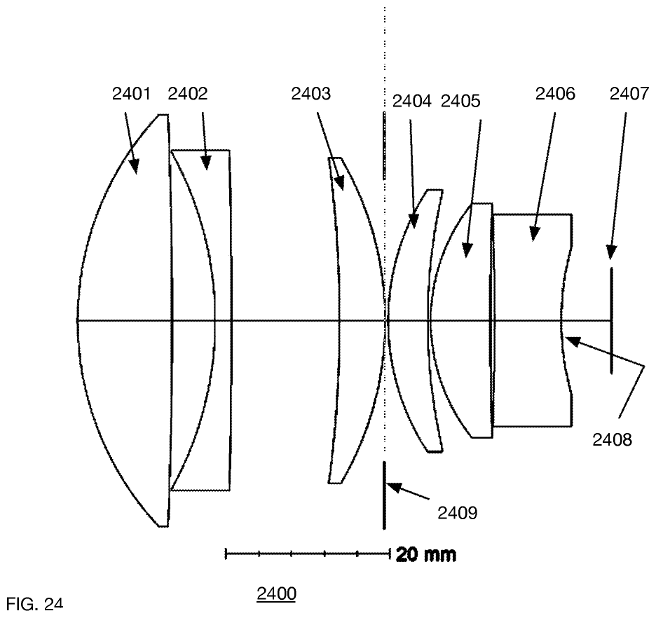

FIG. 24 shows the embodiment of Example 22, an imaging projection lens system 2400, that has three lens elements in Group 2 or six lens elements total. This design has a field angle of +/−12° with a relative aperture of F/0.70 and an effective focal length of 30.0. The example of present invention shows an imaging lighting lens of a low F/# which has good optical efficiency and is high resolution.

It comprises two positive powered lens groups. Group 1 comprises L1 2401, L2 2402 and L3 2403 and has an effective focal length of EFL_G1. In preferred embodiment, the EFL_G1 should be equal or greater than 2 times the EFL of the whole lens in order to achieve maximum thermal stability. An aperture stop 2409 is located in group 1 at the image surface of L3. The stop location is closer to the light source to help with field aberration correction. The optical powers of the lens elements in the first group are positive, negative, positive respectively. Group 2 has positive power and comprises positive powered lens element L4 2404, positive powered lens element L5 2405 and negative powered lens element L6 2406. L5 and L6 function together as an air spaced doublet. Group 2 has an effective focal length of EFL_G2. The image surface 2408 of the last element nearest the light source 2407 has a radius of RL. All lens elements are spherical and all lens elements are made of glass material in order to achieve maximum thermal stability. The radius of curvature of individual lens shape is chosen to lower fabrication cost, stray light generation and aberration contribution. The absolute value of the radius of curvature of the lens surface |Rᵢ| with the smallest radius of curvature is |R9|. Table 22 shows the optical prescription of Example 22.

TABLE 22

| Surface | Type | Radius | Thickness | ND, ABBE NO. | Clear Diam | LENS |
|---|---|---|---|---|---|---|
| OBJ | SPHERICAL | Infinity | 10000.00 | | | |
| 1 | SPHERICAL | 36.51 | 11.50 | 1.658, 50.866 | 50.00 | L1 |
| 2 | SPHERICAL | −650.40 | 5.25 | | 50.00 | |
| 3 | SPHERICAL | −41.99 | 2.00 | 1.728, 28.310 | 41.19 | L2 |
| 4 | SPHERICAL | −780.20 | 13.10 | | 40.25 | |
| 5 | SPHERICAL | −145.30 | 5.55 | 1.620, 60.373 | 39.40 | L3 |
| 6 | SPHERICAL | −38.69 | 0.37 | | 39.51 | |
| STO | SPHERICAL | 28.77 | 4.80 | 1.620, 60.373 | 31.88 | L4 |
| 8 | SPHERICAL | 68.45 | 0.37 | | 30.85 | |
| 9 | SPHERICAL | 22.56 | 7.25 | 1.620, 60.373 | 28.44 | L5 |
| 10 | SPHERICAL | 367.70 | 0.51 | | 26.01 | |
| 11 | SPHERICAL | −447.70 | 8.13 | 1.728, 28.310 | 25.83 | L6 |
| 12 | SPHERICAL | 32.39 | 6.11 | | 17.77 | |
| IMA | SPHERICAL | Infinity | | | 12.90 | |

The parametric equations (1)-(14) are satisfied:

| | | | | | | | |
|---|---|---|---|---|---|---|---|
| EXAMPLE | EFL/Ah | TTL/Ah | Ri/TTL | F/# | EFL_G1/EFL | EFL_G2/EFL | RL/EFL |
| 22 | 2.34 | 5.07 | 0.35 | 0.7 | 2.36 | 1.42 | 1.08 |
| | | | | | EFL_L1/EFL 1.75 | EFL_L4/EFL 2.54 | |
| | | | | | EFL_L2/EFL −2.02 | EFL_L5/EFL 1.28 | |
| | | | | | EFL_L3/EFL 2.77 | EFL_L6/EFL −1.36 | |

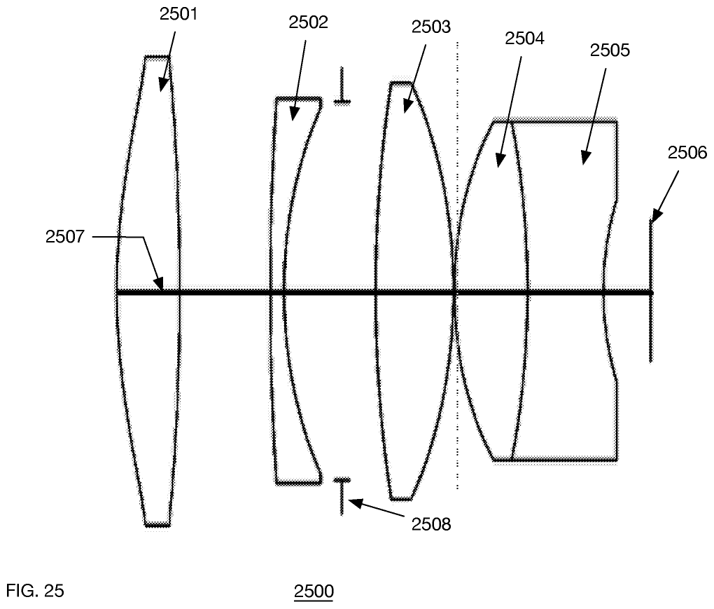

FIG. 25 shows the layout of Example 23, a five element lens system 2500. This design has a horizontal field angle of +/−12° with a relative aperture (F/#) of F/0.75 and an effective focal length EFL of 33 mm with a 14 mm source Ah. It comprises five lens elements. The first lens L1 2501 from the left is a positive powered glass element with optical property of a higher abbe number and therefore relatively small color dispersion. The second lens L2 2502 from the left is a negative powered glass element with optical property of a lower abbe number and therefore relatively higher color dispersion. There is an aperture stop 2508 on the image side of this element 2502. The third lens L3 2503 from the left is a positive powered glass element with a higher Abbe number and therefore relatively lower color dispersion. The fourth elements 2504 L4 from left is positively powered glass element with a high Abbe number and therefore relatively lower color dispersion. The fifth element 2505 L5 from left is negatively powered glass element with a low Abbe number and therefore relatively high color dispersion. Such choice of dispersion properties of elements facilitates the good color correction as required by automobile lighting lens application. All elements are made of glass material. This arrangement provides good protection from heat and UV radiation generated by light source 2506 even with the close proximity of lens elements to the light source. The all glass design also is helpful to the thermal performance stability of the lens assembly. The material of L1 2501 can be molded and thus bring additional degree of freedom of aberration correction by using aspheric terms without increasing cost.

The image surface (RL) of the last element is concave facing the light source array 2506 and has a curvature radius divided by the total track length (TTL) satisfying above specified Equation (4) to improve light collection efficiency, to keep the lens barrel rear end diameter small, to improve optical performance uniformity over the projected field and to keep the stray light low.

The lens system is used to project an image or light pattern originating from an image or light pattern formed on the light source 2506. A non-limiting example light source is an LED array having a horizontal size (Aₕ) 109 of 14 mm. Details of an example LED array light source are shown in FIG. 1. The physical length (TTL) of the example lens system 2500 is 78 mm. However, dimensions of the lens system 2500 can be scaled to accommodate light sources having different dimensions.

Table 23 shows the optical prescription of Added Example 23.

TABLE 23

| | | Radius | Thickness | | | Clear | |
|---|---|---|---|---|---|---|---|
| Surface | Type | (mm) | (mm) | Nd | Vd | Diameter | lens |
| OBJ | SPHERICAL | Infinity | Infinity | | | 0 | |
| 1 | ASPHERICAL | 48.3291 | 9.2092 | 1.5231 | 58.64 | 45.96 | L1 |
| 2 | ASPHERICAL | −155.846 | 13.2781 | | | 44.89 | |
| 3 | SPHERICAL | 197.1382 | 2 | 1.6727 | 32.17 | 37.78 | L2 |
| 4 | SPHERICAL | 32.5909 | 8.5065 | | | 35.88 | |
| STO | SPHERICAL | Infinity | 4.8883 | | | 37.16 | |
| 6 | SPHERICAL | 90.5707 | 11.4327 | 1.6204 | 60.34 | 40.3 | L3 |
| 7 | SPHERICAL | −36.6475 | 0.1 | | | 40.76 | |
| 8 | SPHERICAL | 26.674 | 10.7414 | 1.804 | 46.57 | 33.21 | L4 |
| 9 | SPHERICAL | −59.9872 | 11.1489 | 1.8052 | 25.46 | 33.21 | L5 |
| 10 | SPHERICAL | 21.7784 | 6.8951 | | | 17.8 | |
| IMA | SPHERICAL | Infinity | | | | 13.85 | |

L1 Object/Image surface are aspherical described by the following equation:

$$z = \frac{{cr}^{2}}{1 + \sqrt{1 - ( 1 + k ) {c}^{2} {r}^{2}}} + {a}_{1} {r}^{2} + {a}_{2} {r}^{4} + {a}_{3} {r}^{6} + {a}_{4} {r}^{8} + {a}_{5} {r}^{10} + {a}_{6} {r}^{12} + {a}_{7} {r}^{14} + {a}_{8} {r}^{16} .$$

The parameters for this equation are as follows:

Object Surface of L1

| | |
|---|---|
| k | −2.26653 |
| Coefficient on r\hat{ } 2 | 0.00E+00 |
| Coefficient on r\hat{ } 4 | 0 |
| Coefficient on r\hat{ } 6 | −7.4139291e−09 |
| Coefficient on r\hat{ } 8 | 2.0636919e−12 |
| Coefficient on r\hat{ }10 | 0 |
| Coefficient on r\hat{ }12 | 0.00E+00 |
| Coefficient on r\hat{ }14 | 0.00E+00 |
| Coefficient on r\hat{ }16 | 0.00E+00 |

Image Surface of L1

| | |
|---|---|
| k | 0 |
| Coefficient on r\hat{ } 2 | 0.00E+00 |
| Coefficient on r\hat{ } 4 | 2.1687697e−06 |
| Coefficient on r\hat{ } 6 | −7.4899309e−09 |
| Coefficient on r\hat{ } 8 | 8.0994019e−12 |
| Coefficient on r\hat{ }10 | 0 |
| Coefficient on r\hat{ }12 | 0.00E+00 |
| Coefficient on r\hat{ }14 | 0.00E+00 |
| Coefficient on r\hat{ }16 | 0.00E+00 |

The parametric equations (1)-(14) are satisfied:

| | | | | | | | |
|---|---|---|---|---|---|---|---|
| EXAMPLE | EFL/Ah | TTL/Ah | Ri/TTL | F/# | EFL_G1/EFL | EFL_G2/EFL | RL/EFL |
| 23 | 2.36 | 5.59 | 0.28 | 0.8 | 1.70 | 4.54 | 0.66 |
| | | | | | EFL_L1/EFL 2.1 | EFL_L4/EFL 1.0 | |
| | | | | | EFL_L2/EFL. −1.7 | EFL_L5/EFL −0.8 | |
| | | | | | EFL_L3/EFL 1.3 | | |

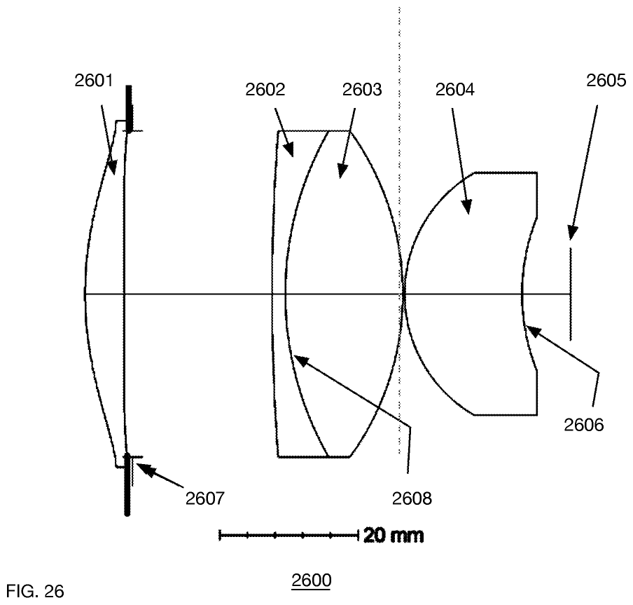

FIG. 26 shows the layout of Example 24, an embodiment of a high resolution, four lens, imaging projection lens system 2600. This design has a field angle of +/−12° with a relative aperture of F/0.64 and an effective focal length of 30.2 mm. This example of the present invention shows an imaging lighting lens of a low F/# which has good optical efficiency and is high resolution.

It comprises two positive powered lens groups. Group 1 comprises L1 2601, L2 2602 and L3 2603 and has an effective focal length of EFL_G1. An aperture stop 2607 is located in group 1 at the image surface of L1. The optical powers of the lens elements in the first group are positive, negative, positive respectively. L1 is aspheric, where at least one of the two surfaces is aspheric. The power of aspheric element in group 1 is kept weak to ensure the stability of performance within working temperature range. L2 and L3 in Group 1 form a cemented or air gap doublet. The cemented surface 2608 is helpful in the reduction of blue fringes. Group 2 comprises one positive powered lens element L4 2604 and has an effective focal length of EFL_G2. The image surface 2606 of the last element nearest the light source 2605 has a radius of RL. The radius of curvature of individual lens shape is chosen to lower fabrication cost, stray light generation and aberration contribution. The absolute value of the radius of curvature of the lens surface |Rᵢ| with the smallest radius of curvature is |R7|. Table 24 shows the optical prescription of Example 24.

TABLE 24

| Surface | Type | Radius | Thickness | ND, ABBE NO. | Clear Diam | Conic | LENS |
|---|---|---|---|---|---|---|---|
| OBJ | SPHERICAL | Infinity | 10000.00 | | | 0.00 | |
| 1 | ASPHERICAL | 47.91 | 5.68 | 1.491, 57.440 | 50.00 | 0.00 | L1 |
| 21 | ASPHERICAL | 1622.92 | 1.23 | | 50.00 | 0.00 | |
| STO | SPHERICAL | Infinity | 20.18 | | 47.00 | 0.00 | |
| 4 | SPHERICAL | 319.11 | 1.91 | 1.846, 23.787 | 47.00 | 0.00 | L2 |
| 5 | SPHERICAL | 47.32 | 17.01 | 1.620, 60.373 | 47.00 | 0.00 | L3 |
| 6 | SPHERICAL | −40.02 | 0.26 | | 47.00 | 0.00 | |
| 7 | SPHERICAL | 20.23 | 17.00 | 1.620, 60.373 | 35.08 | 0.00 | L4 |
| 8 | SPHERICAL | 29.83 | 6.99 | | 22.37 | 0.00 | |
| IMA | SPHERICAL | Infinity | | | 13.31 | 0.00 | |

Both surfaces of L1 are aspheric. The parameters for the equation:

$$z = \frac{{cr}^{2}}{1 + \sqrt{1 - ( 1 + k ) {c}^{2} {r}^{2}}} + {a}_{1} {r}^{2} + {a}_{2} {r}^{4} + {a}_{3} {r}^{6} + {a}_{4} {r}^{8} + {a}_{5} {r}^{10} + {a}_{6} {r}^{12} + {a}_{7} {r}^{14} + {a}_{8} {r}^{16} .$$

are:

Object Surface of L1:

| | |
|---|---|
| Coefficient on r² | 0 |
| Coefficient on r⁴ | −6.068e−06 |
| Coefficient on r⁶ | 5.829e−09 |
| Coefficient on r⁸ | −9.446e−12 |
| Coefficient on r¹⁰ | −1.2591e−15 |

Image Surface of L1:

| | |
|---|---|
| Coefficient on r² | 0 |
| Coefficient on r⁴ | −2.27932e−06 |
| Coefficient on r⁶ | 5.8876e−09 |
| Coefficient on r⁸ | 1.6671e−14 |

The parametric equations (1)-(14) are satisfied:

| | | | | | | | |
|---|---|---|---|---|---|---|---|
| EXAMPLE | EFL/Ah | TTL/Ah | Ri/TTL | F/# | EFL_G1/EFL | EFL_G2/EFL | RL/EFL |
| 24 | 2.36 | 5.49 | 0.29 | 0.6 | 1.796 | 2 | 0.99 |
| | | | | | EFL_L1/EFL 3.30 | EFL_L4/EFL 2.00 | |
| | | | | | EFL_L2/EFL −2.20 | | |
| | | | | | EFL_L3/EFL 1.20 | | |

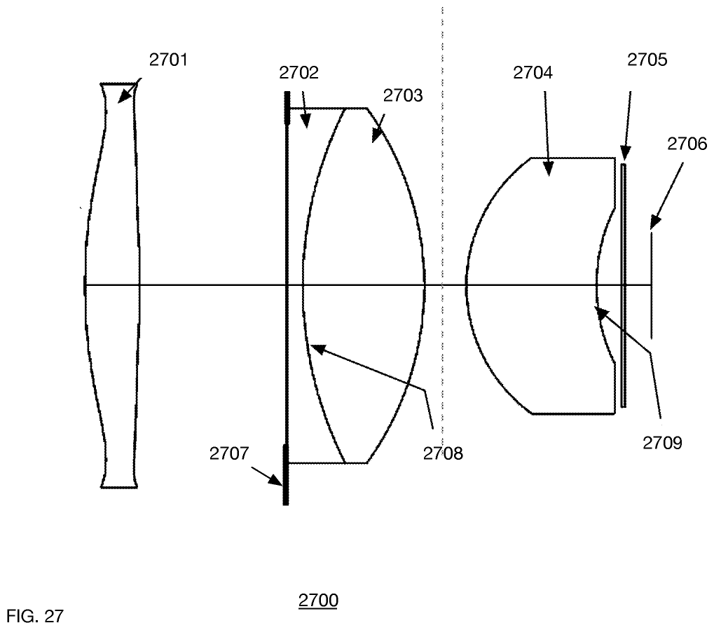

FIG. 27 shows the layout of Example 25. This design 2700 has a field angle of +/−12° with a relative aperture of F/0.70 and an effective focal length of 30.5. This example of the present invention shows an imaging lighting lens of a low F/# which has good optical efficiency and is high resolution.

It comprises two positive powered lens groups. Group 1 comprises L1 2701, L2 2702 and L3 2703 and has an effective focal length of EFL_G1. An aperture stop 2707 is located in group 1 at the object surface of L2. The optical powers of the lens elements in the first group are positive, negative, positive respectively. L1 is aspheric, where at least one of the two surfaces is aspheric.

The power of aspheric element in group 1 is kept weak to ensure the stability of performance within working temperature range. L2 and L3 in Group 1 form a cemented or air gap doublet. The cemented surface 2708 is helpful in the reduction of blue fringes. Group 2 comprises one positive powered lens element L4 2704 and has an effective focal length of EFL_G2. The image surface 2709 of the last element nearest the light source 2706 has a radius of RL. A cover plate 2705 is included. The prescription values for R8 and R9 refer to this cover plate. The radius of curvature of individual lens shape is chosen to lower fabrication cost, stray light generation and aberration contribution. The absolute value of the radius of curvature of the lens surface |Rᵢ| with the smallest radius of curvature is |R6|. Table 25 shows the optical prescription of Example 25.

TABLE 25

| Surface | Type | Radius | Thickness | ND, ABBE NO. | Clear Diam | Conic | LENS |
|---|---|---|---|---|---|---|---|
| OBJ | SPHERICAL | Infinity | 10000.00 | | | 0.00 | |
| 1 | ASPHERICAL | 72.45 | 6.75 | 1.493, 53.961 | 50.00 | 0.00 | L1 |
| 2 | ASPHERICAL | −113.20 | 18.26 | | 50.00 | 0.00 | |
| STO | SPHERICAL | Infinity | 1.98 | 1.784, 25.719 | 43.70 | 0.00 | L2 |
| 4 | SPHERICAL | 48.55 | 15.05 | 1.622, 58.154 | 43.67 | 0.00 | L3 |
| 5 | SPHERICAL | −37.42 | 5.22 | | 43.97 | 0.00 | |
| 6 | SPHERICAL | 19.55 | 16.10 | 1.638, 55.471 | 31.73 | 0.00 | L4 |
| 7 | SPHERICAL | 21.59 | 3.08 | | 19.08 | 0.00 | |
| 8 | SPHERICAL | Infinity | 0.50 | 1.516, 64.212 | 30.00 | 0.00 | COVER |
| 9 | SPHERICAL | Infinity | 3.18 | | 30.00 | 0.00 | |
| IMA | SPHERICAL | Infinity | | | 13.08 | 0.00 | |

Both the object and image surfaces of L1 1201 are aspheric. The parameters for the aspheric equation,

$$z = \frac{{cr}^{2}}{1 + \sqrt{1 - ( 1 + k ) {c}^{2} {r}^{2}}} + {a}_{1} {r}^{2} + {a}_{2} {r}^{4} + {a}_{3} {r}^{6} + {a}_{4} {r}^{8} + {a}_{5} {r}^{10} + {a}_{6} {r}^{12} + {a}_{7} {r}^{14} + {a}_{8} {r}^{16} .$$

are:

Object Surface of L1:

| | |
|---|---|
| Coefficient on r² | 0 |
| Coefficient on r⁴ | 6.182e−06 |
| Coefficient on r⁶ | −2.009e−08 |
| Coefficient on r⁸ | 1.511e−14 |

Image Surface of L1:

| | |
|---|---|
| Coefficient on r² | 0 |
| Coefficient on r⁴ | 3.1069e−05 |
| Coefficient on r⁶ | −1.6534e−07 |
| Coefficient on r⁸ | 5.061e−10 |
| Coefficient on r¹⁰ | −8.055e−13 |
| Coefficient on r¹² | 5.099e−16 |

The parametric equations (1)-(14) are satisfied:

| | | | | | | | |
|---|---|---|---|---|---|---|---|
| EXAMPLE | EFL/Ah | TTL/Ah | Ri/TTL | F/# | EFL_G1/EFL | EFL_G2/EFL | RL/EFL |
| 25 | 2.38 | 5.48 | 0.28 | 0.7 | 1.659 | 2.6 | 0.71 |
| | | | | | EFL_L1/EFL 3.00 | EFL_L4/EFL 2.60 | |
| | | | | | EFL_L2/EFL −2.00 | | |
| | | | | | EFL_L3/EFL 1.20 | | |

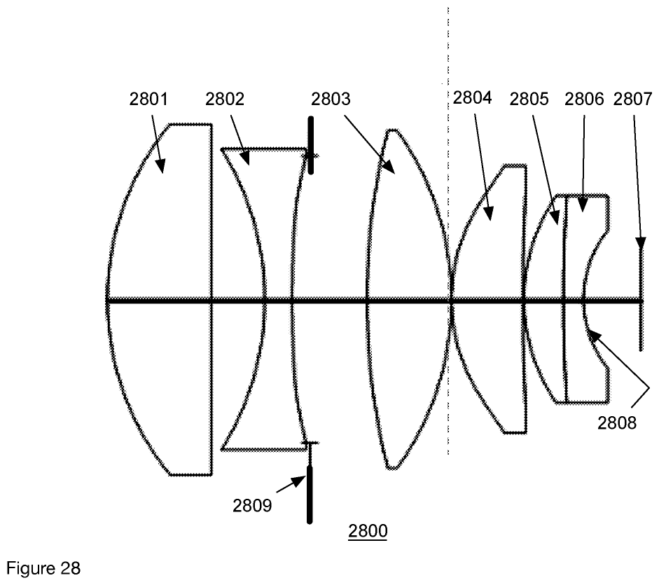

FIG. 28 shows the layout of Example 26, another embodiment 2800 with three lens elements in group 2. This design has a field angle of +/−12° with a relative aperture of F/0.73 and an effective focal length EFL of 30.5 when used with a 12.8 mm (Ah) image source. The embodiment of an imaging projection lens system shows an imaging lighting lens of a low F/# which has good optical efficiency and is high resolution. It comprises two positive powered lens groups. Group 1 comprises L1 2801, L2 2802 and L3 2803 and has an effective focal length of EFL_G1. In preferred embodiment, the EFL_G1 should be equal or greater than 2 times the EFL of the whole lens in order to achieve maximum thermal stability. An aperture stop 2809 is located in group 1 at the image surface of L2. The optical powers of the lens elements in the first group are positive, negative, positive respectively. Group 2 has positive power and comprises positive powered lens element L4 2804, positive powered lens element L5 2805 and negative powered lens element L6 2806. L5 and L6 function together as an air spaced doublet. Group 2 has an effective focal length of EFL_G2. The image surface 2808 of the last element nearest the light source 2807 has a radius of RL. All lens elements are spherical except for L2 and L4. The radius of curvature of individual lens shape is chosen to lower fabrication cost, stray light generation and aberration contribution. The absolute value of the radius of curvature of the lens surface |Rᵢ| with the smallest radius of curvature is |R12|. Table 26 shows the optical prescription of Example 26.

TABLE 26

| Surface | | | | | Material | Clear | |
|---|---|---|---|---|---|---|---|
| ID | Surface Type | Lens | Radius | Thickness | Nd/Abbe | Semi | Conic |
| 0 | STANDARD | | Infinity | 1.00E+04 | | 2.13E+03 | 0.00E+00 |
| 1 | STANDARD | L1 | 35.3 | 1.32E+01 | 1.620, 60.374 | 2.24E+01 | 0.00E+00 |
| 2 | STANDARD | | Infinity | 6.78E+00 | | 2.02E+01 | 0.00E+00 |
| 3 | STANDARD | L2 | −36.0 | 3.48E+00 | 1.585, 29.909 | 1.91E+01 | 0.00E+00 |
| 4 | EVENASPH | | 171 | 2.26E+00 | | 1.82E+01 | 0.00E+00 |
| 5 | STANDARD | stop | Infinity | 7.21E+00 | | 1.83E+01 | 0.00E+00 |
| 6 | STANDARD | L3 | 88.3 | 1.08E+01 | 1.620, 60.374 | 2.13E+01 | 0.00E+00 |
| 7 | STANDARD | | −36.8 | 0.00E+00 | | 2.15E+01 | 0.00E+00 |
| 8 | EVENASPH | L4 | 22.5 | 9.12E+00 | 1.492, 57.949 | 1.70E+01 | −1.37E+00 |
| 9 | EVENASPH | | 811 | 1.01E−01 | | 1.59E+01 | 0.00E+00 |
| 10 | STANDARD | L5 | 23.2 | 5.02E+00 | 1.773, 49.613 | 1.32E+01 | 0.00E+00 |
| 11 | STANDARD | L6 | 21.8 | 2.54E+00 | 1.847, 23.787 | 1.32E+01 | 0.00E+00 |
| 12 | STANDARD | | 14.0 | 7.31E+00 | | 8.78E+00 | 0.00E+00 |
| 13 | STANDARD | | Infinity | 0.00E+00 | | 6.55E+00 | 0.00E+00 |

| | EVENASPH for | EVENASPH for | EVENASPH for |
|---|---|---|---|
| | Image Surface | Object Surface | Image Surface |
| Coefficients | of L2 | of L4 | of L4 |
| r\hat{ }4 | 8.58E−06 | 1.44E−05 | 1.62E−05 |
| r\hat{ }6 | −1.09E−08 | 3.26E−08 | 1.62E−05 |
| r\hat{ }8 | 2.68E−11 | −2.00E−10 | 2.96E−11 |

The parametric equations (1)-(14) are satisfied:

| | | | | | | | |
|---|---|---|---|---|---|---|---|
| EXAMPLE | EFL/Ah | TTL/Ah | Ri/TTL | F/# | EFL_G1/EFL | EFL_G2/EFL | RL/EFL |
| 26 | 2.38 | 5.30 | 0.21 | 0.7 | 1.742 | 3.05 | 0.46 |
| | | | | | EFL_L1/EFL 1.86 | EFL_L4/EFL 1.54 | |
| | | | | | EFL_L2/EFL −1.65 | EFL_L5/EFL 0.97 | |
| | | | | | EFL_L3/EFL 1.42 | EFL_L6/EFL −0.54 | |

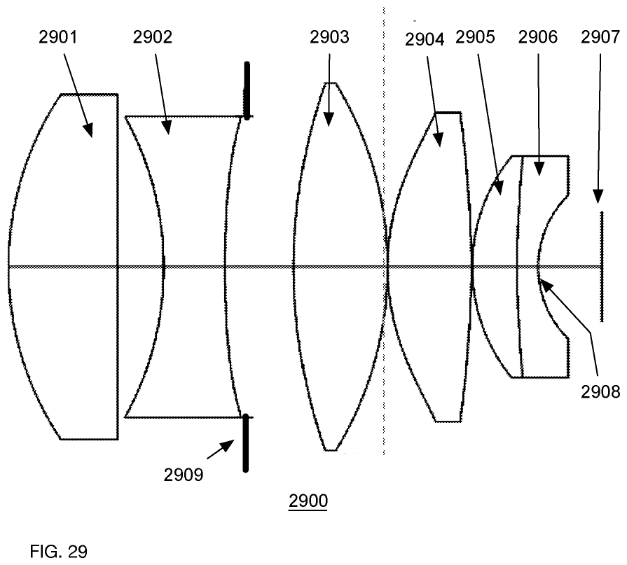

FIG. 29 shows the layout of Example 27. This design has a field angle of +/−12° with a relative aperture of F/0.75 and an effective focal length EFL of 30.5 when used with a 12.8 mm (Ah) image source. The embodiment of an imaging projection lens system 2900 shows an imaging lighting lens of a low F/# which has good optical efficiency and is high resolution.

It comprises two positive powered lens groups. Group 1 comprises L1 2901, L2 2902 and L3 2903 and has an effective focal length of EFL_G1. In preferred embodiment, the EFL_G1 should be equal or greater than 2 times the EFL of the whole lens in order to achieve maximum thermal stability. An aperture stop 2909 is located in group 1 at the image surface of L2. The optical powers of the lens elements in the first group are positive, negative, positive respectively. Group 2 has positive power and comprises positive powered lens element L4 2904, positive powered lens element L5 2905 and negative powered lens element L6 2906. L5 and L6 function together as an air spaced doublet. Group 2 has an effective focal length of EFL_G2. The image surface 2908 of the last element nearest the light source 2907 has a radius of RL. All lens elements are spherical except for L2 and L4. The radius of curvature of individual lens shape is chosen to lower fabrication cost, stray light generation and aberration contribution. The absolute value of the radius of curvature of the lens surface |Rᵢ| with the smallest radius of curvature is |R12|. Table 27 shows the optical prescription of Example 27

TABLE 27

| Surface | | | | | | Clear | |
|---|---|---|---|---|---|---|---|
| ID | Surface Type | lens | Radius | Thickness | Material | Semi | Conic |
| 0 | STANDARD | | Infinity | 1.00E+04 | | 2.13E+03 | 0.00E+00 |
| 1 | STANDARD | L1 | 3.76E+01 | 1.32E+01 | 1.620, 60.374 | 2.09E+01 | 0.00E+00 |
| 2 | STANDARD | | Infinity | 5.62E+00 | | 1.87E+01 | 0.00E+00 |
| 3 | STANDARD | L2 | −3.75E+01 | 7.43E+00 | 1.585, 29.909 | 1.82E+01 | 0.00E+00 |
| 4 | EVENASPH | | 1.34E+02 | 2.37E+00 | | 1.82E+01 | 0.00E+00 |
| 5 | STANDARD | stop | Infinity | 5.95E+00 | | 1.83E+01 | 0.00E+00 |
| 6 | STANDARD | L3 | 6.68E+01 | 1.14E+01 | 1.620, 60.374 | 2.22E+01 | 0.00E+00 |
| 7 | STANDARD | | −4.25E+01 | 0.00E+00 | | 2.23E+01 | 0.00E+00 |
| 8 | EVENASPH | L4 | 2.78E+01 | 1.02E+01 | 1.492, 57.949 | 1.87E+01 | −2.11E+00 |
| 9 | EVENASPH | | −9.18E+01 | 1.01E−01 | | 1.76E+01 | 0.00E+00 |
| 10 | STANDARD | L5 | 2.12E+01 | 5.47E+00 | 1.773, 49.613 | 1.35E+01 | 0.00E+00 |
| 11 | STANDARD | L6 | 1.34E+02 | 2.54E+00 | 1.847, 23.787 | 1.35E+01 | 0.00E+00 |
| 12 | STANDARD | | 1.22E+01 | 7.74E+00 | | 8.67E+00 | 0.00E+00 |
| 13 | STANDARD | | Infinity | 0.00E+00 | | 6.65E+00 | 0.00E+00 |

| | EVENASPH for | EVENASPH for | EVENASPH for |
|---|---|---|---|
| | Image Surface | Object Surface | Image Surface |
| Coefficients | of L2 | of L4 | of L4 |
| r\hat{ }4 | 6.31E−06 | 8.19E−06 | 1.33E−05 |
| r\hat{ }6 | −1.81E−09 | −7.66E−09 | −3.95E−08 |
| r\hat{ }8 | 7.84E−12 | −3.41E−11 | 4.03E−11 |

The parametric equations (1)-(14) are satisfied:

| | | | | | | | |
|---|---|---|---|---|---|---|---|
| EXAMPLE | EFL/Ah | TTL/Ah | Ri/TTL | F/# | EFL_G1/EFL | EFL_G2/EFL | RL/EFL |
| 27 | 2.38 | 5.63 | 0.17 | 0.8 | 1.82 | 3.06 | 0.40 |
| | | | | | EFL_L1/EFL 1.98 | EFL_L4/EFL 1.46 | |
| | | | | | EFL_L2/EFL −1.61 | EFL_L5/EFL 0.88 | |
| | | | | | EFL_L3/EFL 1.43 | EFL_L6/EFL −0.47 | |

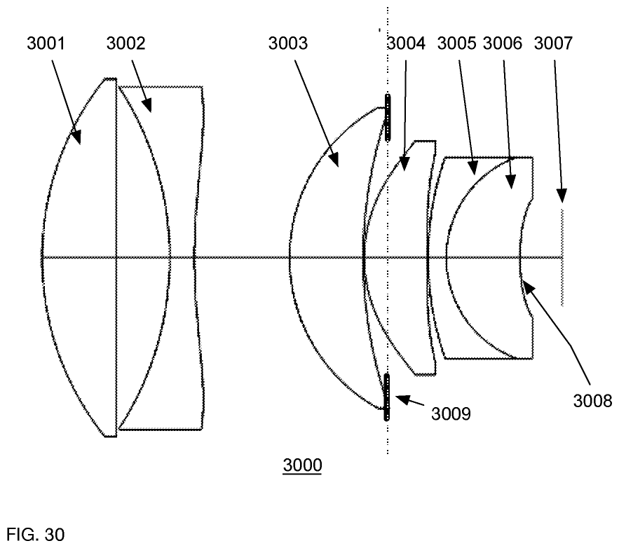

FIG. 30 shows the 6 lens element layout of Example 28. This design has a field angle of +/−12° with a relative aperture of F/0.68 and an effective focal length EFL of 30.7 when used with a 12.8 mm (Ah) image source. The embodiment of an imaging projection lens system 3000 shows an imaging lighting lens of a low F/# which has good optical efficiency and is high resolution.

It comprises two positive powered lens groups. Group 1 comprises L1 3001, L2 3002 and L3 3003 and has an effective focal length of EFL_G1. In preferred embodiment, the EFL_G1 should be equal or greater than 2 times the EFL of the whole lens in order to achieve maximum thermal stability. An aperture stop 3009 is located in group 1 at the image surface of L3. The stop location is closer to the light source to help with field aberration correction. The optical powers of the lens elements in the first group are positive, negative, positive respectively. Group 2 has positive power and comprises two positive powered and one negative powered lens elements in the order: positive powered lens element L4 3004, negative powered L5 3005 and positive powered lens element L6 3006. L5 and L6 function together as an air spaced doublet.

Group 2 has an effective focal length of EFL_G2. The image surface 3008 of the last element nearest the light source 3007 has a radius of RL. All lens elements are spherical except for L2 and L4. The radius of curvature of individual lens shape is chosen to lower fabrication cost, stray light generation and aberration contribution. The absolute value of the radius of curvature of the lens surface |Rᵢ| with the smallest radius of curvature is |R10|. Table 28 shows the optical prescription of Example 28.

TABLE 28

| Surface | | | | | | Clear | |
|---|---|---|---|---|---|---|---|
| ID | Surface Type | Lens | Radius | Thickness | Material | Semi | Conic |
| 0 | STANDARD | | Infinity | 1.00E+04 | | 2.14E+03 | 0.00E+00 |
| 1 | STANDARD | L1 | 39.4 | 1.03E+01 | 1.620, 60.374 | 2.47E+01 | 0.00E+00 |
| 2 | STANDARD | | Infinity | 7.39E+00 | | 2.41E+01 | 0.00E+00 |
| 3 | STANDARD | L2 | −43.0 | 3.44E+00 | 1.585, 29.909 | 2.35E+01 | 0.00E+00 |
| 4 | EVENASPH | | 89.4 | 1.32E+01 | | 2.37E+01 | 0.00E+00 |
| 5 | STANDARD | L3 | 23.70 | 1.02E+01 | 1.620, 60.374 | 2.08E+01 | 0.00E+00 |
| 6 | STANDARD | | 61.70 | 1.36E−01 | | 2.08E+01 | 0.00E+00 |
| 7 | EVENASPH | L4(stop) | 19.00 | 8.73E+00 | 1.492, 57.949 | 1.61E+01 | −1.37E+00 |
| 8 | EVENASPH | | −16800 | 1.01E−01 | | 1.47E+01 | 0.00E+00 |
| 9 | STANDARD | L5 | 41.60 | 2.54E+00 | 1.805, 25.477 | 1.39E+01 | 0.00E+00 |
| 10 | STANDARD | L6 | 14.80 | 1.02E+01 | 1.744, 44.904 | 1.39E+01 | 0.00E+00 |
| 11 | STANDARD | | 27.10 | 5.87E+00 | | 8.09E+00 | 8.11E+00 |
| 12 | STANDARD | | Infinity | 0.00E+00 | | 6.66E+00 | 0.00E+00 |

| | EVENASPH for | EVENASPH for | EVENASPH for |
|---|---|---|---|
| | Image Surface | Object Surface | Image Surface |
| Coefficients | of L2 | of L4 | of L4 |
| r\hat{ }4 | −3.91E−06 | 1.25E−05 | 4.00E−05 |
| r\hat{ }6 | −8.35E−09 | 4.26E−08 | −7.78E−08 |
| r\hat{ }8 | 4.44E−12 | −2.17E−10 | 4.19E−11 |

The parametric equations (1)-(14) are satisfied:

| | | | | | | | |
|---|---|---|---|---|---|---|---|
| EXAMPLE | EFL/Ah | TTL/Ah | Ri/TTL | F/# | EFL_G1/EFL | EFL_G2/EFL | RL/EFL |
| 28 | 2.40 | 5.63 | 0.21 | 0.7 | 2.37 | 1.37 | 0.88 |
| | | | | | EFL_F1/EFL 2.06 | EFL_L4/EFL 1.25 | |
| | | | | | EFL_F2/EFL −1.59 | EFL_L5/EFL 2.13 | |
| | | | | | EFL_F3/EFL 1.83 | EFL_L6/EFL −1.00 | |

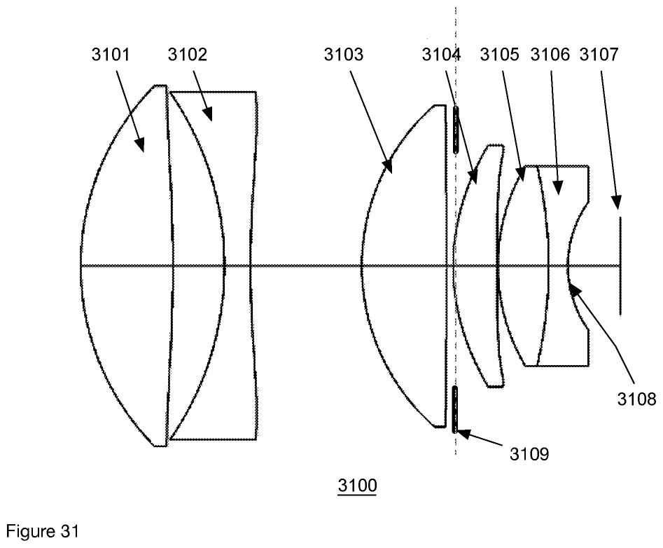

FIG. 31 shows the layout of embodiment Example 29, with three lens elements in group 2.

This design has a field angle of +/−12° with a relative aperture of F/0.67 and an effective focal length EFL of 30.8. The embodiment of an imaging projection lens system 3100 shows an imaging lighting lens of a low F/# which has good optical efficiency and is high resolution. It comprises two positive powered lens groups. Group 1 comprises L1 3101, L2 3102 and L3 3103 and has an effective focal length of EFL_G1. In preferred embodiment, the EFL_G1 should be equal or greater than 2 times the EFL of the whole lens in order to achieve maximum thermal stability. An aperture stop 3109 is located in group 1 at the image surface of L3. The stop location is closer to the light source to help with field aberration correction. The optical powers of the lens elements in the first group are positive, negative, positive respectively. Group 2 has positive power and comprises positive powered lens element L4 3104, positive powered lens element L5 3105 and negative powered lens element L6 3106. L5 and L6 function together as an air spaced doublet. Group 2 has an effective focal length of EFL_G2. The image surface 3108 of the last element nearest the light source 3107 has a radius of RL. All lens elements are spherical except for L2 and L4. The radius of curvature of individual lens shape is chosen to lower fabrication cost, stray light generation and aberration contribution. The absolute value of the radius of curvature of the lens surface |Rᵢ| with the smallest radius of curvature is |R11|. Table 29 shows the optical prescription of Example 29.

TABLE 29

| Surface | | | | | | Clear | |
|---|---|---|---|---|---|---|---|
| ID | Surface Type | Lens | Radius | Thickness | Material | Semi | Conic |
| 0 | STANDARD | | Infinity | 1.00E+04 | | 2.14E+03 | 0.00E+00 |
| 1 | STANDARD | L1 | 34.3 | 1.23E+01 | 1.492, 57.441 | 2.41E+01 | 0.00E+00 |
| 2 | EVENASPH | | −177 | 6.88E+00 | | 2.35E+01 | 0.00E+00 |
| 3 | STANDARD | L2 | −40.7 | 3.48E+00 | 1.585, 29.909 | 2.32E+01 | 0.00E+00 |
| 4 | EVENASPH | | 136 | 1.48E+01 | | 2.31E+01 | 0.00E+00 |
| 5 | STANDARD | L3 | 28.7 | 1.13E+01 | 1.620, 60.374 | 2.15E+01 | 0.00E+00 |
| 6 | STANDARD | | −2.42E+03 | 9.26E−01 | | 2.08E+01 | 0.00E+00 |
| 7 | EVENASPH | L4 (stop) | 2.94E+01 | 5.85E+00 | 1.694, 53.151 | 1.61E+01 | −5.14E−01 |
| 8 | EVENASPH | | −1.05E+03 | 9.82E−02 | | 1.52E+01 | 0.00E+00 |
| 9 | STANDARD | L5 | 2.62E+01 | 6.76E+00 | 1.773, 49.613 | 1.34E+01 | 0.00E+00 |
| 10 | STANDARD | L6 | −5.90E+01 | 2.57E+00 | 1.847, 23.787 | 1.34E+01 | 0.00E+00 |
| 11 | STANDARD | | 1.48E+01 | 7.03E+00 | | 8.52E+00 | 0.00E+00 |
| 12 | STANDARD | | Infinity | 0.00E+00 | | 6.53E+00 | 0.00E+00 |

| | EVENASPH | EVENASPH | EVENASPH | EVENASPH |
|---|---|---|---|---|
| | for Image | for Image | for Object | for Image |
| | Surface | Surface | Surface | Surface |
| Coefficients | of L1 | of L2 | of L4 | of L4 |
| r\hat{ }4 | 2.79E−06 | −2.18E−06 | 5.58E−06 | 2.41E−05 |
| r\hat{ }6 | −7.19E−10 | −6.49E−09 | −2.54E−08 | −5.79E−08 |
| r\hat{ }8 | | 3.91E−12 | 2.86E−11 | 1.30E−10 |

The parametric equations (1)-(14) are satisfied:

| | | | | | | | |
|---|---|---|---|---|---|---|---|
| EXAMPLE | EFL/Ah | TTL/Ah | Ri/TTL | F/# | EFL_G1/EFL | EFL_G2/EFL | RL/EFL |
| 29 | 2.41 | 5.62 | 0.21 | 0.7 | 1.79 | 2.51 | 0.48 |
| | | | | | EFL_L1/EFL 1.93 | EFL_L4/EFL 1.34 | |
| | | | | | EFL_L2/EFL −1.71 | EFL_L5/EFL 1.14 | |
| | | | | | EFL_L3/EFL 1.48 | EFL_L6/EFL −0.55 | |

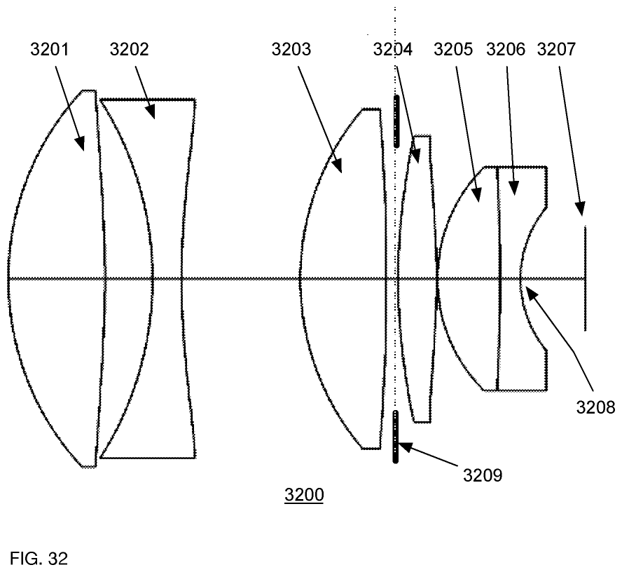

FIG. 32 shows the layout of Example 30. This design has a field angle of +/−12° with a relative aperture of F/0.7 and an effective focal length EFL of 30.8 when used with a 12.8 mm (Ah) image source. The 30th embodiment of an imaging projection lens system 3200 shows an imaging lighting lens of a low F/# which has good optical efficiency and is high resolution. It comprises two positive powered lens groups. Group 1 comprises L1 3201, L2 3202 and L3 3203 and has an effective focal length of EFL_G1. In preferred embodiment, the EFL_G1 should be equal or greater than 2 times the EFL of the whole lens in order to achieve maximum thermal stability. An aperture stop 3209 is located in group 1 at the image surface of L3. The stop location is closer to the light source to help with field aberration correction. The optical powers of the lens elements in the first group are positive, negative, positive respectively. Group 2 has positive power and comprises positive powered lens element L4 3204, positive powered lens element L5 3205 and negative powered lens element L6 3206. L5 and L6 function together as an air spaced doublet. Group 2 has an effective focal length of EFL_G2. The image surface 3208 of the last element nearest the light source 3207 has a radius of RL. All lens elements are spherical except for L2 and L4. The radius of curvature of individual lens shape is chosen to lower fabrication cost, stray light generation and aberration contribution. The absolute value of the radius of curvature of the lens surface |Rᵢ| with the smallest radius of curvature is |R11|. Table 30 shows the optical prescription of Example 30.

TABLE 30A

| Surface | | | | | | Clear | |
|---|---|---|---|---|---|---|---|
| ID | Surface Type | Lens | Radius | Thickness | Material | Semi | Conic |
| 0 | STANDARD | | Infinity | 1.00E+04 | | 2.14E+03 | 0.00E+00 |
| 1 | STANDARD | L1 | 3.43E+01 | 1.20E+01 | 1.492, 57.441 | 2.34E+01 | 0.00E+00 |
| 2 | EVENASPH | | −1.45E+02 | 5.96E+00 | | 2.27E+01 | 0.00E+00 |
| 3 | STANDARD | L2 | −4.12E+01 | 3.64E+00 | 1.585, 29.909 | 2.23E+01 | 0.00E+00 |
| 4 | EVENASPH | | 9.88E+01 | 1.48E+01 | | 2.18E+01 | 0.00E+00 |
| 5 | STANDARD | L3 | 3.25E+01 | 1.07E+01 | 1.620, 60.374 | 2.11E+01 | 0.00E+00 |
| 6 | STANDARD | | −2.70E+02 | 1.46E+00 | | 2.04E+01 | 0.00E+00 |
| 7 | EVENASPH | L4(stop) | 7.60E+01 | 4.81E+00 | 1.694, 53.151 | 1.77E+01 | 5.46E+00 |
| 8 | EVENASPH | | −9.18E+01 | 9.98E−02 | | 1.70E+01 | 0.00E+00 |
| 9 | STANDARD | L5 | 1.94E+01 | 7.82E+00 | 1.773, 49.613 | 1.39E+01 | 0.00E+00 |
| 10 | STANDARD | L6 | −2.41E+02 | 2.54E+00 | 1.847, 23.787 | 1.28E+01 | 0.00E+00 |
| 11 | STANDARD | | 1.38E+01 | 8.13E+00 | | 8.87E+00 | 0.00E+00 |
| 12 | STANDARD | | Infinity | 0.00E+00 | | 6.45E+00 | 0.00E+00 |

TABLE 30B

| | EVENASPH | EVENASPH | EVENASPH | EVENASPH |
|---|---|---|---|---|
| | for Image | for Image | for Object | for Image |
| | Surface | Surface | Surface | Surface |
| Coefficients | of L1 | of L2 | of L4 | of L4 |
| r\hat{ }4 | 3.76E−06 | −3.05E−06 | 6.25E−07 | 1.25E−05 |
| r\hat{ }6 | −2.50E−09 | 8.46E−10 | −3.52E−08 | −3.50E−08 |
| r\hat{ }8 | | −3.40E−12 | 7.38E−11 | 8.94E−11 |

The parametric equations (1)-(14) are satisfied:

| | | | | | | | |
|---|---|---|---|---|---|---|---|
| EXAMPLE | EFL/Ah | TTL/Ah | Ri/TTL | F/# | EFL_G1/EFL | EFL_G2/EFL | RL/EFL |
| 30 | 2.41 | 5.62 | 0.19 | 0.7 | 1.87 | 2.2 | 0.45 |
| | | | | | EFL_L1/EFL 1.86 | EFL_L4/EFL 1.96 | |
| | | | | | EFL_L2/EFL −1.59 | EFL_L5/EFL 0.82 | |
| | | | | | EFL_L3/EFL 1.53 | EFL_L6/EFL −0.52 | |

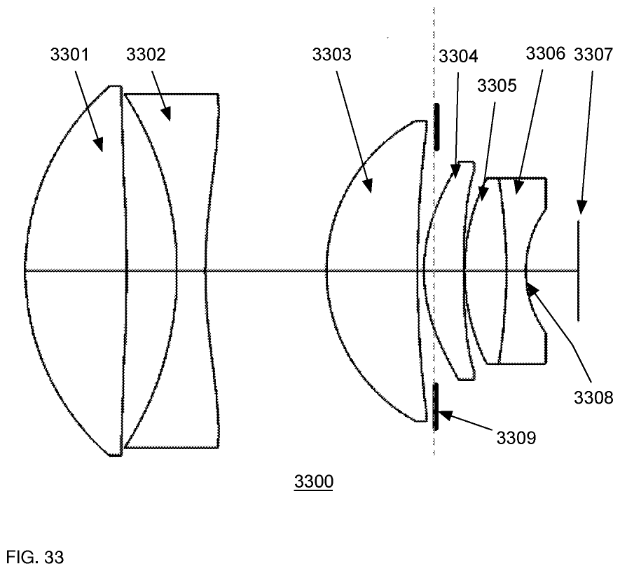

FIG. 33 shows the layout of Example 31. This design has a field angle of +/−12° with a relative aperture of F/0.69 and an effective focal length EFL of 30.8 when used with a 12.8 mm (Ah) image source. The embodiment of an imaging projection lens system 3300 shows an imaging lighting lens of a low F/# which has good optical efficiency and is high resolution.

It comprises two positive powered lens groups. Group 1 comprises L1 3301, L2 3302 and L3 3303 and has an effective focal length of EFL_G1. In preferred embodiment, the EFL_G1 should be equal or greater than 2 times the EFL of the whole lens in order to achieve maximum thermal stability. An aperture stop 3309 is located in group 1 at the image surface of L3. The stop location is closer to the light source to help with field aberration correction. The optical powers of the lens elements in the first group are positive, negative, positive respectively. Group 2 has positive power and comprises positive powered lens element L4 3304, positive powered lens element L5 3305 and negative powered lens element L6 3306. L5 and L6 function together as an air spaced doublet. Group 2 has an effective focal length of EFL_G2. The image surface 3308 of the last element nearest the light source 3307 has a radius of RL. All lens elements are spherical except for L2 and L4. The radius of curvature of individual lens shape is chosen to lower fabrication cost, stray light generation and aberration contribution. The absolute value of the radius of curvature of the lens surface |Rᵢ| with the smallest radius of curvature is |R11|. Table 31 shows the optical prescription of Example 31.

TABLE 31A

| Surface | | | | | | Clear | |
|---|---|---|---|---|---|---|---|
| ID | Surface Type | Lens | Radius | Thickness | Material | Semi | Conic |
| 0 | STANDARD | | Infinity | 1.00E+04 | | 2.14E+03 | 0.00E+00 |
| 1 | STANDARD | L1 | 3.18E+01 | 1.32E+01 | 1.492, 57.441 | 2.40E+01 | 0.00E+00 |
| 2 | EVENASPH | | −1.57E+02 | 6.54E+00 | | 2.33E+01 | 0.00E+00 |
| 3 | STANDARD | L2 | −4.21E+01 | 3.69E+00 | 1.585, 29.909 | 2.30E+01 | 0.00E+00 |
| 4 | EVENASPH | | 6.47E+01 | 1.57E+01 | | 2.23E+01 | 0.00E+00 |
| 5 | STANDARD | L3 | 2.22E+01 | 1.18E+01 | 1.620, 60.374 | 1.95E+01 | 0.00E+00 |
| 6 | STANDARD | | 1.43E+02 | 8.74E−01 | | 1.86E+01 | 0.00E+00 |
| 7 | EVENASPH | L4(stop) | 2.15E+01 | 5.19E+00 | 1.694, 53.151 | 1.41E+01 | −4.88E−01 |
| 8 | EVENASPH | | 1.56E+02 | 9.91E−02 | | 1.30E+01 | 0.00E+00 |
| 9 | STANDARD | L5 | 2.67E+01 | 5.42E+00 | 1.773, 49.613 | 1.20E+01 | 0.00E+00 |
| 10 | STANDARD | L6 | −7.36E+01 | 2.54E+00 | 1.847, 23.787 | 1.20E+01 | 0.00E+00 |
| 11 | STANDARD | | 1.37E+01 | 6.85E+00 | | 8.01E+00 | 0.00E+00 |
| 12 | STANDARD | | Infinity | 0.00E+00 | | 6.47E+00 | 0.00E+00 |

TABLE 31B

| | EVENASPH | EVENASPH | EVENASPH | EVENASPH |
|---|---|---|---|---|
| | for Image | for Image | for Object | for Image |
| | Surface | Surface | Surface | Surface |
| Coefficients | of L1 | of L2 | of L4 | of L4 |
| r\hat{ }4 | 5.42E−06 | −8.63E−06 | 5.43E−06 | 3.99E−05 |
| r\hat{ }6 | −3.35E−09 | −1.42E−09 | −8.03E−08 | −1.76E−07 |
| r\hat{ }8 | | 3.65E−13 | −1.44E−12 | 6.14E−10 |

The parametric equations (1)-(14) are satisfied:

| | | | | | | | |
|---|---|---|---|---|---|---|---|
| EXAMPLE | EFL/Ah | TTL/Ah | Ri/TTL | F/# | EFL_G1/EFL | EFL_G2/EFL | RL/EFL |
| 31 | 2.41 | 5.62 | 0.19 | 0.7 | 1.74 | 2.58 | 0.44 |
| | | | | | EFL_L1/EFL 1.78 | EFL_L4/EFL 1.15 | |
| | | | | | EFL_L2/EFL −1.39 | EFL_L5/EFL 1.15 | |
| | | | | | EFL_L3/EFL 1.32 | EFL_L6/EFL −0.51 | |

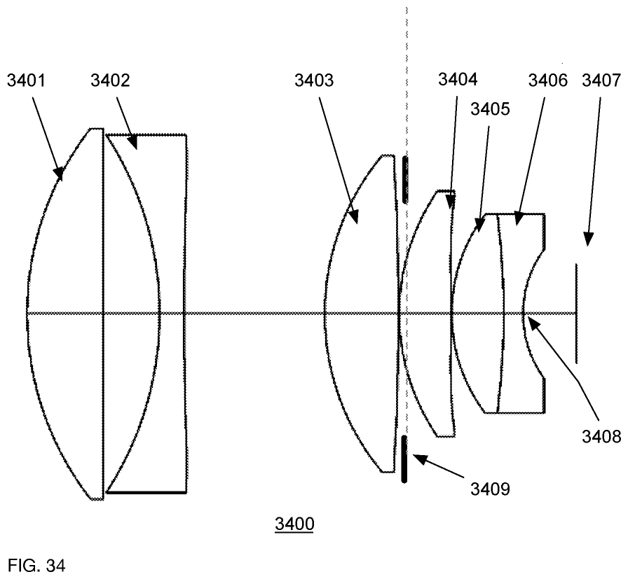

FIG. 34 shows the layout of Example 32. This design has a field angle of +/−12° with a relative aperture of F/0.67 and an effective focal length EFL of 30.8 when used with a 12.8 mm (Ah) image source. The embodiment of an imaging projection lens system 3400 shows an imaging lighting lens of a low F/# which has good optical efficiency and is high resolution.

It comprises two positive powered lens groups. Group 1 comprises L1 3401, L2 3402 and L3 3403 and has an effective focal length of EFL_G1. In preferred embodiment, the EFL_G1 should be equal or greater than 2 times the EFL of the whole lens in order to achieve maximum thermal stability. An aperture stop 3409 is located in group 1 at the image surface of L3. The stop location is closer to the light source to help with field aberration correction. The optical powers of the lens elements in the first group are positive, negative, positive respectively. Group 2 has positive power and comprises positive powered lens element L4 3404, positive powered lens element L5 3405 and negative powered lens element L6 3406. L5 and L6 function together as an air spaced doublet. Group 2 has an effective focal length of EFL_G2. The image surface 3408 of the last element nearest the light source 3407 has a radius of RL. All lens elements are spherical except for L2 and L4. The radius of curvature of individual lens shape is chosen to lower fabrication cost, stray light generation and aberration contribution. The absolute value of the radius of curvature of the lens surface |Rᵢ| with the smallest radius of curvature is |R11|. Table 32 shows the optical prescription of Example 32.

TABLE 32A

| Surface | | | | | | Clear | |
|---|---|---|---|---|---|---|---|
| ID | Surface Type | LENS | Radius | Thickness | Material | Semi | Conic |
| 0 | STANDARD | | Infinity | 1.00E+04 | | 2.14E+03 | 0.00E+00 |
| 1 | STANDARD | L1 | 3.96E+01 | 9.95E+00 | 1.620, 60.374 | 2.43E+01 | 0.00E+00 |
| 2 | STANDARD | | Infinity | 7.45E+00 | | 2.37E+01 | 0.00E+00 |
| 3 | STANDARD | L2 | −4.27E+01 | 3.19E+00 | 1.585, 29.909 | 2.35E+01 | 0.00E+00 |
| 4 | EVENASPH | | 4.20E+02 | 1.84E+01 | | 2.28E+01 | 0.00E+00 |
| 5 | STANDARD | L3 | 3.24E+01 | 9.68E+00 | 1.620, 60.374 | 2.08E+01 | 0.00E+00 |
| 6 | STANDARD | | −3.47E+02 | 9.94E−02 | | 2.08E+01 | 0.00E+00 |
| 7 | EVENASPH | L4(stop) | 2.83E+01 | 6.79E+00 | 1.492, 57.949 | 1.61E+01 | −1.41E+00 |
| 8 | EVENASPH | | −3.46E+02 | 1.01E−01 | | 1.52E+01 | 0.00E+00 |
| 9 | STANDARD | L5 | 2.15E+01 | 6.82E+00 | 1.773, 49.613 | 1.31E+01 | 0.00E+00 |
| 10 | STANDARD | L6 | −101. | 2.54E+00 | 1.847, 23.787 | 1.31E+01 | 0.00E+00 |
| 11 | STANDARD | | 1.44E+01 | 6.95E+00 | | 8.47E+00 | 0.00E+00 |
| 12 | STANDARD | | Infinity | 0.00E+00 | | 6.47E+00 | 0.00E+00 |

TABLE 32B

| | EVENASPH for | EVENASPH for | EVENASPH for |
|---|---|---|---|
| | Image Surface | Object Surface | Image Surface |
| Coefficients | of L2 | of L4 | of L4 |
| r\hat{ }4 | 1.12E−06 | 8.03E−06 | 1.71E−05 |
| r\hat{ }6 | −5.35E−09 | 6.70E−09 | −1.62E−08 |
| r\hat{ }8 | 1.68E−12 | −2.18E−11 | 2.29E−11 |

The parametric equations (1)-(14) are satisfied:

| | | | | | | | |
|---|---|---|---|---|---|---|---|
| EXAMPLE | EFL/Ah | TTL/Ah | Ri/TTL | F/# | EFL_G1/EFL | EFL_G2/EFL | RL/EFL |
| 32 | 2.41 | 5.62 | 0.20 | 0.7 | 1.78 | 2.58 | 0.47 |
| | | | | | EFL_L1/EFL 2.09 | EFL_L4/EFL 1.75 | |
| | | | | | EFL_L2/EFL −2.15 | EFL_L5/EFL 0.93 | |
| | | | | | EFL_L3/EFL 1.58 | EFL_L6/EFL −0.55 | |

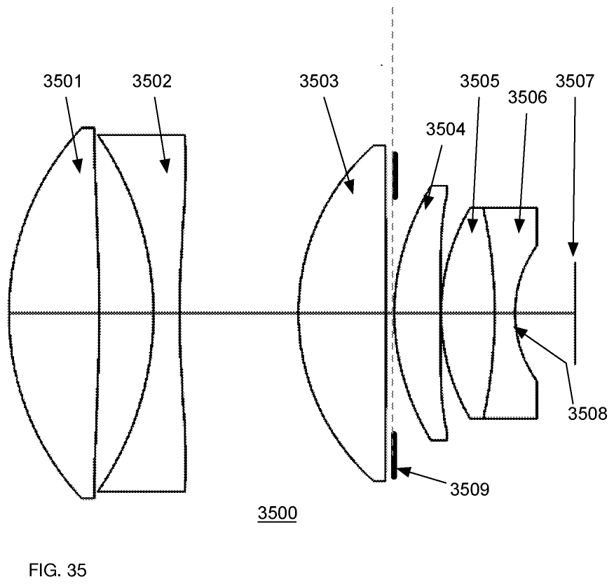

FIG. 35 shows the layout of Example 33. This design has a field angle of +/−12° with a relative aperture of F/0.7 and an effective focal length EFL of 30.8 when used with a 12.8 mm (Ah) image source. The embodiment of an imaging projection lens system 3500 shows an imaging lighting lens of a low F/# which has good optical efficiency and is high resolution.

It comprises two positive powered lens groups. Group 1 comprises L1 3501, L2 3502 and L3 3503 and has an effective focal length of EFL_G1. In preferred embodiment, the EFL_G1 should be equal or greater than 2 times the EFL of the whole lens in order to achieve maximum thermal stability. An aperture stop 3509 is located in group 1 at the image surface of L3. The stop location is closer to the light source to help with field aberration correction. The optical powers of the lens elements in the first group are positive, negative, positive respectively. Group 2 has positive power and comprises positive powered lens element L4 3504, positive powered lens element L5 3505 and negative powered lens element L6 3506. L5 and L6 function together as an air spaced doublet. Group 2 has an effective focal length of EFL_G2. The image surface 3508 of the last element nearest the light source 3507 has a radius of RL. All lens elements are spherical except for L2 and L4. The radius of curvature of individual lens shape is chosen to lower fabrication cost, stray light generation and aberration contribution. The absolute value of the radius of curvature of the lens surface |Rᵢ| with the smallest radius of curvature is |R11|. Table 33 shows the optical prescription of Example 33.

TABLE 33A

| Surface | | | | | | Clear | |
|---|---|---|---|---|---|---|---|
| ID | Surface Type | lens | Radius | Thickness | Material | Semi | Conic |
| 0 | STANDARD | | Infinity | 1.00E+04 | | 2.14E+03 | 0.00E+00 |
| 1 | STANDARD | L1 | 3.45E+01 | 1.15E+01 | 1.492, 57.441 | 2.35E+01 | 0.00E+00 |
| 2 | EVENASPH | | −2.12E+02 | 6.90E+00 | | 2.29E+01 | 0.00E+00 |
| 3 | STANDARD | L2 | −3.97E+01 | 3.36E+00 | 1.585, 29.909 | 2.26E+01 | 0.00E+00 |
| 4 | EVENASPH | | 1.34E+02 | 1.51E+01 | | 2.26E+01 | 0.00E+00 |
| 5 | STANDARD | L3 | 2.85E+01 | 1.11E+01 | 1.620, 60.374 | 2.13E+01 | 0.00E+00 |
| 6 | STANDARD | | −2.35E+03 | 1.07E+00 | | 2.07E+01 | 0.00E+00 |
| 7 | EVENASPH | L4 (stop) | 2.95E+01 | 5.85E+00 | 1.694, 53.151 | 1.61E+01 | −4.96E−01 |
| 8 | EVENASPH | | 8.58E+02 | 1.02E−01 | | 1.51E+01 | 0.00E+00 |
| 9 | STANDARD | L5 | 2.61E+01 | 6.80E+00 | 1.773, 49.613 | 1.33E+01 | 0.00E+00 |
| 10 | STANDARD | L6 | −6.21E+01 | 2.58E+00 | 1.847, 23.787 | 1.33E+01 | 0.00E+00 |
| 11 | STANDARD | | 1.46E+01 | 7.62E+00 | | 8.56E+00 | 0.00E+00 |
| 12 | STANDARD | | Infinity | 0.00E+00 | | 6.52E+00 | 0.00E+00 |

TABLE 33B

| | EVENASPH | EVENASPH | EVENASPH | EVENASPH |
|---|---|---|---|---|
| | for Image | for Image | for Object | for Image |
| | Surface | Surface | Surface | Surface |
| Coefficients | of L1 | of L2 | of L4 | of L4 |
| r\hat{ }4 | 2.53E−06 | −2.54E−06 | 4.97E−06 | 2.42E−05 |
| r\hat{ }6 | −3.98E−10 | −7.01E−09 | −2.53E−08 | −5.51E−08 |
| r\hat{ }8 | | 4.63E−12 | 4.04E−11 | 1.40E−10 |

The parametric equations (1)-(14) are satisfied:

| | | | | | | | |
|---|---|---|---|---|---|---|---|
| EXAMPLE | EFL/Ah | TTL/Ah | Ri/TTL | F/# | EFL_G1/EFL | EFL_G2/EFL | RL/EFL |
| 33 | 2.41 | 5.62 | 0.20 | 0.7 | 1.81 | 2.55 | 0.47 |
| | | | | | EFL_L1/EFL 1.98 | EFL_L4/EFL 1.33 | |
| | | | | | EFL_L2/EFL −1.67 | EFL_L5/EFL 1.13 | |
| | | | | | EFL_L3/EFL 1.47 | EFL_L6/EFL −0.54 | |

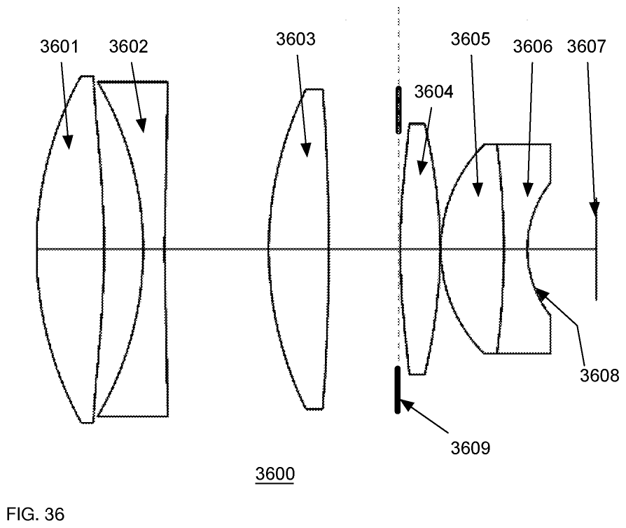

FIG. 36 shows the layout of Example 34. This design has a field angle of +/−12° with a relative aperture of F/0.79 and an effective focal length EFL of 30.8 when used with a 12.8 mm (Ah) image source. The embodiment of an imaging projection lens system 3600 shows an imaging lighting lens of a low F/# which has good optical efficiency and is high resolution.

It comprises two positive powered lens groups. Group 1 comprises L1 3601, L2 3602 and L3 3603 and has an effective focal length of EFL_G1. In preferred embodiment, the EFL_G1 should be equal or greater than 2 times the EFL of the whole lens in order to achieve maximum thermal stability. An aperture stop 3609 is located in group 1 at the image surface of L3. The stop location is closer to the light source to help with field aberration correction. The optical powers of the lens elements in the first group are positive, negative, positive respectively. Group 2 has positive power and comprises positive powered lens element L4 3604, positive powered lens element L5 3605 and negative powered lens element L6 3606. L5 and L6 function together as an air spaced doublet. Group 2 has an effective focal length of EFL_G2. The image surface 3608 of the last element nearest the light source 3607 has a radius of RL. All lens elements are spherical except for L2 and L4. The radius of curvature of individual lens shape is chosen to lower fabrication cost, stray light generation and aberration contribution. The absolute value of the radius of curvature of the lens surface |Rᵢ| with the smallest radius of curvature is |R₁₁|. Table 34 shows the optical prescription of Example 34.

TABLE 34A

| Surface | | | | | | Clear | |
|---|---|---|---|---|---|---|---|
| ID | Surface Type | LENS | Radius | Thickness | Material | Semi | Conic |
| 0 | STANDARD | | Infinity | 1.00E+04 | | 2.14E+03 | 0.00E+00 |
| 1 | STANDARD | L1 | 46.0 | 8.71E+00 | 1.492, 57.441 | 2.23E+01 | 0.00E+00 |
| 2 | EVENASPH | | −104 | 5.03E+00 | | 2.18E+01 | 0.00E+00 |
| 3 | STANDARD | L2 | −42.2 | 2.76E+00 | 1.585, 29.909 | 2.15E+01 | 0.00E+00 |
| 4 | EVENASPH | | 233 | 1.34E+01 | | 2.11E+01 | 0.00E+00 |
| 5 | STANDARD | L3 | 46.5 | 7.67E+00 | 1.620, 60.374 | 2.05E+01 | 0.00E+00 |
| 6 | STANDARD | | −271 | 9.22E+00 | | 2.05E+01 | 0.00E+00 |
| 7 | EVENASPH | L4 (stop) | 94.1 | 5.11E+00 | 1.694, 53.151 | 1.61E+01 | 2.23E+01 |
| 8 | EVENASPH | | −59.6 | 9.95E−02 | | 1.60E+01 | 0.00E+00 |
| 9 | STANDARD | L5 | 18.9 | 8.12E+00 | 1.773, 49.613 | 1.34E+01 | 0.00E+00 |
| 10 | STANDARD | L6 | −99.5 | 3.03E+00 | 1.847, 23.787 | 1.34E+01 | 0.00E+00 |
| 11 | STANDARD | | 13.8 | 8.83E+00 | | 8.63E+00 | 0.00E+00 |
| 12 | STANDARD | | Infinity | 0.00E+00 | | 6.54E+00 | 0.00E+00 |

TABLE 34B

| | EVENASPH | EVENASPH | EVENASPH | EVENASPH |
|---|---|---|---|---|
| | for Image | for Image | for Object | for Image |
| | Surface | Surface | Surface | Surface |
| Coefficients | of L1 | of L2 | of L4 | of L4 |
| r\hat{ }4 | 5.01E−06 | −4.44E−06 | −1.43E−06 | 1.04E−05 |
| r\hat{ }6 | −1.86E−09 | 1.67E−09 | −3.34E−08 | −4.63E−08 |
| r\hat{ }8 | | 4.30E−12 | 2.10E−11 | 7.96E−11 |

The parametric equations (1)-(14) are satisfied:

| | | | | | | | |
|---|---|---|---|---|---|---|---|
| EXAMPLE | EFL/Ah | TTL/Ah | Ri /TTL | F/# | EFL_G1/EFL | EFL_G2/EFL | RL/EFL |
| 34 | 2.41 | 5.62 | 0.19 | 0.8 | 2.31 | 1.59 | 0.45 |
| | | | | | EFL_L1/EFL 2.14 | EFL_L4/EFL 1.72 | |
| | | | | | EFL_L2/EFL −1.96 | EFL_L5/EFL 0.80 | |
| | | | | | EFL_L3/EFL 2.09 | EFL_L6/EFL −0.52 | |

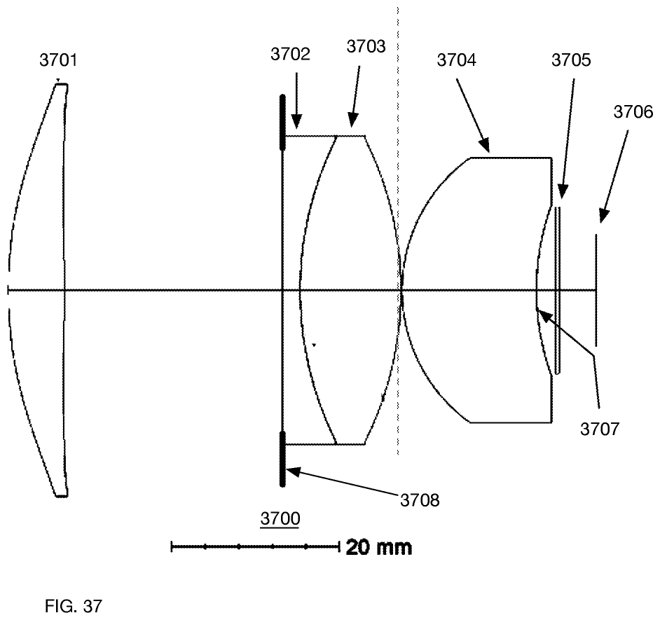

FIG. 37 shows the layout of embodiment 35, a four lens imaging projection lens system 3700. This design has a field angle of +/−12° with a relative aperture of F/0.70 and an effective focal length of 30.9 when used with a 12.8 mm (Ah) image source. This example of a four lens imaging system shows an imaging lighting lens of a low F/# which has good optical efficiency and is high resolution.

It comprises two positive powered lens groups. Group 1 comprises L1 3701, L2 3702 and L3 3703 and has an effective focal length of EFL_G1. An aperture stop 3708 is located in group 1 at the object surface of L2. L2 and L3 form a cemented or air gap doublet. The optical powers of the lens elements in the first group are positive, negative, positive respectively. L1 is aspheric, where at least one of the two surfaces is aspheric. The power of aspheric element in group 1 is kept weak to ensure the stability of performance within working temperature range. Group 2 comprises one lens element L4 3704 and has an effective focal length of EFL_G2. The image surface 3707 of the last element nearest the light source 3706 has a radius of RL. The example includes a cover plate 3705. Surfaces 8 and 9 and the corresponding Nd and Abbe numbers in the prescription refer to this cover plate. The radius of curvature of individual lens shape is chosen to lower fabrication cost, stray light generation and aberration contribution. The absolute value of the radius of curvature of the lens surface |Rᵢ| with the smallest radius of curvature is |R6|. Table 35 shows the optical prescription of Example 35.

TABLE 35

| Surface | Type | Radius | Thickness | ND, ABBE NO. | Clear Diam | Conic | LENS |
|---|---|---|---|---|---|---|---|
| OBJ | SPHERICAL | Infinity | 10000.00 | | 4380.00 | 0.00 | |
| 1 | ASPHERICAL | 51.08 | 6.66 | 1.493, 50.887 | 48.92 | 0.00 | L1 |
| 2 | ASPHERICAL | −303.00 | 26.00 | | 48.33 | 0.00 | |
| STO | SPHERICAL | Infinity | 2.09 | 1.784, 25.719 | 36.66 | 0.00 | L2 |
| 4 | SPHERICAL | 39.99 | 12.00 | 1.622, 58.154 | 35.83 | 0.00 | L3 |
| 5 | SPHERICAL | −39.99 | 0.13 | | 35.72 | 0.00 | |
| 6 | SPHERICAL | 19.31 | 16.00 | 1.638, 55.471 | 31.36 | 0.00 | L4 |
| 7 | SPHERICAL | 29.63 | 2.22 | | 20.36 | 0.00 | |
| 8 | SPHERICAL | Infinity | 0.50 | 1.516, 64.212 | 19.79 | 0.00 | |
| 9 | SPHERICAL | Infinity | 4.35 | | 19.39 | 0.00 | |
| IMA | SPHERICAL | Infinity | | | 13.36 | 0.00 | |

Both surfaces of L1 are aspherical. The parameters for the equation:

$$z = \frac{{cr}^{2}}{1 + \sqrt{1 - ( 1 + k ) {c}^{2} {r}^{2}}} + {a}_{1} {r}^{2} + {a}_{2} {r}^{4} + {a}_{3} {r}^{6} + {a}_{4} {r}^{8} + {a}_{5} {r}^{10} + {a}_{6} {r}^{12} + {a}_{7} {r}^{14} + {a}_{8} {r}^{16} .$$

are:

Object Surface of L1:

| | |
|---|---|
| Coefficient on r²: | 0 |
| Coefficient on r⁴: | 4.590e−06 |
| Coefficient on r⁶: | − 1.543e−08 |
| Coefficient on r⁸ | 8.262e−12 |

Image Surface of L1:

| | |
|---|---|
| Coefficient on r² | 0 |
| Coefficient on r⁴ | 1.040e−05 |
| Coefficient on r⁶ | −2.406e−08 |
| Coefficient on r⁸ | 2.246e−11 |

The parametric equations (1)-(14) are satisfied:

| | | | | | | | |
|---|---|---|---|---|---|---|---|
| EXAMPLE | EFL/Ah | TTL/Ah | Ri/TTL | F/# | EFL_G1/EFL | EFL_G2/EFL | RL/EFL |
| 35 | 2.41 | 5.46 | 0.28 | 0.7 | 1.82 | 1.7 | 0.96 |
| | | | | | EFL_L1/EFL 2.9 | EFL_L4/EFL 1.7 | |
| | | | | | EFL_L2/EFL −1.6 | | |
| | | | | | EFL_L3/EFL 1.1 | | |

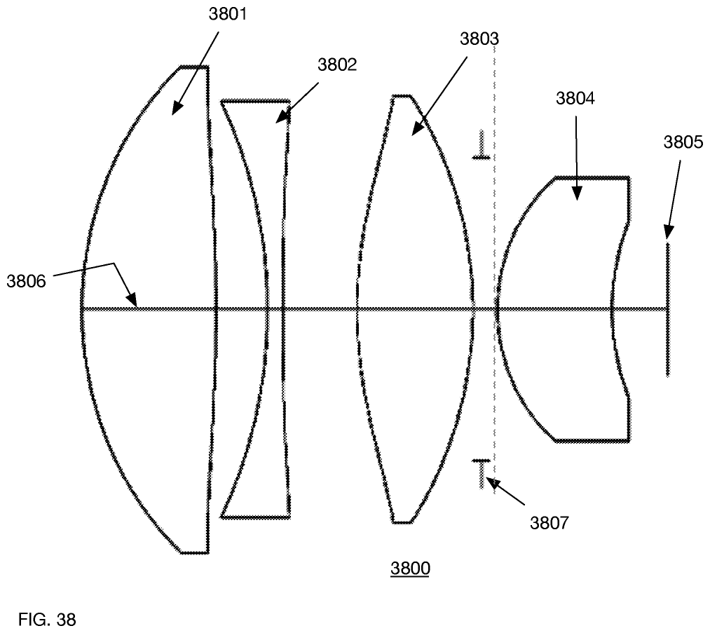

FIG. 38 shows the layout of Example 36, a four lens system 3800. This design has a horizontal field angle of +/−12° with a relative aperture (F/#) of F/0.7 and an effective focal length EFL of 31 mm with a 12.8 mm source Ah.

It comprises four lens elements. The first lens 3801 L1 from the left is a positive powered element with optical property of a higher abbe number and therefore relatively small color dispersion. The second lens 3802 L2 from the left is a negative powered glass element with a lower Abbe number and therefore relatively higher color dispersion. The third element 3803 L3 from left is a positively powered element with a higher Abbe number and therefore relatively lower color dispersion. There is an aperture stop 3807 on the image side of L3 3803. The fourth element 3804 L4 from left is a positive powered element with a high abbe number and therefore relatively low color dispersion. Such choice of dispersion properties of elements facilitates the good color correction as required by automobile lighting lens application. The L1 3801 and L3 3803 are made of moldable glass material and L2 and L4 are made of typical glass material. This arrangement provide good protection from heat and UV radiation generated by light source even with the close proximity of lens elements to the light source. Each element can be made either from optical plastic or glass materials. When the first element is made of plastic material, the aperture shape can be made more complex by plastic molding, and the overall manufacturing cost can also be reduced. In preferred embodiments, all elements are made of glass materials. The all glass design also is helpful to the thermal performance stability of the lens assembly. The additional design degrees of freedom available from using aspheric profile for object/image surfaces of L1 and L3 can further improve the aberration correction of the system without incurring additional manufacturing cost due to the material chosen for L1 and L2 can be molded.

The image surface (RL) of the last element 3804 is concave facing the light source array 3805 and has a curvature radius divided by the total track length (TTL) satisfying above specified Equation (4) to improve light collection efficiency, to keep the lens barrel rear end diameter small, to improve optical performance uniformity over the projected field and to keep the stray light low.

The lens system is used to project an image or light pattern originating from an image or light pattern formed on the light source 3805. A non-limiting example light source is an LED array having a horizontal size (Aₕ) 109 of 12.8 mm. Details of an example LED array light source are shown in FIG. 1. The physical length (TTL) of the example 1 lens system is 65 mm. However, dimensions of the lens system 3800 can be scaled to accommodate light sources having different dimensions.

Table 36 shows the optical prescription of Added Example 36.

TABLE 36

| | | Radius | Thickness | | | Clear | |
|---|---|---|---|---|---|---|---|
| Surface | Type | (mm) | (mm) | Nd | Vd | Diameter | lens |
| OBJ | SPHERICAL | Infinity | 10000 | | | 4278.23 | |
| 1 | SPHERICAL | 32.6267 | 14.9484 | 1.5168 | 64.21 | 46.97 | L1 |
| 2 | ASPHERICAL | −157.9176 | 5.7659 | | | 43.7 | |
| 3 | SPHERICAL | −44.5895 | 1.7027 | 1.7283 | 28.31 | 41.9 | L2 |
| 4 | SPHERICAL | 287.4776 | 8.2773 | | | 41.3 | |
| 5 | ASPHERICAL | 39.2509 | 12.9269 | 1.5168 | 64.21 | 40.97 | L3 |
| 6 | SPHERICAL | −36.8664 | 0.9569 | | | 40.5 | |
| STO | SPHERICAL | Infinity | 1.819 | | | 30.62 | |
| 8 | SPHERICAL | 16.7523 | 12.8 | 1.4875 | 70.42 | 26.55 | L4 |
| 9 | SPHERICAL | 22.0974 | 6.1685 | | | 18.03 | |
| IMA | SPHERICAL | Infinity | | | | 13.32 | |

L1 and L3 object/Image surface are aspherical described by the following equation:

$$z = \frac{{cr}^{2}}{1 + \sqrt{1 - ( 1 + k ) {c}^{2} {r}^{2}}} + {a}_{1} {r}^{2} + {a}_{2} {r}^{4} + {a}_{3} {r}^{6} + {a}_{4} {r}^{8} + {a}_{5} {r}^{10} + {a}_{6} {r}^{12} + {a}_{7} {r}^{14} + {a}_{8} {r}^{16} .$$

The parameters for this equation are as follows:

Image Surface of L1

| | |
|---|---|
| k | −14.99998 |
| Coefficient on r\hat{ } 2 | 0.00E+00 |
| Coefficient on r\hat{ } 4 | 4.2135012e−06 |
| Coefficient on r\hat{ } 6 | −1.1734809e−08 |
| Coefficient on r\hat{ } 8 | 1.6157415e−11 |
| Coefficient on r\hat{ }10 | 0 |
| Coefficient on r\hat{ }12 | 0.00E+00 |
| Coefficient on r\hat{ }14 | 0.00E+00 |
| Coefficient on r\hat{ }16 | 0.00E+00 |

Image Surface of L3

| | |
|---|---|
| k | −0.9104903 |
| Coefficient on r\hat{ } 2 | 0.00E+00 |
| Coefficient on r\hat{ } 4 | −6.9825641e−06 |
| Coefficient on r\hat{ } 6 | −3.7381927e−09 |
| Coefficient on r\hat{ } 8 | 0 |
| Coefficient on r\hat{ }10 | 0 |
| Coefficient on r\hat{ }12 | 0.00E+00 |
| Coefficient on r\hat{ }14 | 0.00E+00 |
| Coefficient on r\hat{ }16 | 0.00E+00 |

| | | | | | | | |
|---|---|---|---|---|---|---|---|
| EXAMPLE | EFL/Ah | TTL/Ah | Ri/TTL | F/# | EFL_G1/EFL | EFL_G2/EFL | RL/EFL |
| 36 | 2.42 | 5.11 | 0.26 | 0.7 | 1.49 | 2.58 | 0.71 |
| | | | | | EFL_L1/EFL 1.7 | EFL_L4/EFL 2.6 | |
| | | | | | EFL_L2/EFL −1.7 | | |
| | | | | | EFL_L3/EFL 1.3 | | |

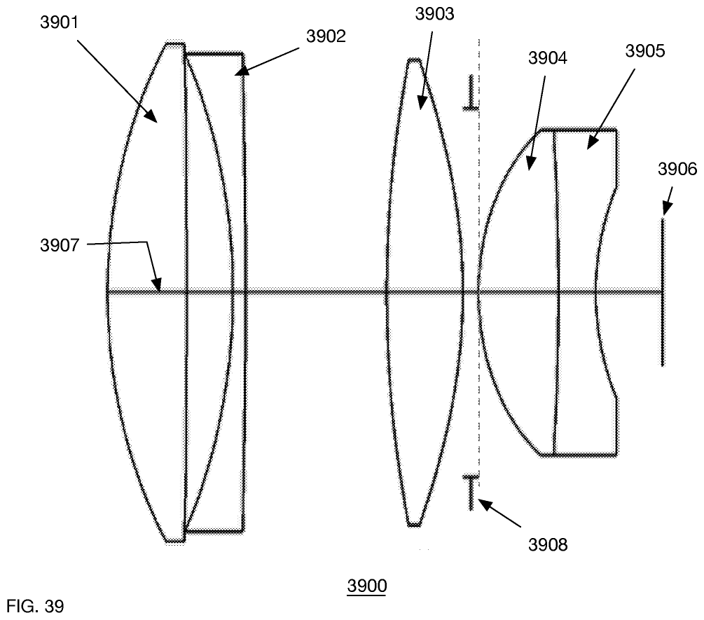

FIG. 39 shows the layout of Example 37, a five element lens system 3900. This design has a horizontal field angle of +/−12° with a relative aperture (F/#) of F/0.75 and an effective focal length EFL of 34 mm with a 14 mm source Ah.

It comprises five lens elements. The first lens 3901 L1 from the left is a positive powered glass element with optical property of a higher abbe number and therefore relatively small color dispersion. The second lens 3902 L2 from the left is a negative powered glass element with optical property of a lower abbe number and therefore relatively higher color dispersion. The third lens 3903 L3 from the left is a positive powered glass element with a higher Abbe number and therefore relatively lower color dispersion. There is an aperture stop 3908 on the image side of L3 3903. The fourth elements 3904 L4 from left is positively powered glass element with a high Abbe number and therefore relatively lower color dispersion. The fifth element 3905 L5 from left is negatively powered glass element with a low Abbe number and therefore relatively high color dispersion. Such choice of dispersion properties of elements facilitates the good color correction as required by automobile lighting lens application. All elements are made of glass material. This arrangement provides good protection from heat and UV radiation generated by light source 3906 even with the close proximity of lens elements to the light source. Each element can be made either from optical plastic or glass materials. When the first/second elements are made of plastic materials, the aperture shape can be made more complex by plastic molding, and the overall manufacturing cost can also be reduced. In preferred embodiments, all elements are made of glass materials. The all glass design also is helpful to the thermal performance stability of the lens assembly. The material of L1 and L3 can be molded and thus bring additional degree of freedom of aberration correction by using aspheric terms without increasing cost.

The image surface (RL) of the last element 3905 is concave facing the light source array and has a curvature radius divided by the total track length (TTL) satisfying above specified Equation (4) to improve light collection efficiency, to keep the lens barrel rear end diameter small, to improve optical performance uniformity over the projected field and to keep the stray light low.

The lens system is used to project an image or light pattern originating from an image or light pattern formed on the light source 3906. A non-limiting example light source is an LED array having a horizontal size (Aₕ) 109 of 14 mm. Details of an example LED array light source are shown in FIG. 1. The physical length (TTL) of the example 1 lens system is 75 mm. However, dimensions of the lens system 100 can be scaled to accommodate light sources having different dimensions.

Table 37 shows the optical prescription of Added Example 37.

TABLE 37

| | | Radius | Thickness | | | Clear | |
|---|---|---|---|---|---|---|---|
| Surface | Type | (mm) | (mm) | Nd | Vd | Diameter | lens |
| OBJ | SPHERICAL | Infinity | 10000 | | | 4278.71 | |
| 1 | SPHERICAL | 40.7544 | 10.752 | 1.5891 | 61.16 | 48.28 | L1 |
| 2 | SPHERICAL | −765.7871 | 6.2087 | | | 46.48 | |
| 3 | SPHERICAL | −44.6651 | 1.6887 | 1.6889 | 31.08 | 46.4 | L2 |
| 4 | SPHERICAL | −705.4058 | 19.094 | | | 46.24 | |
| 5 | SPHERICAL | 86.4039 | 10.3052 | 1.5891 | 61.16 | 45.15 | L3 |
| 6 | ASPHERICAL | −40.35 | 1.0938 | | | 44.82 | |
| STO | SPHERICAL | Infinity | 1.0158 | | | 35.87 | |
| 8 | SPHERICAL | 18.9897 | 10.8056 | 1.6385 | 55.47 | 31.58 | L4 |
| 9 | SPHERICAL | −192.941 | 5.0705 | 1.7847 | 25.72 | 29.38 | L5 |
| 10 | SPHERICAL | 20.1037 | 8.9988 | | | 20.38 | |
| IMA | SPHERICAL | Infinity | | | | 14.25 | |

L3 Image surface are aspherical described by the following equation:

$$z = \frac{{cr}^{2}}{1 + \sqrt{1 - ( 1 + k ) {c}^{2} {r}^{2}}} + {a}_{1} {r}^{2} + {a}_{2} {r}^{4} + {a}_{3} {r}^{6} + {a}_{4} {r}^{8} + {a}_{5} {r}^{10} + {a}_{6} {r}^{12} + {a}_{7} {r}^{14} + {a}_{8} {r}^{16} .$$

The parameters for this equation are as follows:

Image Surface of L3

| | |
|---|---|
| k | −1.975507 |
| Coefficient on r\hat{ } 2 | 0.00E+00 |
| Coefficient on r\hat{ } 4 | 0 |
| Coefficient on r\hat{ } 6 | 0 |
| Coefficient on r\hat{ } 8 | 0 |
| Coefficient on r\hat{ }10 | 0 |
| Coefficient on r\hat{ }12 | 0.00E+00 |
| Coefficient on r\hat{ }14 | 0.00E+00 |
| Coefficient on r\hat{ }16 | 0.00E+00 |

The parametric equations (1)-(14) are satisfied:

| | | | | | | | |
|---|---|---|---|---|---|---|---|
| EXAMPLE | EFL/Ah | TTL/Ah | Ri/TTL | F/# | EFL_G1/EFL | EFL_G2/EFL | RL/EFL |
| 37 | 2.43 | 5.36 | 0.25 | 0.8 | 1.59 | 4.72 | 0.59 |
| | | | | | EFL_L1/EFL 1.9 | EFL_L4/EFL 0.9 | |
| | | | | | EFL_L2/EFL −2 | EFL_L5/EFL −0.7 | |
| | | | | | EFL_L3/EFL 1.4 | | |

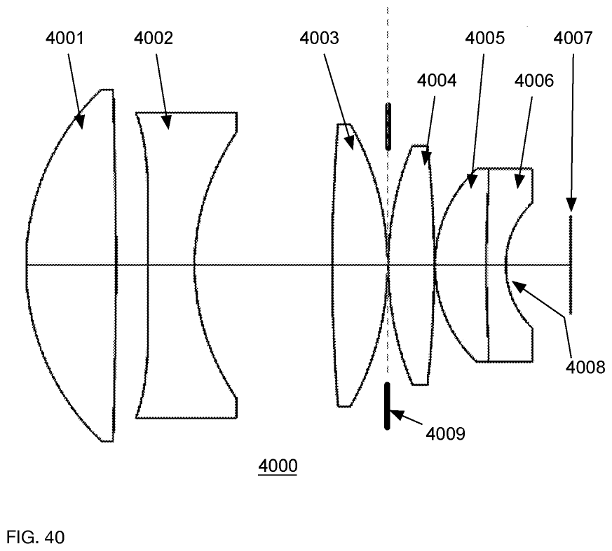

FIG. 40 shows the layout of Example 38. This design has a field angle of +/−12° with a relative aperture of F/0.76 and an effective focal length EFL of 33.3 when used with a 12.8 mm (Ah) image source. The embodiment of an imaging projection lens system 4000 shows an imaging lighting lens of a low F/# which has good optical efficiency and is high resolution.

It comprises two positive powered lens groups. Group 1 comprises L1 4001, L2 4002 and L3 4003 and has an effective focal length of EFL_G1. In preferred embodiment, the EFL_G1 should be equal or greater than 2 times the EFL of the whole lens in order to achieve maximum thermal stability. An aperture stop 4009 is located in group 1 at the image surface of L3. The stop location is closer to the light source to help with field aberration correction. The optical powers of the lens elements in the first group are positive, negative, positive respectively. Group 2 has positive power and comprises positive powered lens element L4 4004, positive powered lens element L5 4005 and negative powered lens element L6 4006. L5 and L6 function together as an air spaced doublet. Group 2 has an effective focal length of EFL_G2. The image surface 4008 of the last element nearest the light source 4007 has a radius of RL. All lens elements are spherical except for L2 and L4. The radius of curvature of individual lens shape is chosen to lower fabrication cost, stray light generation and aberration contribution. The absolute value of the radius of curvature of the lens surface |Rᵢ| with the smallest radius of curvature is |R11|. Table 38 shows the optical prescription of Example 38.

TABLE 38A

| Surface | Surface | | | | | Clear | |
|---|---|---|---|---|---|---|---|
| ID | Type | LENS | Radius | Thickness | Material | Semi | Conic |
| 0 | STANDARD | | Infinity | 1.00E+04 | | 2.14E+03 | 0.00E+00 |
| 1 | STANDARD | L1 | 34.7 | 1.29E+01 | 1.492, 57.441 | 2.51E+01 | 0.00E+00 |
| 2 | EVENASPH | | −316 | 4.50E+00 | | 2.43E+01 | 0.00E+00 |
| 3 | EVENASPH | L2 | 475 | 6.70E+00 | 1.585, 29.909 | 2.19E+01 | 0.00E+00 |
| 4 | EVENASPH | | 32.2 | 1.97E+01 | | 1.89E+01 | 0.00E+00 |
| 5 | STANDARD | L3 | 246 | 7.90E+00 | 1.620, 60.374 | 2.01E+01 | 0.00E+00 |
| 6 | STANDARD | | −40.9 | 1.08E−01 | | 2.02E+01 | 0.00E+00 |
| 7 | STANDARD | L4 (stop) | 44.0 | 6.56E+00 | 1.620, 60.374 | 1.71E+01 | 0.00E+00 |
| 8 | STANDARD | | −149 | 1.08E−01 | | 1.65E+01 | 0.00E+00 |
| 9 | STANDARD | L5 | 18.9 | 7.36E+00 | 1.773, 49.613 | 1.38E+01 | 0.00E+00 |
| 10 | STANDARD | L6 | 267 | 2.75E+00 | 1.847, 23.787 | 1.27E+01 | 0.00E+00 |
| 11 | STANDARD | | 12.4 | 9.29E+00 | | 8.90E+00 | 0.00E+00 |
| 12 | STANDARD | | Infinity | 0.00E+00 | | 7.02E+00 | 0.00E+00 |

TABLE 38B

| | EVENASPH for | EVENASPH for | EVENASPH for |
|---|---|---|---|
| | Image Surface | Object Surface | Image Surface |
| Coefficients | of L1 | of L2 | of L2 |
| r\hat{ }4 | 2.85E−06 | −8.05E−06 | −2.00E−06 |
| r\hat{ }6 | −2.17E−09 | −3.61E−09 | 8.82E−09 |
| r\hat{ }8 | | | −2.41E−11 |

The parametric equations (1)-(14) are satisfied:

| | | | | | | | |
|---|---|---|---|---|---|---|---|
| EXAMPLE | EFL/Ah | TTL/Ah | Ri/TTL | F/# | EFL_G1/EFL | EFL_G2/EFL | RL/EFL |
| 38 | 2.60 | 6.08 | 0.16 | 0.8 | 2.03 | 2.12 | 0.37 |
| | | | | | EFL_L1/EFL 1.92 | EFL_L4/EFL 1.66 | |
| | | | | | EFL_L2/EFL −1.77 | EFL_L5/EFL 0.73 | |
| | | | | | EFL_L3/EFL 1.71 | EFL_L6/EFL −0.44 | |

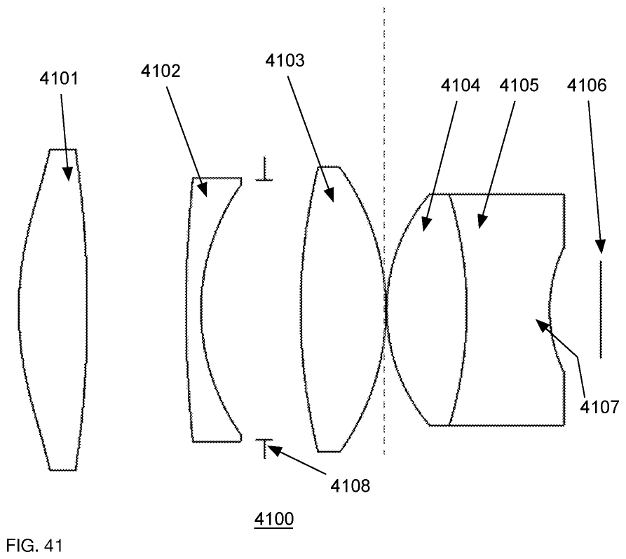

FIG. 41 shows the layout of a five lens element embodiment 39 of an imaging lens system 4100. This design has a field angle of +/−12° with a relative aperture of F/0.76 and an effective focal length of 33.4. This example of present invention shows an imaging lighting lens of a low F/# which has good optical efficiency and is high resolution.

It comprises two positive powered lens groups. Group 1 comprises L1 4101, L2 4102 and L3 4103 and has an effective focal length of EFL_G1. An aperture stop 4108 is located in group 1 between L2 and L3. The optical powers of the lens elements in the first group are positive, negative, positive respectively. L1 is made of molded glass to achieve good aberration correction and thermal performance stability. Group 2 in this example has positive power and comprises positive powered lens element L4 4104 and negative powered lens element L5 4105. L4 and L5 form a cemented or air gap doublet. The cemented surface in group 2 is helpful in the reduction of blue fringes and improve efficiency. Group 2 has an effective focal length of EFL_G2. The image surface 4107 of the last element nearest the light source 4106 has a radius of RL. Each element can be made either from optical plastic or glass materials. When the first element is made of plastic material, the aperture shape can be made more complex by plastic molding, and the overall manufacturing cost can also be reduced. In preferred embodiments, all elements are made of glass materials. All lens elements are made of glass material in order to achieve maximum thermal stability. The radius of curvature of individual lens shape is chosen to lower fabrication cost, stray light generation and aberration contribution. The absolute value of the radius of curvature of the lens surface |Rᵢ| with the smallest radius of curvature is |R10|. Table 39 shows the optical prescription of Example 39.

TABLE 39

| | | | | Glass | Clear | | |
|---|---|---|---|---|---|---|---|
| Surface | Type | Radius | Thickness | nd, abbe no. | Diam | Conic | LENS |
| OBJ | SPHERICAL | Infinity | 10000.00 | | | 0.00 | |
| 1 | ASPHERICAL | 48.3 | 9.2 | 1.52, 58 | 50 | −2.267 | L1 |
| 2 | ASPHERICAL | −155.8 | 13.3 | | 50 | | |
| 3 | SPHERICAL | 197.1 | 2 | 1.67, 32 | 38 | | L2 |
| 4 | SPHERICAL | 32.5 | 8.5 | | 38 | | |
| STO | SPHERICAL | Infinity | 4.9 | | 37 | | |
| 6 | SPHERICAL | 90.5 | 11.4 | 1.62, 60 | 40 | | L3 |
| 7 | SPHERICAL | −36.6 | 0.1 | | 40 | | |
| 8 | SPHERICAL | 26.6 | 10.7 | 1.80, 47 | 32 | | L4 |
| 9 | SPHERICAL | −59.9 | 11.1 | 1.81, 25 | 31 | | L5 |
| 10 | SPHERICAL | 21.7 | 6.96 | | | | |
| IMA | SPHERICAL | Infinity | | | 14 | 0.00 | |

The image surface of L2 and both the image and the object surfaces of L3 are aspherical with the following aspheric formula parameters for the equation:

$$z = \frac{{cr}^{2}}{1 + \sqrt{1 - ( 1 + k ) {c}^{2} {r}^{2}}} + {a}_{1} {r}^{2} + {a}_{2} {r}^{4} + {a}_{3} {r}^{6} + {a}_{4} {r}^{8} + {a}_{5} {r}^{10} + {a}_{6} {r}^{12} + {a}_{7} {r}^{14} + {a}_{8} {r}^{16} .$$

Object Surface of L1

| | |
|---|---|
| Coefficient on r² | 0 |
| Coefficient on r⁴ | 0 |
| Coefficient on r⁶ | −7.414e−9 |
| Coefficient on r⁸ | 2.064e−12 |

Image Surface of L1

| | |
|---|---|
| Coefficient on r² | 0 |
| Coefficient on r⁴ | 2.169e−6 |
| Coefficient on r⁶ | −7.489e−9 |
| Coefficient on r⁸ | 8.099e−12 |

The parametric equations (1)-(14) are satisfied:

| | | | | | | | |
|---|---|---|---|---|---|---|---|
| EXAMPLE | EFL/Ah | TTL/Ah | Ri/TTL | F/# | EFL_G1/EFL | EFL_G2/EFL | RL/EFL |
| 39 | 2.61 | 6.11 | 0.28 | 0.8 | 1.7 | 4.54 | 0.65 |
| | | | | | EFL_L1/EFL 2.14 | EFL_L4/EFL 0.99 | |
| | | | | | EFL_L2/EFL −1.74 | EFL_L5/EFL −0.8 | |
| | | | | | EFL_L3/EFL 1.30 | | |

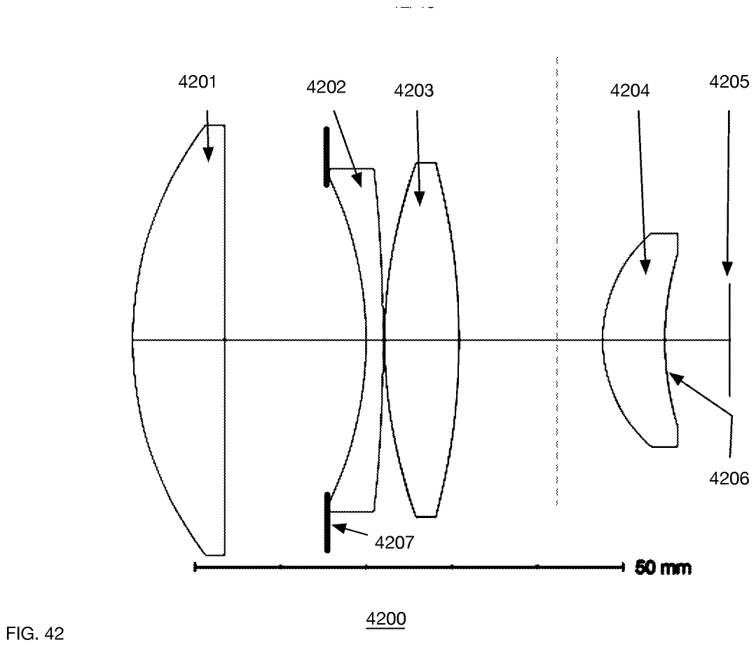

FIG. 42 shows the layout of embodiment 40 of an imaging projection lens system 4200. This design has a field angle of +/−10° with a relative aperture of F/0.75 and an effective focal length of 36.8 when used with a 12.8 mm (Ah) image source. The example of present invention shows an imaging lighting lens of a low F/# which has good optical efficiency and is high resolution. It comprises two positive powered lens groups. Group 1 comprises L1 4201, L2 4202 and L3 4203 and has an effective focal length of EFL_G1. An aperture stop 4207 is located in group 1 at the object surface of L2. The optical powers of the lens elements in the first group are positive, negative, positive respectively. Group 2 comprises one lens element L4 4204 and has an effective focal length of EFL_G2. The image surface 4206 of the last element nearest the light source 4205 has a radius of RL. All lens elements are spherical. Each element can be made either from optical plastic or glass materials. When the first element is made of plastic material, the aperture shape can be made more complex by plastic molding, and the overall manufacturing cost can also be reduced. In preferred embodiments, all elements are made of glass materials. All lens elements are made of glass material in order to achieve maximum thermal stability. The radius of curvature of individual lens shape is chosen to lower fabrication cost, stray light generation and aberration contribution. The absolute value of the radius of curvature of the lens surface |Rᵢ| with the smallest radius of curvature is |R7|. Table 40 shows the optical prescription of Example 40.

TABLE 40

| Surface | Type | Radius | Thickness | ND, ABBE NO. | Clear Diam | LENS |
|---|---|---|---|---|---|---|
| OBJ | SPHERICAL | Infinity | 10000.00 | | | |
| 1 | SPHERICAL | 40.90 | 10.77 | 1.568, 56.059 | 50.00 | L1 |
| 2 | SPHERICAL | Infinity | 16.49 | | 50.00 | |
| STO | SPHERICAL | −43.62 | 2.00 | 1.846, 23.787 | 37.92 | L2 |
| 4 | SPHERICAL | −178.18 | 0.20 | | 39.92 | |
| 5 | SPHERICAL | 59.94 | 8.63 | 1.620, 60.373 | 41.21 | L3 |
| 6 | SPHERICAL | −80.72 | 16.80 | | 40.78 | |
| 7 | SPHERICAL | 16.44 | 7.24 | 1.772, 49.613 | 24.80 | L4 |
| 8 | SPHERICAL | 33.61 | 7.60 | | 20.14 | |
| IMA | SPHERICAL | Infinity | | | 13.21 | |

The parametric equations (1)-(14) are satisfied:

| | | | | | | | |
|---|---|---|---|---|---|---|---|
| EXAMPLE | EFL/Ah | TTL/Ah | Ri/TTL | F/# | EFL_G1/EFL | EFL_G2/EFL | RL/EFL |
| 40 | 2.88 | 5.45 | 0.24 | 0.8 | 1.73 | 0.95 | 0.91 |
| | | | | | EFL_L1/EFL 1.95 | EFL_L4 0.95 | |
| | | | | | EFL_L2/EFL −1.90 | | |
| | | | | | EFL_L3/EFL 1.50 | | |

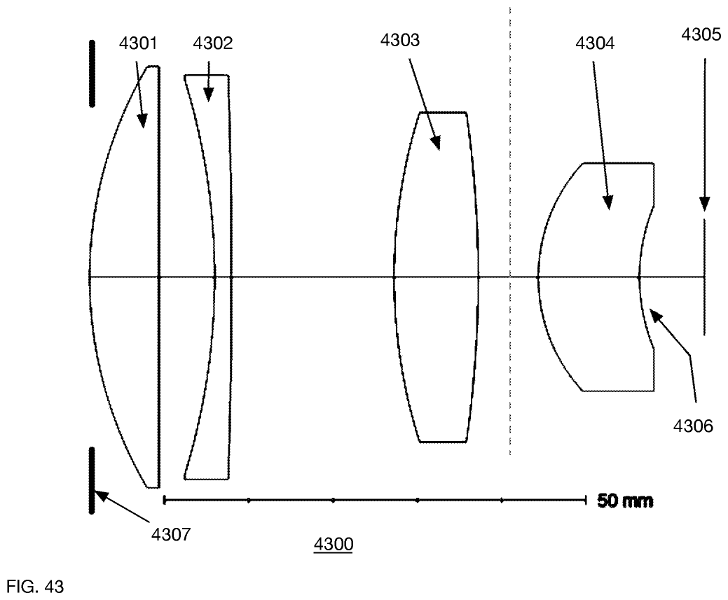

FIG. 43 shows the layout embodiment 41 of an imaging projection lens 4300. This design has a field angle of +/−10° with a relative aperture of F/0.75 and an effective focal length of 36.8 when used with a 12.8 mm (Ah) image source. This example of the present invention shows an imaging lighting lens of a low F/# which has good optical efficiency and is high resolution.

It comprises two positive powered lens groups. Group 1 comprises L1 4301, L2 4302 and L3 4303 and has an effective focal length of EFL_G1. An aperture stop 4307 is located in group 1 at the object surface of L1. The optical powers of the lens elements in the first group are positive, negative, positive respectively. Group 2 comprises one lens element L4 4304 and has an effective focal length of EFL_G2. The image surface 4306 of the last element nearest the light source 4305 has a radius of RL. All lens elements are spherical. Each element can be made either from optical plastic or glass materials. When the first/second elements are made of plastic materials, the aperture shape can be made more complex by plastic molding, and the overall manufacturing cost can also be reduced. In preferred embodiments, all elements are made of glass materials. All lens elements are made of glass material in order to achieve maximum thermal stability. The radius of curvature of individual lens shape is chosen to lower fabrication cost, stray light generation and aberration contribution. The absolute value of the radius of curvature of the lens surface |Rᵢ| with the smallest radius of curvature is |R7|. Table 41 shows the optical prescription of Example 41.

TABLE 41

| Surf | Type | Radius | Thickness | ND, ABBE NO. | Clear Diam | LENS |
|---|---|---|---|---|---|---|
| OBJ | SPHERICAL | Infinity | 10000.00 | | 3526.54 | |
| STO | SPHERICAL | 48.80 | 8.24 | 1.772, 49.613 | 50.00 | L1 |
| 2 | SPHERICAL | Infinity | 6.61 | | 50.00 | |
| 3 | SPHERICAL | −78.77 | 2.00 | 1.846, 23.787 | 46.52 | L2 |
| 4 | SPHERICAL | −734.79 | 19.31 | | 48.00 | |
| 5 | SPHERICAL | 64.65 | 10.00 | 1.640, 60.213 | 39.00 | L3 |
| 6 | SPHERICAL | −135.03 | 7.11 | | 39.00 | |
| 7 | SPHERICAL | 19.86 | 12.00 | 1.772, 49.613 | 27.00 | L4 |
| 8 | SPHERICAL | 21.80 | 7.73 | | 17.10 | |
| IMA | SPHERICAL | Infinity | | | 13.77 | |

| | | | | | | | |
|---|---|---|---|---|---|---|---|
| EXAMPLE | EFL/Ah | TTL/Ah | Ri/TTL | F/# | EFL_G1/EFL | EFL_G2/EFL | RL/EFL |
| 41 | 2.88 | 5.70 | 0.27 | 0.8 | 1.58 | 2.1 | 0.59 |
| | | | | | EFL_L1/EFL 1.70 | EFL_L4/EFL 2.10 | |
| | | | | | EFL_L2/EFL −2.80 | | |
| | | | | | EFL_L3/EFL 1.90 | | |

### SUMMARY

A lens system design for an imaging projection lens is described. The system enables selection of performance requirements of a high or low resolution lens system as described through a set of examples meeting a set of parametric equations. A low resolution imaging lenses has a field angle between +/−15 and +/−20 degrees and effective focal lengths (EFL) between 18 and 25. The high resolution lens systems have an EFL between 30 and 38 source and field angles between +/−10 and +/−12 degrees. The examples all use a 9.0 mm or a 12.8 mm light source (Ah). The lens system is scaled to other size light sources using the parametric equation for EFL/Ah. The lens system comprises two positive powered lens groups. For systems with four or more lens elements, there are 3 lens elements in a first group and 1 to 3 lens element in a second group, the second group is nearest the light source.

Parametric data for all of the low resolution samples 1-12 are shown in Table 42. Parametric data for all of the high resolution samples 13-41, are shown in Table 43. All of the Examples 1-41 satisfy parametric equations (1)-(14). The invented lens system is comprised of 3 to 6 lens elements divided into two positive powered lens groups. For all systems with four or more lens elements, there are three lens elements in Group 1 (G1) and these first three elements have positive, negative, positive powers in order L1, L2, L3 respectively.

TABLE 42
Low resolution, EFL/Ah <2

| | EFL/ | TTL/ | Ri/ | EFL_G1/ | EFL_G2/ | RL/ | # | power: L1, L2, |
|---|---|---|---|---|---|---|---|---|
| EXAMPLE | Ah | Ah | TTL | EFL | EFL | EFL | elements | . . . |
| 1 | 1.39 | 3.40 | 0.28 | 2.38 | 0.89 | 4.18 | 3 | +−+ |
| 2 | 1.41 | 2.77 | 0.51 | 2.56 | 0.97 | 1.48 | 3 | +++ |
| 3 | 1.44 | 4.48 | 0.27 | 1.93 | 1.61 | 2.07 | 4 | +−++ |
| 4 | 1.44 | 4.50 | 0.24 | 1.96 | 1.62 | 2.07 | 5 | +−+++ |
| 5 | 1.48 | 4.89 | 0.27 | 2.06 | 1.61 | 3.16 | 5 | +−+++ |
| 6 | 1.48 | 5.03 | 0.26 | 2.28 | 1.82 | 5.66 | 5 | +−++− |
| 7 | 1.56 | 3.46 | 0.39 | 1.79 | 1.20 | 3.45 | 5 | ++−++ |
| 8 | 1.82 | 4.18 | 0.30 | 1.56 | 1.4 | 2.53 | 5 | +−+++ |
| 9 | 1.91 | 4.27 | 0.29 | 1.54 | 1.43 | 2.44 | 5 | +−+++ |
| 10 | 1.91 | 4.30 | 0.30 | 1.925 | 1.161 | 1.46 | 4 | +−++ |
| 11 | 1.94 | 4.30 | 0.31 | 1.56 | 1.5 | 2.10 | 5 | +−+++ |
| 12 | 2.00 | 4.16 | 0.29 | 2.56 | 0.97 | 3.09 | 3 | +−+ |

TABLE 43
High resolution Designs, EFL/Ah >2.0

| | EFL/ | TTL/ | Ri/ | EFL_G1/ | EFL_G2/ | RL/ | # | power: L1, L2, |
|---|---|---|---|---|---|---|---|---|
| EXAMPLE | Ah | Ah | TTL | EFL | EFL | EFL | elements | . . . |
| 13 | 2.30 | 5.50 | 0.27 | 1.997 | 1.23 | 1.55 | 4 | +−++ |
| 14 | 2.33 | 5.15 | 0.51 | 1.22 | 2.29 | −2.72 | 3 | +++ |
| 15 | 2.34 | 5.79 | 0.32 | 1.88 | 1.41 | 3.58 | 4 | +−++ |
| 16 | 2.34 | 5.61 | 0.13 | 1.96 | 1.42 | 1.30 | 4 | +−++ |
| 17 | 2.34 | 5.52 | 0.13 | 1.91 | 1.43 | 1.42 | 4 | +−++ |
| 18 | 2.34 | 5.68 | 0.31 | 1.89 | 1.54 | 1.96 | 4 | +−++ |
| 19 | 2.34 | 5.00 | 0.35 | 1.76 | 2.26 | 2.24 | 5 | +−++− |
| 20 | 2.34 | 5.08 | 0.33 | 1.916 | 1.67 | 1.06 | 5 | +−++− |
| 21 | 2.34 | 5.08 | 0.32 | 1.76 | 1.96 | 7.28 | 5 | +−++− |
| 22 | 2.34 | 5.07 | 0.35 | 2.36 | 1.42 | 1.08 | 6 | +−+++− |
| 23 | 2.36 | 5.59 | 0.28 | 1.70 | 4.54 | 0.66 | 5 | +−++− |
| 24 | 2.36 | 5.49 | 0.29 | 1.796 | 2 | 0.99 | 4 | +−++ |
| 25 | 2.38 | 5.48 | 0.28 | 1.659 | 2.6 | 0.71 | 4 | +−++ |
| 26 | 2.38 | 5.30 | 0.21 | 1.742 | 3.05 | 0.46 | 6 | +−+++− |
| 27 | 2.38 | 5.63 | 0.17 | 1.82 | 3.06 | 0.40 | 6 | +−+++− |
| 28 | 2.40 | 5.63 | 0.21 | 2.37 | 1.37 | 0.88 | 6 | +−+++− |
| 29 | 2.41 | 5.62 | 0.21 | 1.79 | 2.51 | 0.48 | 6 | +−+++− |
| 30 | 2.41 | 5.62 | 0.19 | 1.87 | 2.2 | 0.45 | 6 | +−+++− |
| 31 | 2.41 | 5.62 | 0.19 | 1.74 | 2.58 | 0.44 | 6 | +−+++− |
| 32 | 2.41 | 5.62 | 0.20 | 1.78 | 2.58 | 0.47 | 6 | +−+++− |
| 33 | 2.41 | 5.62 | 0.20 | 1.81 | 2.55 | 0.47 | 6 | +−+++− |
| 34 | 2.41 | 5.62 | 0.19 | 2.31 | 1.59 | 0.45 | 6 | +−+++− |
| 35 | 2.41 | 5.46 | 0.28 | 1.82 | 1.7 | 0.96 | 4 | +−++ |
| 36 | 2.42 | 5.11 | 0.26 | 1.49 | 2.58 | 0.71 | 4 | +−++ |
| 37 | 2.43 | 5.36 | 0.25 | 1.59 | 4.72 | 0.59 | 5 | +−++− |
| 38 | 2.60 | 6.08 | 0.16 | 2.03 | 2.12 | 0.37 | 6 | +−+++− |
| 39 | 2.61 | 6.11 | 0.28 | 1.7 | 4.54 | 0.65 | 5 | +−++− |
| 40 | 2.88 | 5.45 | 0.24 | 1.73 | 0.95 | 0.91 | 4 | +−++ |
| 41 | 2.88 | 5.70 | 0.27 | 1.58 | 2.1 | 0.59 | 4 | +−++ |

TABLE 44 shows the data for all examples now sorted by number of lens elements.

TABLE 44

| | EFL/ | TTL/ | Ri/ | EFL_G1/ | EFL_G2/ | RL/ | # | power: L1, L2, |
|---|---|---|---|---|---|---|---|---|
| EXAMPLE | Ah | Ah | TTL | EFL | EFL | EFL | elements | . . . |
| 1 | 1.39 | 3.40 | 0.28 | 2.38 | 0.89 | 4.18 | 3 | +−+ |
| 2 | 1.41 | 2.77 | 0.51 | 2.56 | 0.97 | 1.48 | 3 | +++ |
| 12 | 2.00 | 4.16 | 0.29 | 2.56 | 0.97 | 3.09 | 3 | +−+ |
| 14 | 2.33 | 5.15 | 0.51 | 1.22 | 2.29 | −2.72 | 3 | +++ |
| 3 | 1.44 | 4.48 | 0.27 | 1.93 | 1.61 | 2.07 | 4 | +−++ |
| 10 | 1.91 | 4.30 | 0.30 | 1.925 | 1.161 | 1.46 | 4 | +−++ |
| 13 | 2.30 | 5.50 | 0.27 | 1.997 | 1.23 | 1.55 | 4 | +−++ |
| 15 | 2.34 | 5.79 | 0.32 | 1.88 | 1.41 | 3.58 | 4 | +−++ |
| 16 | 2.34 | 5.61 | 0.13 | 1.96 | 1.42 | 1.30 | 4 | +−++ |
| 17 | 2.34 | 5.52 | 0.13 | 1.91 | 1.43 | 1.42 | 4 | +−++ |
| 18 | 2.34 | 5.68 | 0.31 | 1.89 | 1.54 | 1.96 | 4 | +−++ |
| 24 | 2.36 | 5.49 | 0.29 | 1.796 | 2 | 0.99 | 4 | +−++ |
| 25 | 2.38 | 5.48 | 0.28 | 1.659 | 2.6 | 0.71 | 4 | +−++ |
| 35 | 2.41 | 5.46 | 0.28 | 1.82 | 1.7 | 0.96 | 4 | +−++ |
| 36 | 2.42 | 5.11 | 0.26 | 1.49 | 2.58 | 0.71 | 4 | +−++ |
| 40 | 2.88 | 5.45 | 0.24 | 1.73 | 0.95 | 0.91 | 4 | +−++ |
| 41 | 2.88 | 5.70 | 0.27 | 1.58 | 2.1 | 0.59 | 4 | +−++ |
| 4 | 1.44 | 4.50 | 0.24 | 1.96 | 1.62 | 2.07 | 5 | +−+++ |
| 5 | 1.48 | 4.89 | 0.27 | 2.06 | 1.61 | 3.16 | 5 | +−+++ |
| 6 | 1.48 | 5.03 | 0.26 | 2.28 | 1.82 | 5.66 | 5 | +−++− |
| 7 | 1.56 | 3.46 | 0.39 | 1.79 | 1.20 | 3.45 | 5 | ++−++ |
| 8 | 1.82 | 4.18 | 0.30 | 1.56 | 1.4 | 2.53 | 5 | +−+++ |
| 9 | 1.91 | 4.27 | 0.29 | 1.54 | 1.43 | 2.44 | 5 | +−+++ |
| 11 | 1.94 | 4.30 | 0.31 | 1.56 | 1.5 | 2.10 | 5 | +−+++ |
| 19 | 2.34 | 5.00 | 0.35 | 1.76 | 2.26 | 2.24 | 5 | +−++− |
| 20 | 2.34 | 5.08 | 0.33 | 1.916 | 1.67 | 1.06 | 5 | +−++− |
| 21 | 2.34 | 5.08 | 0.32 | 1.76 | 1.96 | 7.28 | 5 | +−++− |
| 23 | 2.36 | 5.59 | 0.28 | 1.70 | 4.54 | 0.66 | 5 | +−++− |
| 37 | 2.43 | 5.36 | 0.25 | 1.59 | 4.72 | 0.59 | 5 | +−++− |
| 39 | 2.61 | 6.11 | 0.28 | 1.7 | 4.54 | 0.65 | 5 | +−++− |
| 22 | 2.34 | 5.07 | 0.35 | 2.36 | 1.42 | 1.08 | 6 | +−+++− |
| 26 | 2.38 | 5.30 | 0.21 | 1.742 | 3.05 | 0.46 | 6 | +−+++− |
| 27 | 2.38 | 5.63 | 0.17 | 1.82 | 3.06 | 0.40 | 6 | +−+++− |
| 28 | 2.40 | 5.63 | 0.21 | 2.37 | 1.37 | 0.88 | 6 | +−+++− |
| 29 | 2.41 | 5.62 | 0.21 | 1.79 | 2.51 | 0.48 | 6 | +−+++− |
| 30 | 2.41 | 5.62 | 0.19 | 1.87 | 2.2 | 0.45 | 6 | +−+++− |
| 31 | 2.41 | 5.62 | 0.19 | 1.74 | 2.58 | 0.44 | 6 | +−+++ |
| 32 | 2.41 | 5.62 | 0.20 | 1.78 | 2.58 | 0.47 | 6 | +−+++ |
| 33 | 2.41 | 5.62 | 0.20 | 1.81 | 2.55 | 0.47 | 6 | +−+++− |
| 34 | 2.41 | 5.62 | 0.19 | 2.31 | 1.59 | 0.45 | 6 | +−+++− |
| 38 | 2.60 | 6.08 | 0.16 | 2.03 | 2.12 | 0.37 | 6 | +−+++− |

All examples follow the parametric equation except of example 14 that includes a convex, towards the light source of the last element R_{L}/EFL=−2.7 for this example.

TABLE 45 shows summary data for all examples including effective focal lengths for all lens elements.

TABLE 45
LENS ELEMENT DATA.

| EXAM- | EFL/ | # | power: L1, | EFL_G1/ | EFL_G2/ | EFL_L1/ | EFL_L2/ | EFL_L3/ | EFL_L4/ | EFL_L5/ | EFL_L6/ |
|---|---|---|---|---|---|---|---|---|---|---|---|
| PLE | Ah | elements | L2, . . . | EFL | EFL | EFL | EFL | EFL | EFL | EFL | EFL |
| 1 | 1.39 | 3 | +−+ | 2.4 | 0.9 | 1.9 | −15.2 | 0.9 | | | |
| 2 | 1.41 | 3 | +++ | 2.6 | 1.0 | 2.0 | 1.9 | 2.9 | | | |
| 3 | 1.44 | 4 | +−++ | 1.9 | 1.6 | 3.3 | −11.6 | 2.3 | 1.6 | | |
| 4 | 1.44 | 5 | +−+++ | 2.0 | 1.6 | 3.3 | −0.8 | 1.2 | 2.3 | 1.6 | |
| 5 | 1.48 | 5 | +−+++ | 2.1 | 1.6 | 3.7 | −1.3 | 2.2 | 2.1 | 1.6 | |
| 6 | 1.48 | 5 | +−++− | 2.3 | 1.8 | 4.4 | −4.6 | 2.2 | 1.6 | −4.9 | |
| 7 | 1.56 | 5 | ++−++ | 1.8 | 1.2 | 3.6 | 2.1 | −0.8 | 1.1 | 1.2 | |
| 8 | 1.82 | 5 | +−+++ | 1.6 | 1.4 | 2.9 | −3.8 | 3.2 | 2.5 | 1.4 | |
| 9 | 1.91 | 5 | +−+++ | 1.5 | 1.4 | 2.8 | −3.7 | 3.1 | 2.6 | 1.4 | |
| 10 | 1.91 | 4 | +−++ | 1.9 | 1.2 | 2.6 | −3.9 | 2.2 | 1.2 | | |
| 11 | 1.94 | 5 | +−+++ | 1.6 | 1.5 | 2.7 | −3.6 | 3.1 | 3.3 | 1.5 | |
| 12 | 2.00 | 3 | +−+ | 2.6 | 1.0 | 1.8 | −7.4 | 1.0 | | | |
| 13 | 2.30 | 4 | +−++ | 2.0 | 1.2 | 3.8 | −1.3 | 1.0 | 1.2 | | |
| 14 | 2.33 | 3 | +++ | 1.2 | 2.3 | 15.0 | 1.1 | 2.3 | | | |
| 15 | 2.34 | 4 | +−++ | 1.9 | 1.4 | 1.3 | −1.1 | 1.6 | 1.4 | | |
| 16 | 2.34 | 4 | +−++ | 2.0 | 1.4 | 1.5 | −0.9 | 1.1 | 1.4 | | |
| 17 | 2.34 | 4 | +−++ | 1.9 | 1.4 | 1.5 | −0.9 | 1.2 | 1.4 | | |
| 18 | 2.34 | 4 | +−++ | 1.9 | 1.5 | 1.3 | −1.0 | 1.5 | 1.6 | | |
| 19 | 2.34 | 5 | +−++− | 1.8 | 2.3 | 1.9 | −2.4 | 1.9 | 1.2 | −1.7 | |
| 20 | 2.34 | 5 | +−++− | 1.9 | 1.7 | 1.8 | −2.2 | 2.1 | 0.9 | −1.3 | |
| 21 | 2.34 | 5 | +−++− | 1.8 | 2.0 | 1.9 | −2.1 | 1.7 | 1.4 | −3.1 | |
| 22 | 2.34 | 6 | +−+++− | 2.4 | 1.4 | 1.8 | −2.0 | 2.8 | 2.5 | 1.3 | −1.4 |
| 23 | 2.36 | 5 | +−++− | 1.7 | 4.5 | 2.1 | −1.7 | 1.3 | 1.0 | −0.8 | |
| 24 | 2.36 | 4 | +−++ | 1.8 | 2.0 | 3.3 | −2.2 | 1.2 | 2.0 | | |
| 25 | 2.38 | 4 | +−++ | 1.7 | 2.6 | 3.0 | −2.0 | 1.2 | 2.6 | | |
| 26 | 2.38 | 6 | +−+++− | 1.7 | 3.1 | 1.9 | −1.7 | 1.4 | 1.5 | 1.0 | −0.5 |
| 27 | 2.38 | 6 | +−+++− | 1.8 | 3.1 | 2.0 | −1.6 | 1.4 | 1.5 | 0.9 | −0.5 |
| 28 | 2.40 | 6 | +−+++− | 2.4 | 1.4 | 2.1 | −1.6 | 1.8 | 1.3 | 2.1 | −1.0 |
| 29 | 2.41 | 6 | +−+++− | 1.8 | 2.5 | 1.9 | −1.7 | 1.5 | 1.3 | 1.1 | −0.6 |
| 30 | 2.41 | 6 | +−+++− | 1.9 | 2.2 | 1.9 | −1.6 | 1.5 | 2.0 | 0.8 | −0.5 |
| 31 | 2.41 | 6 | +−+++− | 1.7 | 2.6 | 1.8 | −1.4 | 1.3 | 1.2 | 1.2 | −0.5 |
| 32 | 2.41 | 6 | +−+++− | 1.8 | 2.6 | 2.1 | −2.2 | 1.6 | 1.8 | 0.9 | −0.6 |
| 33 | 2.41 | 6 | +−+++− | 1.8 | 2.6 | 2.0 | −1.7 | 1.5 | 1.3 | 1.1 | −0.5 |
| 34 | 2.41 | 6 | +−+++− | 2.3 | 1.6 | 2.1 | −2.0 | 2.1 | 1.7 | 0.8 | −0.5 |
| 35 | 2.41 | 4 | +−++ | 1.8 | 1.7 | 2.9 | −1.6 | 1.1 | 1.7 | | |
| 36 | 2.42 | 4 | +−++ | 1.5 | 2.6 | 1.7 | −1.7 | 1.3 | 2.6 | | |
| 37 | 2.43 | 5 | +−++− | 1.6 | 4.7 | 1.9 | −2.0 | 1.4 | 0.9 | −0.7 | |
| 38 | 2.60 | 6 | +−+++− | 2.0 | 2.1 | 1.9 | −1.8 | 1.7 | 1.7 | 0.7 | −0.4 |
| 39 | 2.61 | 5 | +−++− | 1.7 | 4.5 | 2.1 | −1.7 | 1.3 | 1.0 | −0.8 | |
| 40 | 2.88 | 4 | +−++ | 1.7 | 1.0 | 2.0 | −1.9 | 1.5 | 1.0 | | |
| 41 | 2.88 | 4 | +−++ | 1.6 | 2.1 | 1.7 | −2.8 | 1.9 | 2.1 | | |

For examples that include 4 or more lens elements, all have powers of +−+ in group 1. The single exception to this is Example 7, FIG. 9, where the first positive lens element is split into two positive lens elements. Considering these first two elements as a single element, it too follows the prescriptive pattern of +−+.

We claim:

1. An imaging lighting lens system having an effective focal length (EFL), a total track length (TTL), and an f-number (F/#), used for projecting light from an array light source having a width (Ah) and located at an image plane, the lens system comprising two lens groups, each lens group comprised of lens elements each lens element having two radii of curvature (Rᵢ) and the groups ordered from object to image:
a. group 1 has positive power and comprises three lens elements, L1, L2, L3 having optical powers that are positive, negative, positive respectively, and, includes an aperture stop, and, has an effective focal length (EFL_G1), and,
b. group 2 has positive power and comprises one, two, or, three lens element, has an effective focal length (EFL_G2), and, a lens surface, that is nearest the light source, has a radius (RL), and,
c. the f-number is less than 0.8, and,
d. the ratio of EFL to Ah is between 1.2 and 2.0 for lower resolution applications and between 2.2 and 3.0 for higher resolution applications.

2. The imaging lighting lens system of claim 1 that satisfies the parametric equations:
$$a . 1.2 <= EFL / Ah \leq 2$$
$$b . TTL / Ah < 6.1$$
$$c . \vert Ri \vert / TTL > 0.51$$
$$d . F / \# < 0.8$$
$$e . 1. <= EFL\_G1 / EFL <= 2.5$$
$$f . 0.9 <= EFL\_G2 / EFL <= 2.$$
$$g . 1.5 <= RL / EFL$$
$$h . 1.3 <= EFL\_L1 / EFL <= 4.5$$
$$i . - 12 <= EFL\_L2 / EFL <= - 0.5$$
$$j . 1. <= EFL\_L3 / EFL <= 3.5 .$$

3. The imaging lighting lens system of claim 1 that satisfies the parametric equations:
$$a . 2.2 <= EFL / Ah \leq 3$$
$$b . TTL / Ah < 6.1$$
$$c . \vert Ri \vert / TTL > 0.51$$
$$d . F / \# < 0.8$$
$$e . 1. <= EFL\_G1 / EFL <= 2.5$$
$$f . 0.9 <= EFL\_G2 / EFL <= 4.7$$
$$g . 0.3 <= RL / EFL$$
$$h . 1.3 <= EFL\_L1 / EFL <= 4.5$$
$$i . - 12 <= EFL\_L2 / EFL <= - 0.5$$
$$j . 1. <= EFL\_L3 / EFL <= 3.5 .$$

4. The imaging lighting lens system of claim 1 wherein group 2 includes a single positive power lens element, L4.

5. An imaging lighting lens system having an effective focal length (EFL), a total track length (TTL), and an f-number (F/#), used for projecting light from an array light source having a width (Ah) and located at an image plane, the lens system comprising two lens groups, each lens group comprised of lens elements each lens element having two radii of curvature (Ri) and the groups ordered from object to image:
a. group 1 has positive power and comprises two lens elements, L1 and L2 having optical powers that are positive, negative, positive respectively, and, includes an aperture stop, and, has an effective focal length (EFL_G1), and,
b. group 2 has positive power and comprises one lens element L3, has an effective focal length (EFL_G2), and, a lens surface, that is nearest the light source, has a radius (RL), and,
c. the f-number is less than 0.8, and,
d. the ratio of EFL to Ah is between 1.2 and 2.0 for lower resolution applications and between 2.2 and 3.0 for higher resolution applications, and,
$$e . 1. <= EFL\_G1 / EFL <= 3. and 0.9 <= EFL\_G2 <= 2.5 .$$

6. The imaging lighting lens system of claim 5 that satisfies the parametric equations:
$$a . TTL / Ah < 6.1$$
$$b . \vert Ri \vert / TTL > 0.51$$
$$c . F / \# < 0.8$$
$$d . 1. <= EFL\_G1 / EFL <= 2.6$$
$$e . 0.9 <= EFL\_G2 / EFL <= 2.3$$
$$f . 0.3 <= RL / EFL$$
$$g . 1.5 <= EFL\_L1 / EFL <= 15$$
$$h . - 15 <= EFL\_L2 / EFL <= 2.$$
$$i . - 0.8 <= EFL\_L3 / EFL <= 3. .$$
